(19) United States
(12) Patent Application Publication
(10) Pub. No.: US 2018/0247178 A1
(43) Pub. Date: Aug. 30, 2018

(54) DISPLAY CONTROL DEVICE, DISPLAY CONTROL METHOD, AND PROGRAM

(71) Applicant: SONY CORPORATION, TOKYO (JP)

(72) Inventors: NAOKI IDE, TOKYO (JP); YOSHIYUKI KOBAYASHI, TOKYO (JP); KENTA KAWAMOTO, TOKYO (JP); TOMOO MIZUKAMI, TOKYO (JP)

(21) Appl. No.: 15/741,946

(22) PCT Filed: Jul. 1, 2016
(86) PCT No.: PCT/JP2016/069647

§ 371 Date: Jan. 4, 2018

(30) Foreign Application Priority Data
Jul. 16, 2015 (JP) 2015-142175

(51) Int. Cl. G06N 3/00; G06F 17/30; G06N 5/04; G06F 15/18

(52) U.S. Cl. CPC G06N 3/004; G06F 15/18; G06N 5/046; G06F 17/30

(57) ABSTRACT

The present technology relates to a display control device, a display control method, and a program, which are capable of displaying a prediction result for a life event in an easy-to-understand manner. A future life event obtained by predicting the future life event using chronological data related to a life event is displayed on a display unit in a chronology on the basis of a score at which the life event occurs. The present technology can be applied, for example, to display of a prediction result for a life event.

### TECHNICAL FIELD

The present technology relates to a display control device, a display control method, and a program, and more particularly, to a display control device, a display control method, and a program which are capable of displaying, for example, a prediction result for a life event in an easy-to-understand manner.

### BACKGROUND ART

For example, methods of predicting chronological data indicating a future life event of a user, that is, for example, a place where the user will be in the future or a future behavior of the user from chronological behavior data indicating a behavior of the user as a behavior history of the user using a probability and using the predictive chronological data for presentation to the user or the like have been proposed (for examples, see Patent Documents 1 and 2).

### CITATION LIST

### Patent Document

### Patent Document 1: Japanese Patent Application Laid-Open No. 2011-118777

### Patent Document 2: Japanese Patent No. 5664398

### SUMMARY OF THE INVENTION

### Problems to be Solved by the Invention

Meanwhile, in a case where a future life event of the user or the like is predicted, it is requested to display a prediction result for the life event in an easy-to-understand manner.

The present technology was made in light of the foregoing, and it is desirable to be able to display the prediction result for the life event in an easy-to-understand manner.

### Solutions to Problems

A display control device of the present technology is a display control device including a control unit that performs display control such that a future life event obtained by predicting the future life event using chronological data related to a life event is displayed on a display unit in a chronology on the basis of a score at which the life event occurs, and a program of the present technology is a program causing a computer to function as the display control device.

A display control method of the present technology is a display control method including performing display control such that a future life event obtained by predicting the future life event using chronological data related to a life event is displayed on a display unit in a chronology on the basis of a score at which the life event occurs.

In the display control device, the display control method, and the program of the present technology, a future life event obtained by predicting the future life event using chronological data related to a life event is displayed on a display unit in a chronology on the basis of a score at which the life event occurs.

Further, the display control device may be an independent device or an internal block constituting one device.

Further, the program may be provided by transmission via a transmission medium or may be recorded on a recording medium and provided.

### Effects of the Invention

According to the present technology, it is possible to display the prediction result for the life event in an easy-to-understand manner.

Further, the effects described herein are not necessarily limited, and any of effects described in the present disclosure may be included.

### BRIEF DESCRIPTION OF DRAWINGS

FIG. 1 is a diagram illustrating a usage example of chronological data.

FIG. 2 is a diagram for describing an example of future prediction.

FIG. 3 is a diagram for describing an example of deficient modal prediction.

FIG. 4 is a block diagram illustrating a configuration example of a predicting device that performs recursive future prediction.

FIG. 5 is a diagram for describing a method of suppressing repetitive search for chronological data from a chronological database 10.

FIG. 6 is a diagram for describing a network model in which similar sections among a plurality of pieces of chronological data are bundled, and a plurality of pieces of chronological data is held in the form of a network structure.

FIG. 7 is a diagram illustrating a batch learning HMM and an incremental HMM.

FIG. 8 is a diagram for describing an overview of a subset scheme.

FIG. 9 is a diagram for describing a calculation performed using an HMM.

FIG. 10 is a block diagram illustrating a configuration example of a subset HMM generating device that generates a subset HMM.

FIG. 11 is a flowchart illustrating an example of a cluster table generation process performed by a subset HMM generating device and an example of a subset HMM generation process.

FIG. 12 is a flowchart illustrating a subset HMM generation process.

FIG. 13 is a diagram for further describing a subset HMM generation process for generating a subset HMM.

FIG. 14 is a block diagram illustrating a configuration example of a predicting device that predicts (generates) predictive chronological data using a network model.

FIG. 15 is a diagram for describing an example of generation (prediction) of predictive chronological data in a predictive chronological generating unit 53.

FIG. 16 is a diagram for describing an example of presenting a future life event.

FIG. 17 is a diagram illustrating a display example of simplifying and displaying a prediction state sequence.

FIG. 18 is a diagram illustrating a display example of displaying a prediction state sequence (a display example of a score/time order display).

FIG. 19 is a diagram illustrating a display example of a score/time order display with an occurrence condition.

FIG. 20 is a diagram illustrating an example of a correspondence relation between a state constituting a prediction state sequence and a life event.

FIG. 21 is a block diagram illustrating a configuration example of one embodiment of a life event service system to which the present technology is applied.

FIG. 22 is a block diagram illustrating functional configuration examples of a server 61 and a client 62.

FIG. 23 is a diagram illustrating a display example of a user interface displayed on a presenting unit 88.

FIG. 24 is a diagram illustrating a detailed example of a population setting UI 102.

FIG. 25 is a diagram illustrating a detailed example of a goal setting UI 103.

FIG. 26 is a flowchart illustrating an example of a network model learning process performed by a life event service system.

FIG. 27 is a flowchart illustrating an example of a life event prediction process performed by a life event service system.

FIG. 28 is a diagram schematically illustrating an example of a network structure of a life event of a person.

FIG. 29 is a block diagram illustrating a configuration example of an academic background occupation selection prediction system to which a life event service system is applied.

FIG. 30 is a block diagram illustrating a configuration example of a health prediction system to which a life event service system is applied.

FIG. 31 is a diagram schematically illustrating an example of a network structure of a life event of an object.

FIG. 32 is a diagram schematically illustrating an example of a network structure of life events of an assembly of persons or things formed by an assembly of persons.

FIG. 33 is a block diagram illustrating a configuration example of an embodiment of a computer to which the present technology is applied.

### MODE FOR CARRYING OUT THE INVENTION

### <Use Example of Chronological Data>

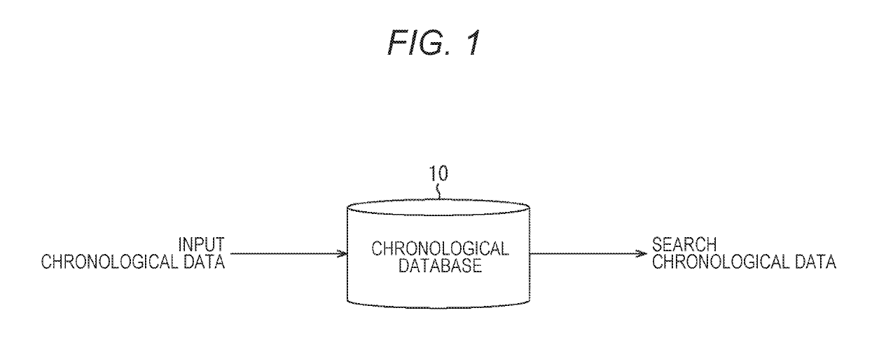

FIG. 1 is a diagram for describing a usage example of chronological data.

Here, in recent years, systems that utilize data, particularly, big data which is a large number of pieces of data have been continuously proposed and constructed.

Information collected systems which utilize data was a relatively small size information which is static, that is, does not change temporally (independent of time) such as a user individual (person), a group of the users, a profile of an object.

However, in recent years, with the progress of technology, in the systems that utilize data, it became possible to collect a large size of chronological data such as the behavior history of the user and sensing outputs of sensors.

If it is possible to collect a large number of pieces of chronological data, it is possible to predict the future using the chronological data.

For example, methods of predicting a place where the user will be in the future or the future behavior of the user from chronological data indicating the behavior of the user have been proposed in Patent Documents 1 and 2.

In the methods disclosed in Patent Documents 1 and 2, for example, a probability of a place or a behavior after one minute or one hour is obtained, and the future is predicted with a time scale of one minute or one hour.

For example, it is possible to collect chronological data of about one hour or one day, perform construction of a database or learning of a model using the chronological data, and perform the prediction of the future performed with the time scale of one minute or one hour using the database or the model.

However, in terms of an actual interest of the user, the user often wants to know a future of a long time scale rather than a future after one minute or one hour. This is because the future after one minute and one hour is roughly decided by the user's experience and intention, and the user knows the future roughly, and thus it is unnecessary to predict it through the system.

On the other hand, for example, it is difficult to anticipate a future of a longtime scale such as one month, one year, or ten years from the user's experience or intention. To predict the future of the long time scale, for example, it is necessary to collect a large number of pieces of chronological data of various persons in advance and use a propensity of the chronological data.

Meanwhile, a target that the user wants to know the future is not necessarily limited to himself/herself. For example, there are cases in which the user wants to know the future of other persons such as family members such as the user's child or grandchild.

Further, there are cases in which the user wants to know the future of an assembly of persons such as a group or an organization to which the user belongs such as a company, a club, a nation, or a social system in addition to one person.

For example, if a user belonging to an organization is able to predict how the organization will change in the future, the user is able to obtain guidelines on how to go through the inside of the organization or the outside of the organization.

Further, for example, a user who runs an organization may want to know conditions to invite the future, that is, for example, measures to be taken or measures to be avoided in order to make the organization prosper and survive together with the prediction result for the future of the organization.

Further, the assembly of persons such as a group or an organization may be an assembly in which a member boundary is not necessarily explicit, for example, such as pacifists and feminists.

There are also cases in which it is desired to know the future of things formed by an assembly of persons, that is, the future of, for example, culture, fashion, or the like. For example, there are cases in which it is desired to know a change in fashion of culture of rounded handwriting or a pictogram or whether current buzzwords will be settled in the future.

Further, the user may often think that he/she wants to know the future of things owned by the user (including movables and real estate), things of interest, things being used, and any other things. For example, there are cases in which the user wants to know how a vehicle, a musical instrument, and a house owned by the user, and a construction such as a nearby road, a bridge, a building, or the like will be changed in the future.

Further, for things, it may be desired to know a use period and a use method thereof in which things actually deteriorate or their monetary value will decline. Further, there are cases in which it is desired to know how to suppress such deterioration or the decline in the monetary value in the future.

According to big data, it is possible to extract useful information used to predict the future by aggregating various cases and applying the various cases to a current case.

For example, it is possible to predict a future image of the user by searching for cases of other users who have followed in the footsteps similar to the user from the big data and aggregating future information from those cases.

Therefore, the big data is useful for future prediction (knowing the future) described above.

However, as described above, there are cases in which it is difficult to appropriately predict the future in the method of searching for cases from the big data and predicting the future.

In other words, for example, in a case where merely chronological data of (a length of) a maximum of about one year is included in the big data, it is possible to predict merely the future corresponding to the length of the chronological data, that is, the future after about one year, and it is difficult to predict the future after more than one year, for example, the future after 10 years.

For this reason, there is a demand for proposals for methods of predicting a future farther than a future corresponding to the length of the longest chronological data included in the big data.

Further, it is requested to present a prediction result obtained by predicting the future in an easy-to-understand manner regardless of how far into the future it is predicted for life events of persons, assemblies of persons, things formed by assemblies of persons, and objects.

Particularly, in a case where a farther future is predicted, a plurality of life events associated with various branches are obtained as life events which are likely to occur in the future. Further, in a branch from a certain life event, there is a choice serving as a condition for deciding a branch destination, and the branch destination from the life event may change depending on a choice to be selected.

It is requested to present a plurality of life events associated with various branches to the user in an easy-to-understand manner together with the condition for deciding the branch destination (a condition that another life event occurs from a predetermined life event).

Further, it is requested to allow the user to select the choice serving as the condition for deciding the branch destination from a certain life event and present a life event occurring in a case where the choice selected by the user is selected.

In this regard, in the present technology, it is possible to predict a life event occurring in a farther future. Further, in the present technology, it is possible to present the prediction result for the life event or the condition for deciding the branch destination from the life event to the user in an easy-to-understand manner. Furthermore, in the present technology, it is possible to enable the user to select the choice serving as the condition for deciding the branch destination from the life event.

Referring to FIG. 1, a chronological database 10 stores a large number of pieces of chronological data. In other words, for example, a large number of pieces of chronological data related to life events of persons, assemblies of persons, things formed by assemblies of persons, and objects are collected, and the large number of pieces of chronological data are stored in chronological database 10.

Further, input chronological data which is chronological data serving as a query is transferred to the chronological database 10.

Chronological data corresponding to the input chronological data is searched for from the chronological database 10. The chronological data corresponding to the input chronological data which is searched for from the chronological database 10 is output as search chronological data and used for, for example, prediction of future life events or the like as necessary.

For example, prediction (estimation) of chronological data other than the input chronological data may be performed using the search chronological data. Examples of the prediction of the chronological data include future prediction and deficient modal prediction.

In the future prediction, future chronological data of the input chronological data is predicted (estimated).

In other words, in the future prediction, for example, chronological data similar to the input chronological data is searched for from the chronological database 10. Then, for example, a part of a future farther than a part similar to the input chronological data among the search chronological data obtained as a result of searching the chronological database 10 is output as a prediction result for the future prediction.

In the deficient modal prediction, in a case where modal data of some modals is deficient in the input chronological data, the deficient modal data of the modal is predicted (estimated).

In other words, a multi-stream including modal data which is data of a plurality of modals is employed as the input chronological data.

In the deficient modal prediction, in a case where modal data of some modals is deficient in the input chronological data of the multi-stream, the deficient modal data of the modal is predicted (estimated).

In other words, in the deficient modal prediction, for example, chronological data having modal data similar to modal data of the input chronological data is searched for from the chronological database 10. Then, for example, the modal data of the modal in which the modal data is deficient in the input chronological data among the modal data included in the search chronological data obtained as a result of searching the chronological database 10 is output as a prediction result for the deficient modal prediction.

Here, examples of the chronological data having the modal data of a plurality of modals include chronological data of a test score of the user and chronological data having chronological data of schools which the user has attended (chronological data indicating schools) or the like as the modal data of a plurality of modals.

### <Future Prediction>

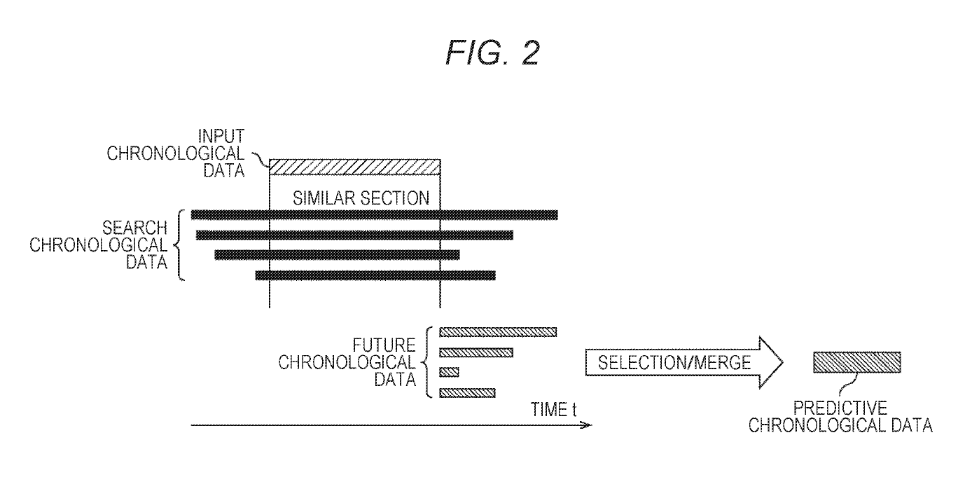

FIG. 2 is a diagram for describing an example of the future prediction.

In the future prediction, one or more pieces of chronological data having a similar section similar to the input chronological data is searched for from the chronological database 10 as the search chronological data.

Further, chronological data of a future farther than the input chronological data is extracted from each of one or more pieces of search chronological data. Further, predictive chronological data obtained by predicting the future of the input chronological data is generated from the future chronological data.

In other words, for example, one of one or more pieces of future chronological data extracted from one or more pieces of search chronological data is selected as the predictive chronological data or merged with one or more pieces of future chronological data to generate the predictive chronological data.

### <Deficient Modal Prediction>

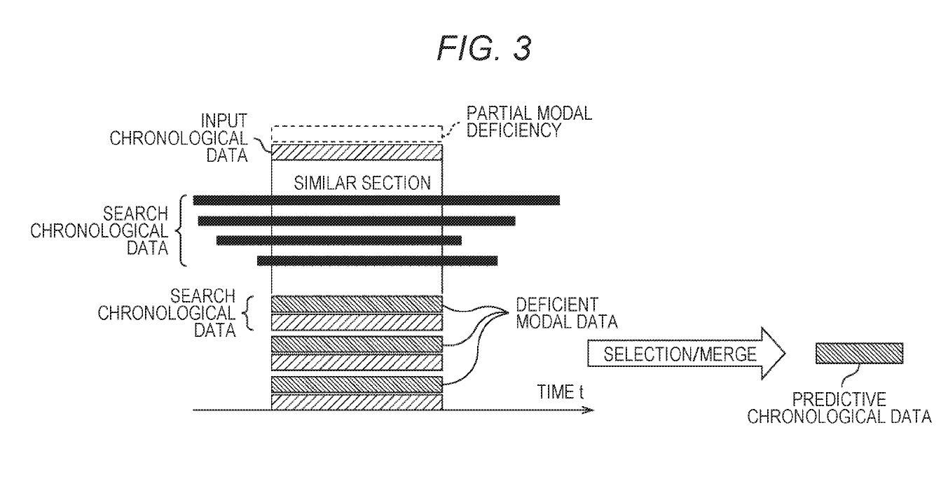

FIG. 3 is a diagram for describing an example of the deficient modal prediction.

In the deficient modal prediction, one or more pieces of chronological data having modal data similar to non-deficient modal data of a modal included in the input chronological data in which modal data of some modals is deficient is searched for from the chronological database 10 as the search chronological data.

Further, modal data of the modal in which the modal data is deficient in the input chronological data is extracted from one or more pieces of search chronological data as the deficient modal data. Further, predictive chronological data obtained by predicting the modal data of the modal which is deficient in the input chronological data (deficient modal prediction data) is generated from the deficient modal data.

In other words, the deficient modal prediction data is generated, for example, by selecting one of one or more pieces of deficient modal data extracted from one or more pieces of search chronological data as the deficient modal prediction data or merging the one or more pieces of deficient modal data.

The present technology can be applied to both the future prediction and the deficient modal prediction, but the following description will proceed with an example of the future prediction out of the future prediction and the deficient modal prediction.

Here, if the future prediction of FIG. 2 is also referred to as “simple future prediction,” in the simple future prediction, it is possible to predict merely up to a point of time of the farthest future of the search chronological data.

In this regard, as a method to predict the farther future, there is a method of obtaining the predictive chronological data of up to a future which is as far as necessary by performing the simple future prediction using the predictive chronological data obtained in the simple future prediction as the input chronological data and repeating it the necessary number of times.

Here, as described above, the future prediction of repeatedly performing the simple future prediction using the predictive chronological data obtained by the simple future prediction as the input chronological data is also referred to as “recursive future prediction.”

### <Configuration Example of Predicting Device Performing Recursive Future Prediction>

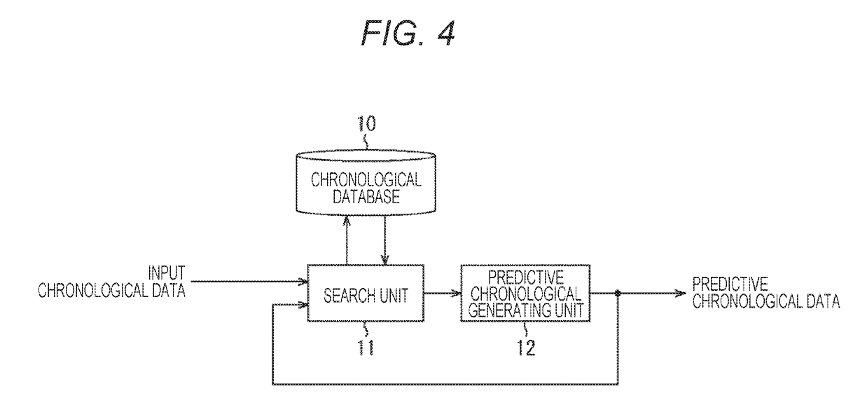

FIG. 4 is a block diagram illustrating a configuration example of a predicting device that performs the recursive future prediction.

Referring to FIG. 4, the predicting device includes the chronological database 10, a search unit 11, and a predictive chronological generating unit 12, and is constructed using the chronological database 10 of FIG. 1.

Chronological data to be used for predicting the future is supplied to the search unit 11 as the input chronological data serving as a query.

The search unit 11 searches for chronological data similar to the input chronological data from the chronological database 10 and supplies one or more pieces of chronological data obtained as a result of search to the predictive chronological generating unit 12 as the search chronological data.

The predictive chronological generating unit 12 extracts apart (section) of a future farther than the input chronological data from one or more pieces of search chronological data supplied from the search unit 11 as the predictive chronological data.

Further, the predictive chronological generating unit 12 supplies one or more pieces of predictive chronological data extracted from one or more pieces of search chronological data to the search unit 11 as new input chronological data.

The search unit 11 searches for chronological data similar to the new input chronological data for each of one or more pieces of the new input chronological data supplied from the predictive chronological generating unit 12 from the chronological database 10.

Thereafter, the search unit 11 and the predictive chronological generating unit 12 repeat a similar process until a predetermined convergence condition is satisfied, for example, until chronological data of up to a necessary future point of time is obtained as the predictive chronological data in the predictive chronological generating unit 12.

Then, as the predictive chronological data, if the convergence condition is satisfied, for example, the chronological data of up to a necessary future point of time is obtained as the predictive chronological data, the predictive chronological generating unit 12 generates chronological data of up to a point of time of a future which is as far as necessary which is chronological data of a future farther than the input chronological data using predictive chronological data obtained until now, and outputs the chronological data as final predictive chronological data.

In the predicting device performing the recursive future prediction of FIG. 4, it is necessary to repeat the search of the chronological data similar to the input chronological data from the chronological database 10 and the extraction of the predictive chronological data from the search chronological data obtained as a result of the search.

Since the search of the chronological data from the chronological database 10 is a high-load process, it is not appropriate to repeatedly perform the search.

As a method of suppressing the repetitive search of the chronological data from the chronological database 10, there is a method of storing long chronological data obtained by connecting chronological data having a similar section in the chronological database 10.

### <Method of Suppressing Repetitive Search of Chronological Data>

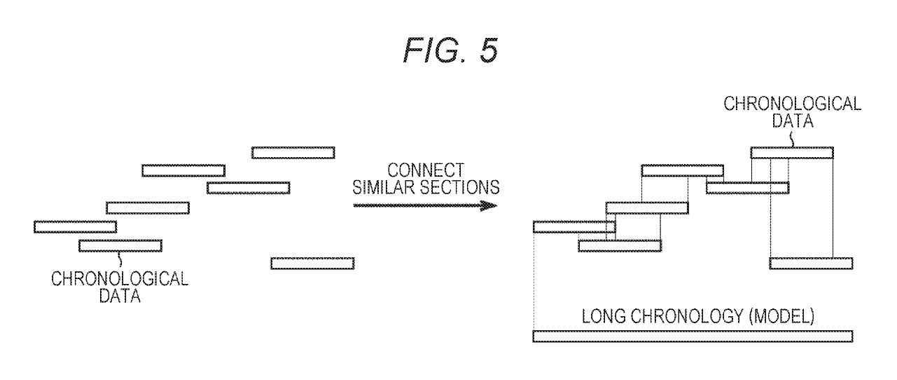

FIG. 5 is a diagram for describing a method of suppressing the repetitive search of the chronological data from the chronological database 10 by storing the long chronological data obtained by connecting the chronological data having similar sections in the chronological database 10.

In the search unit 11 of FIG. 4, in a case where the search of the chronological data is repeatedly performed, the search is performed on the chronological data stored in the chronological database 10.

In this regard, in order to suppress the repetitive search of the chronological data, chronological data having a similar section is searched for in advance from the chronological data stored in the chronological database 10. Further, pieces of the chronological data are repeatedly connected so that the similar sections overlap until chronological data of a necessary length is obtained, and the chronological data is stored in the chronological database 10.

Accordingly, it is possible to obtain the predictive chronological data of up to a future point of time farther than the (first) input chronological data while suppressing the repetitive search of the chronological data from the chronological database 10.

In other words, in a case where a large number of pieces of chronological data which are partially similar to one another are stored in the chronological database 10, it is possible to obtain the long chronological data by connecting the chronological data so that the similar sections of the chronological data overlap.

As a result, the search unit 11 is able to search for the long chronological data as the search chronological data, and the predictive chronological generating unit 12 is able to predict the chronological data serving as the predictive chronological data of up to a farther future point of time.

Therefore, since the predictive chronological data of up to the farther future point of time is obtained, it is possible to suppress the repetitive search of the chronological data in the search unit 11.

Meanwhile, as described above in FIG. 5, in the case where pieces of the chronological data stored in the chronological database 10 are connected so that the similar sections overlap, so-called combination explosion may occur.

In other words, in a case where there are a plurality of pieces of chronological data as chronological data having a similar section to certain chronological data (hereinafter also referred to as “similar chronological data”), new chronological data which is equal in number to the similar chronological data is generated by connecting the certain chronological data with each of a plurality of pieces of similar chronological data.

Further, in a case where there area plurality of pieces of similar chronological data for the new chronological data, the new chronological data which is equal in number to a plurality of pieces of similar chronological data is similarly generated.

In a case where pieces of the chronological data stored in the chronological database 10 are connected so that the similar sections overlap, there are cases in which the combination explosion in which a huge number of pieces of new chronological data are generated since the new chronological data is repeatedly generated occurs.

In this regard, in a case where pieces of the chronological data stored in the chronological database 10 are connected so that the similar sections overlap, the similar sections are bundled, and the chronological data is held in the form of a network model of a network structure (including a tree structure).

As described above, the combination explosion can be suppressed since the chronological data is held in the form of a network model.

Further, in a case where the chronological data is held in the form of the network model as described above, loss of information occurring since the similar sections are bundled is suppressed by storing information of a frequency of chronological data passing through the bundled section (the similar section) (for example, information indicating the number of pieces of chronological data bundled in the bundled sections), information of transition from the bundled section to another bundled section, and information of a distribution of observation values observed in the bundled sections, that is, information of a distribution of sample values of chronological data of the bundled sections.

<Network Model in which Chronological Data is Held in Form of Network Structure>

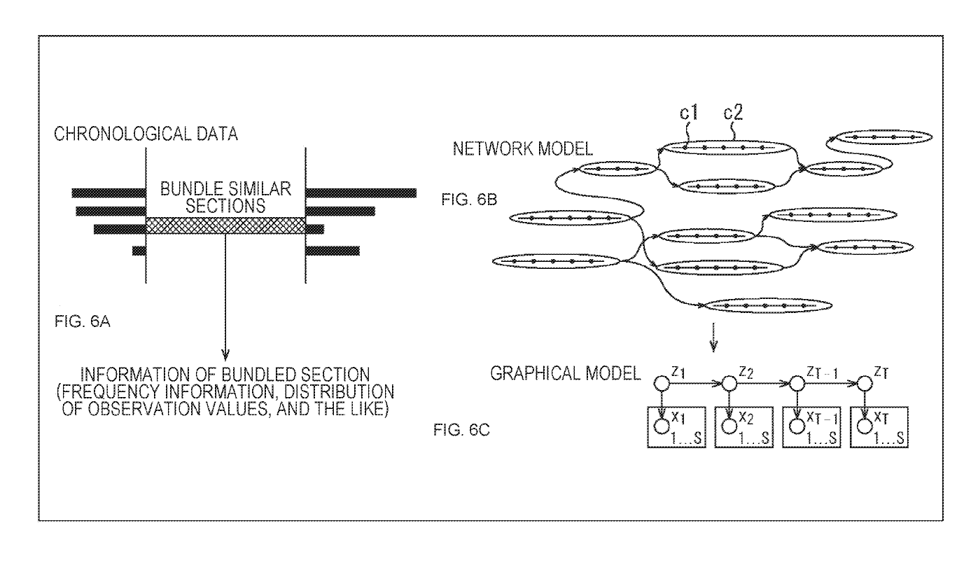

FIG. 6 is a diagram for describing a network model in which the similar sections of a plurality of pieces of chronological data are bundled, and a plurality of pieces of chronological data are held in the form of a network structure.

A in FIG. 6 illustrates a form in which the similar sections of a plurality of pieces of chronological data are bundled.

As illustrated in A of FIG. 6, a network model is constituted by bundling the similar sections of a plurality of pieces of chronological data.

In the case where the network model is constituted by bundling the similar sections of a plurality of pieces of chronological data, the information of the frequency, the information of the transition, and the information of the distribution of the observation values are separately stored as described above.

B of FIG. 6 illustrates an example of the network model constituted by bundling the similar sections of a plurality of pieces of chronological data.

In B of FIG. 6, a portion denoted by c1 indicates a bundled section or a section obtained by dividing the bundled section. The bundled section is branched, or the bundled sections are merged. In B of FIG. 6, a portion denoted by c2 indicates a group of sections not to be branched in the bundled section (including a section obtained by dividing the bundled section).

As the network model, for example, a chronological transition model (state transition model) such as a Markov model (state transition model), a Hidden Markov Model (HMM), a weighted finite state transducer, a linear dynamic system (for example, a Kalman filter, a particle filter, or the like) can be employed.

In a case where the HMM is employed as the network model, in the network model of FIG. 6, the portion denoted by c1 indicates the state of the HMM, the portion denoted by c2 indicates, for example, a group of non-branched states (states in which only one-way state transition or only one-way state transition and self transition are performed).

C of FIG. 6 illustrates an example of a graphical model of the network model of B of FIG. 6.

In the graphical model of C of FIG. 6, an observation value xₜ is observed in a state zₜ. There are S types of observation value xₜ.

An example in which the HMM is employed as the network model will be described below.

For the HMM, for example, the number of times f(i) of stays in a state i (the number of times of passages of the state i) is obtained as the information of the frequency. The number of times f(i) of stays in the state i can be calculated in accordance with Formula (1).

$$\begin{matrix}[ Mathematical Formula 1 ] & \\ f ( i ) = {\sum }_{t = 1}^{T} γ ( t , i ) & ( 1 )\end{matrix}$$

In Formula (1), for example, γ(t, i) is a function that becomes 1 in a case where it is in the state i at a time t, becomes 0 in a case where it is not in the state i at the time t, and indicates whether or not it is in the state i at the time t.

Further, T indicates a time length of chronological data in which the similar sections are to be bundled, that is, learning chronological data which is chronological data used for learning of the HMM (the number of samples of chronological data).

The function γ(t, i) of Formula (1) is calculated by obtaining a maximum likelihood state sequence s={s₁, s₂, . . . , s_{T}} for the learning chronological data in accordance with, for example, a Viterbi algorithm and performing a calculation in accordance with Formula (2) on the basis of the maximum likelihood state sequence s. Here, sₜ indicates a state at a time t.

[Mathematical Formula 2]

γ(t,i)=δ_{i,s}_{ₜ} (2)

In Formula (2), δ_{i,j} is a function that becomes 1 when i=j and 0 when i≠j.

According to Formula (2), the function γ(t, i) becomes 1 in a case where the state sₜ at the time t is the state i, and the function γ(t, i) becomes 0 in a case where the state sₜ at the time t is not the state i.

According to Formula (1), the number of times f(i) of stays in the state i is obtained by adding the function γ(t, i) over samples (times) of the learning chronological data, that is, t=1, 2, . . . , T.

Further, the number of times of stays in the state i serving as the information of the frequency can be incrementally obtained using the number of times which is previously obtained.

In other words, the number of times of stays in the state i for 1st to s-th learning chronological data is indicated by f(s, i). Further, a function indicating whether or not it is in the state i at a time t for (s+1)-th learning chronological data is indicated by γ(s+1, t, i). Further, a time length of the (s+1)-th learning chronological data is indicated by as T (s+1).

In this case, for 1st to (s+1)-th chronological data, the number of times f(s+1, i) of stays in the state i can be obtained in accordance with Formula (3) using the number of times f(s, i) of stays of the state i for the 1st to s-th chronological data.

$$\begin{matrix}[ Mathematical Formula 3 ] & \\ f ( s + 1 , i ) = f ( s , i ) + {\sum }_{t = 1}^{T ( s + 1 )} γ ( s + 1 , t , i ) & ( 3 )\end{matrix}$$

For the HMM, information of an observation model obtained by modeling the observation value is obtained as the information of the distribution of the observation values.

The HMM has an observation model for each state.

In a case where the observation value, that is, a sample value of(learning) chronological data is a continuous value, for example, the Gaussian distribution can be employed as the observation model.

The Gaussian distribution is defined by an average value (average vector) and a variance (a variance-covariance matrix). Therefore, in a case where the Gaussian distribution is employed as the observation model, the average value and the variance that define the Gaussian distribution are obtained as the information of the distribution of the observation values.

An average value μ(i) and a variance σ²(i) of the Gaussian distribution serving as the observation model of the state i can be obtained in accordance with Formulas (4) and (5), respectively.

$$\begin{matrix}[ Mathematical Formula 4 ] & \\ μ ( i ) = \frac{{\sum }_{t = 1}^{T} γ ( t , i ) x ( t )}{{\sum }_{t = 1}^{T} γ ( t , i )} & ( 4 ) \\ [ Mathematical Formula 5 ] & \\ {σ}^{2} ( i ) = \frac{{\sum }_{t = 1}^{T} γ ( t , i ) {( x ( t ) - μ ( i ) )}^{2}}{{\sum }_{t = 1}^{T} γ ( t , i )} & ( 5 )\end{matrix}$$

In Formulas (4) and (5), x(t) indicates a sample value (an observation value) of a time t of chronological data.

Further, a variance of a plurality of pieces of data x is defined as an expectation value E((x−E(x))²) of the square of a difference (x−E (x)) between x and the expectation value (average value) E (x) of x, but the expectation value E((x−E(x))²) is equal to a difference (E(x²)−(E(x))²) of the expectation value E (x²) of the square of x and the square (E(x))² of the expectation value of x.

In Formula (5), the variance σ²(i) is obtained by calculating the expectation value E((x−E(x))²) of the square of the difference (x−E(x)) of x and the expectation value E(x) of x, but the variance σ²(i) can be also obtained by calculating the difference (E (x²)−(E (x))²) of the expectation value E (x²) of the square of x and the square (E (x))² of the expectation value of x.

Further, the average value and the variance of the Gaussian distribution serving as the information of the distribution of the observation values can be incrementally obtained using the average value and the variance of the Gaussian distribution which is previously obtained.

In other words, the average value and the variance of the Gaussian distribution of the state i for the 1st to s-th chronological data are indicated by μ(s, i) and σ² (s, i), respectively. Further, the sample value of the time t of the s-th chronological data is indicated by x(s, t).

In this case, the average value μ(s+1, i) and the variance σ² (s+1, i) of the Gaussian distribution of the state i for the 1st to (s+1)-th chronological data can be obtained in accordance with Formulas (6) and (7) using the average value μ(s, i) and the variance σ² (s, i) of the Gaussian distribution of the state i for the 1st to s-th chronological data, respectively.

$$\begin{matrix} [ Mathematical Formula 6 ] & \\ μ ( s + 1 , i ) = \frac{f ( s , i ) μ ( s , i ) + {\sum }_{t = 1}^{T ( s + 1 )} γ ( s + 1 , t , i ) x ( s , t )}{f ( s + 1 , i )} & ( 6 ) \\ [ Mathematical Formula 7 ] & \\ {σ}^{2} ( s + 1 , i ) = \frac{f ( s , i ) {σ}^{2} ( s , i ) + {\sum }_{t = 1}^{T ( s + 1 )} γ ( s + 1 , t , i ) {( x ( s , t ) - μ ( s + 1 , i ) )}^{2}}{f ( s + 1 , i )} & ( 7 )\end{matrix}$$

In a case where the observation value x (t), that is, the sample value x (t) of the chronological data is a discrete value, a set of probabilities (observation probabilities) in which each of discrete symbols that can be the discrete value will be observed can be employed as the observation model.

Here, the set (distribution) of observation probabilities serving as the observation model is referred to as a “polynomial distribution.”

The observation probability p(i, k) that the discrete symbol k will be observed, which is indicated by the polynomial distribution serving as the observation model of the state i, can be obtained in accordance with Formula (8).

$$\begin{matrix}[ Mathematical Formula 8 ] & \\ p ( i , k ) = \frac{{\sum }_{t = 1}^{T} γ ( t , i ) {δ}_{k , x ( t )}}{{\sum }_{t = 1}^{T} γ ( t , i )} & ( 8 )\end{matrix}$$

According to Formula (8), the observation probability p(i, k) is obtained by dividing a total number Σγ(t, i) δ_{k,x(t)} in which a discrete symbol k is observed as the observation value (sample value) x(t) of the time t of the chronological data in the state i by a total number Σγ(t, i) of stays in the state i.

Further, (the polynomial distribution constituted by) the observation probability serving as the information of the distribution of the observation values can be obtained incrementally using the observation probability which is previously obtained.

In other words, the observation probability of the discrete symbol k in the state i for the 1st to s-th chronological data is indicated by p (s, i, k).

In this case, the observation probability p(s+1, i, k) of the discrete symbol k in the state i for 1st to (s+1)-th chronological data can be obtained in accordance with Formula (9) using the observation probability p(s, i, k) of the discrete symbol k in the state i for the 1st to s-th chronological data.

$$\begin{matrix}[ Mathematical Formula 9 ] & \\ p ( s + 1 , i , k ) = \frac{f ( s , i ) p ( s , i , k ) + {\sum }_{t = 1}^{T ( s + 1 )} γ ( s + 1 , t , i ) {δ}_{k , x ( s + 1 , t )}}{f ( s + 1 , i )} & ( 9 )\end{matrix}$$

For the HMM, a transition probability parameter as the information of the transition is necessary. The transition probability parameter is obtained from the number of times (the number of times of passages) f(i, j) of the state transition, for example, for transition from the state i to a state j. The number of times f(i, j) of the state transition can be calculated in accordance with Formula (10).

$$\begin{matrix}[ Mathematical Formula 10 ] & \\ f ( i , j ) = {\sum }_{t = 1}^{T - 1} ξ ( t , i , j ) & ( 10 )\end{matrix}$$

In Formula (10), ξ(t, i, j) is a function that becomes 1 in a case where it is in the state i at a time t, and it is in the state j at a time t+1 and 0 in other cases, and indicates whether or not the (state) transition from the state i to the state j has been performed between the time t and the time t+1.

For example, the function ξ(t, i, j) of Formula (10) can be calculating by obtaining a maximum likelihood state sequence s={s₁, s₂, . . . , s_{T}} for chronological data, for example, in accordance with the Viterbi algorithm and performing a calculation in accordance with Formula (11) on the basis of the maximum likelihood state sequence s.

[Mathematical Formula 11]

ξ(t,i,j)=δ_{i,s}_{ₜ}δ_{j,s}_{ₜ₊₁} (11)

According to Formula (11), the function ξ(t, i, j) becomes 1 in a case where the state sₜ at the time t is the state i, and the state sₜ₊₁ at the time t+1 is the state j and 0 in other cases.

According to Formula (10), the number of times (frequency) f(i, j) of the (state) transition from the state i to the state j is obtained by adding the function ξ(t, i, j) over the samples (times) of the chronological data, that is, t=1, 2, . . . , T−1.

If the number of times f(i, j) of the transition from the state i to the state j is obtained, a (state) transition probability p (j i) that the transition from the state i to the state j will be performed is obtained in accordance with Formula (12).

$$\begin{matrix}[ Mathematical Formula 12 ] & \\ p ( j \vert i ) = \frac{f ( i , j )}{{\sum }_{j = 1}^{N} f ( i , j )} & ( 12 )\end{matrix}$$

According to Formula (12), the transition probability p (j|i) can be obtained by normalizing the number of times f(i, j) of the transition from the state i to the state j for the state i, that is, by normalizing the total number Σf(i, j) of the transitions that occur when the state i is a transition source.

Further, the number of times of the transition as information of the transition can be incrementally calculated in the so-called incremental manner by using the number of times of the transition found immediately before.

In other words, the number of times of the transitions from the state i to the state j for 1st to s-th chronological data is indicated by f(s, i, j). Further, a function indicating whether or not transition from the state i to the state j has been performed between the time t to the time t+1 for the (s+1)-th chronological data is indicated by ξ(s+1, t, i, j).

In this case, the number of times f(s+1, i, j) of the transitions from the state i to the state j for the 1st to (s+1)-th chronological data can be obtained in accordance with Formula (13) using the number of times f(s, i, j) of the transitions from the state i to the state j for the 1st to s-th chronological data.

$$\begin{matrix}[ Mathematical Formula 13 ] & \\ p ( s + 1 , i , j ) = f ( s , i , j ) + {\sum }_{t = 1}^{T ( s + 1 )} ξ ( s + 1 , t , i , j ) & ( 13 )\end{matrix}$$

Here, in the above case, γ(t, i) is a function indicating whether or not it is in the state i at the time t using 0 or 1, and ξ(t, i, j) is a function indicating whether or not the transition from the state i to the state j has been performed between the time t and the time t+1 using 0 or 1.

In other words, in the above case, γ(t, i) and ξ(t, i, j) are obtained in accordance with Formulas (14) and (15) on the basis of the maximum likelihood state sequence s={s₁, s₂, . . . , s_{T}}.

[Mathematical Formula 14]

γ(t,i)=δ_{i,s}_{ₜ} (14)

[Mathematical Formula 15]

ξ(t,i,j)=δ_{i,s}_{ₜ}δ_{j,s}_{ₜ₊₁} (15)

As γ(t, i) and ξ(t, i, j), in addition to the function that becomes 0 or 1, a posterior probability that has a value in a range of 0 to 1 can be employed.

γ(t, i) and ξ(t, i, j) serving as the posterior probability are indicated by Formulas (16) and (17), respectively.

[Mathematical Formula 16]

γ(t,i)=p(zₜ=i|X={x₁. . . x_{T}}) (16)

[Mathematical Formula 17]

ξ(t,i,j)=p(zₜ=i,zₜ₊₁=j|X={x₁. . . x_{T}}) (17)

In formula (16), p (zₜ=i|X={x₁, x₂, . . . , x_{T}}) indicates a state probability serving as the posterior probability that a state zₜ at the time t will be the state i when chronological data X={x₁, x₂, . . . , x_{T}} is observed.

Further, in Formula (17), p (zₜ=i, zₜ₊₁=j|X={x₁, x₂, . . . , x_{T}}) indicates the posterior probability that the state zₜ at the time t will be the state i and the state zₜ₊₁ at the time t+1 will be the state j when the chronological data X={x₁, x₂, . . . , x_{T}} is observed.

The posterior probability (state probability) p (zₜ=i|X={x₁, x₂, . . . , x_{T}}) of Formula (16) and the posterior probability p (zₜ=i, zₜ₊₁=j|x={x₁, x₂, . . . , x_{T}}) of Formula (17) can be obtained in accordance with Formulas (18) and (19) on the basis of a forward backward algorithm.

$$\begin{matrix} [ Mathematical Formula 18 ] & \\ p ( {z}_{t} = i \vert X = \{ {x}_{1} … {x}_{T} \} ) = \frac{α ( t , i ) β ( t , i )}{{\sum }_{i} α ( t , i ) β ( t , i )} & ( 18 ) \\ [ Mathematical Formula 19 ] & \\ p ( {z}_{t} = i , {z}_{t} = j \vert X = \{ {x}_{1} … {x}_{T} \} ) = \frac{α ( t , i ) β ( t + 1 , j ) p ( {x}_{t} \vert i ) p ( j \vert i )}{{\sum }_{i , j} α ( t , i ) β ( t + 1 , j ) p ( {x}_{t} \vert i ) p ( j \vert i )} & ( 19 )\end{matrix}$$

In Formulas (18) and (19), α(t, i) indicates a forward probability that (the sample value of) the chronological data x₁, x₂, . . . , xₜ will be observed, the forward probability of being in the state i at the time t, and is obtained on the basis of a forward algorithm.

β(t, i) indicates a backward probability that it is in the state i at the time t and thereafter chronological data xₜ₊₁, xₜ₊₂, . . . , x_{T} will be observed and is obtained on the basis of a backward algorithm.

Further, p (xₜ|i) indicates an observation probability that an observation value xₜ will be observed at the time t in the state i, and p (j|i) indicates a transition probability of the transition from the state i to the state j.

Meanwhile, in the normal HMM, it is necessary to decide a network structure of the HMM, that is, a structure of the state transition of the HMM (a structure of the state machine) in advance.

Further, in the learning of the HMM, the parameter of the HMM is obtained, for example, on the basis of a Baum-Welch algorithm so that the (learning) chronological data is applied to the network structure of the HMM.

In the learning of the normal HMM, the network structure of the HMM does not change depending on the learning chronological data.

Meanwhile, the present inventors have developed an HMM which is capable of flexibly extending the network structure (the structure of the state transition) of the HMM by setting similar sections of chronological data to the same state of the HMM by extending an algorithm disclosed in Document A (Japanese Patent Application Laid-Open No. 2012-008659) or Document B (Japanese Patent Application Laid-Open No. 2012-108748). Hereinafter, this HMM is also referred to as an “incremental HMM.”

Further, in the normal HMM, batch learning which is learning for obtaining a parameter using all pieces of chronological data prepared as the learning chronological data at once is performed. In this regard, the normal HMM is also referred to as a “batch learning HMM.”

### <Batch Learning HMM and Incremental HMM>

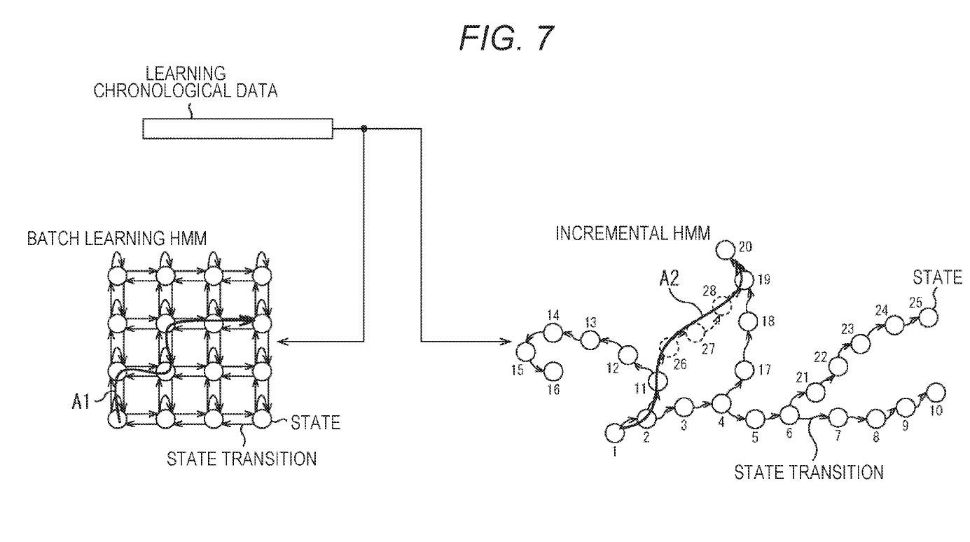

FIG. 7 is a diagram for describing the batch learning HMM and the incremental HMM.

In the batch learning HMM, the network structure (the structure of the state transition) of the batch learning HMM is decided in advance. The network structure of the batch learning HMM is designed by a designer of the batch learning HMM.

As a representative batch learning HMM of the network structure, there are, for example, a unidirectional model (left to right model) and an Ergodic model.

The unidirectional model is, for example, an HMM in which only state transition to a corresponding state or a state on the right side of the corresponding state is allowed for each of states which are linearly arranged in the horizontal direction.

The Ergodic model is an HMM having the highest degree of freedom in which transition to an arbitrary state is allowed.

In the learning of the batch learning HMM, the network structure of the batch learning HMM is determined in advance, and then the learning chronological data is applied to the batch learning HMM at once, and learning (estimation) of the (model) parameter of the batch learning HMM is performed.

In the batch learning HMM, the learning of the parameter is performed so that the learning chronological data is applied to the batch learning HMM in which the network structure is determined in advance.

Further, in the batch learning HMM, in the learning using the learning chronological data, another network structure different from a predetermined network structure is not constructed on the basis of the learning chronological data thereof.

Further, in the batch learning HMM, there are cases in which a network structure in which there is no actual transition between states is constructed when the transition probability between certain states becomes 0 as a result of learning using the learning chronological data. In this case, however, there is a link indicating the state transition between states between the states in which the transition probability is 0, and a network structure in which there is no link, that is, another network structure different from a predetermined network structure is not constructed.

On the other hand, in the learning of the incremental HMM, if the learning chronological data is applied, a portion suitable for the learning chronological data (sates (group) in which the observation value similar to each sample of the learning chronological data is observed) is searched for from the incremental HMM.

Here, if this search is referred to as an “adaptive search,” the adaptive search is carried out using a likelihood p(xₜ|X, θ) of each sample in which each sample value of the learning chronological data is observed in the incremental HMM.

Here, the likelihood p(xₜ|X, θ) indicates a likelihood that the observation value xₜ at the time t when the learning chronological data X={x₁, x₂, . . . x_{T}} is observed in the incremental HMM of a parameter θ.

The likelihood p(xₜ|X, θ) can be obtained in accordance with Formula (20).

$$\begin{matrix}[ Mathematical Formula 20 ] & \\ p ( {x}_{t} \vert X , θ ) = {\sum }_{{z}_{t} = 1}^{N} p ( {x}_{t} \vert {z}_{t} , θ ) p ( {z}_{t} \vert X , θ ) & ( 20 )\end{matrix}$$

In Formula (20), p(xₜ|zₜ, θ) indicates a probability that, in the state zₜ at the time t, the observation value xₜ will be observed in the state zₜ in the incremental HMM of the parameter θ.

p(zₜ|X, θ) indicates the state probability (the posterior probability) in the state zₜ at the time t when the learning chronological data X={x₁, x₂, . . . x_{T}} is observed in the incremental HMM of the parameter θ.

N indicates the number of states in the incremental HMM of the parameter θ.

According to Formula (20), the likelihood p(xₜ|X, θ) that the observation value xₜ will be observed at the time t when the learning chronological data X={x₁, x₂, . . . x_{T}} is observed in the incremental HMM of the parameter θ is obtained by obtaining a sum of the product p(xₜ|zₜ, θ)p(zₜ|X, θ) of the probability p(xₜ|zₜ, θ) that, in the state zₜ at the time t, the observation value xₜ will be observed in the state zₜ and the state probability p(zₜ|X, θ) in the state zₜ at the time t for all the states 1 to N of the incremental HMM of the parameter θ.

The likelihood p (xₜ|X, θ) of Formula (20) indicates the probability that the observation value xₜ serving as the sample value of the learning chronological data will be observed in the incremental HMM, and has a large value when there is a state suitable for the sample value xₜ in the incremental HMM. On the contrary, if there is no state suitable for sample value xₜ in the incremental HMM, the likelihood P (xₜ|X, θ) of Formula (20) has a small value.

In the learning of the incremental HMM, in a case where the value of likelihood p (xₜ|X, θ) is large, and there is a state suitable for the sample value xₜ in the incremental HMM, the sample value xₜ is reflected in (incorporated into) the parameter of the state.

On the other hand, in a case where the value of likelihood p(xₜ|X, θ) is small, and there is no state suitable for the sample value xₜ in the incremental HMM, a new state in which the sample value xₜ is to be reflected is added to the incremental HMM.

Hereinafter, a section of a sample value suitable for the state of the incremental HMM in the section of the learning chronological data is also referred to a “known section,” and a section of a sample value not suitable for the state of the incremental HMM is also referred to as an “unknown section.”

Further, determination of the known section or the unknown section to be performed on the learning chronological data is also referred to as “known unknown determination. In the known unknown determination, the likelihood p (xₜ|X, θ) of Formula (20) on the learning chronological data undergoes a threshold value process. Then, among the sections of the learning chronological data, a section in which the likelihood p (xₜ|X, θ) is larger than a threshold value is determined to be the known section, and a section in which the likelihood p (xₜ|X, θ) is a threshold value or less is determined to be the unknown section.

Since there is no suitable state in the incremental HMM for the unknown section of the learning chronological data, a new state for modeling (learning) the unknown section (a sequence of sample values) is necessary.

In this regard, in the incremental HMM, a new state for modeling the unknown section of the learning chronological data is added.

Examples of an addition method of adding a new state include a rule-based method and a learning-based method.

In the rule-based method, a new state is added in accordance with a state addition rule which is specified in advance.

For example, a case where the learning chronological data is a multi-stream, and thus the sample value of the unknown section has a plurality of pieces of modal data as components is considered. In the rule-based method, a rule that a new state is added in a case where one or two or more pieces of modal data among modal data included in the learning chronological data has a value which is equal to or less than a predetermined value which is designated in advance or a value which is equal or more than a predetermined value or a value within a predetermined range, and a new state is not added in other cases may be employed as the state addition rule.

On the other hand, in the learning-based method, learning of the unknown section of the learning chronological data is performed. The learning of the unknown section of the learning chronological data is performed using another HMM which is newly prepared and different from the incremental HMM. Then, in the learning-based method, a new state is added to the incremental HMM on the basis of a learning result for the unknown section.

In other words, in the learning-based method, as another HMM, for example, a unidirectional model having the number of states equal to or greater than the length of the unknown section (the number of samples) is prepared, and the learning of another HMM is performed in accordance with the Baum-Welch algorithm using the learning chronological data of the unknown section.

Then, a state which is actually used (a state obtained by learning (acquiring) the learning chronological data of the unknown section) among states of another HMM after learning is selected as the new state to be added to the incremental HMM.

In other words, for another HMM after the learning, the maximum likelihood state sequence for the unknown section is obtained, and a state constituting the maximum likelihood state sequence is selected as the new state.

Alternatively, for each state of another HMM after the learning, the state probability (posterior probability) for the unknown section is obtained, and a state having the state probability greater than 0 is selected as the new state.

A state number specifying a state is assigned to the new state to be added to the incremental HMM so that it matches with the state constituting the incremental HMM. In other words, for example, the state number is assigned to the new state so that it becomes a serial number with a state number assigned to the state of the incremental HMM.

Accordingly, the new state suitable for the unknown section is added to the incremental HMM.

Parameters of the new state added to the incremental HMM (an initial probability π, the transition probability a, and the observation model, and the like to be described later) are reset to, for example, 0 as an initial value. Then, for the incremental HMM, learning using the learning chronological data, that is, the update of the parameter θ of the incremental HMM is performed.

As the parameter θ of the incremental HMM, there are three types, that is, the initial probability π, the transition probability a, and (the parameter of) the observation model ϕ, similarly to the batch learning HMM (normal HMM).

Here, the number of states of the incremental HMM is indicated by N.

The initial probability π is an N-dimensional vector having an initial probability πᵢ as a component. The initial probability πᵢ first indicates a probability of being in the state i. In the incremental HMM, in addition to a value obtained by learning, for example, an equal probability 1/N may be used as the initial probability πᵢ.

The transition probability a is an N×N matrix having a transition probability aᵢⱼ as a component. The transition probability aᵢⱼ indicates a probability that a state transition in which the state i is the transition source, and the state j is the transition destination will occur. In a case where most of the transition probability aᵢⱼ is 0, the transition probability a becomes a sparse matrix.

There is an observation model ϕ for each modal (data) serving as a component of chronological data. If the number of modals serving as the component of the chronological data is M, the observation model ϕ is a set of observation models of each modal {ϕ⁽¹⁾, ϕ⁽²⁾, . . . , ϕ^{(M)}}.

Here, ϕ^{(m)} indicates the observation model of an m-th modal among the M modals. There is the observation model ϕ for each state.

The parameter ϕ^{(m)} of the observation model differs depending on a model used for modeling the observation of the m-th (modal) modal data.

For example, in a case where the m-th modal data is a continuous value, and the observation of the modal data is modeled through the Gaussian distribution, the parameter ϕ^{(m)} of the observation model includes an average value μ and a variance σ² of the m-th modal data.

Hereinafter, the average value and the variance of the Gaussian distribution serving as the observation model ϕ^{(m)} of the state i are indicated by μᵢ^{(m)} and σᵢ^{(m)2} (ϕ^{(m)}={μᵢ^{(m)}, σᵢ^{(m)2}}).

Further, for example, in a case where the m-th modal data is a discrete value indicated by K discrete symbols 1, 2, . . . , K, and the observation of the discrete symbol is modeled through the polynomial distribution, the parameter ϕ^{(m)} of the observation model is a probability {p₁, p₂, . . . , p_{K}} that each of the discrete symbols 1, 2, . . . , K will be observed as the m-th modal data.

Hereinafter, the observation probability that the discrete symbol k serving as the observation model ϕ^{(m)} of the state i will be observed is indicated by p_{i, k}^{(m)} (ϕ^{(m)}={p_{i,1}^{(m)}, p_{i,2}^{(m)}, . . . , p_{i,K}^{(m)}}).

In the learning of the incremental HMM (the update of the parameter θ of the incremental HMM), the posterior probability of the state (state probability) γₜ (i) and the posterior probability ξₜ (i, j) of the state transition serving as information indicating how much each sample value of the learning chronological data is suitable for which state of the incremental HMM are calculated.

The posterior probability γₜ(i) of the state indicates a probability of being in the state i at the time t when the learning chronological data is observed, and the posterior probability ξₜ(i, j) of the state transition indicates a probability that the transition from the state i to the state j will be performed at the time t when the learning chronological data will be observed.

The posterior probabilities γₜ (i) and ξₜ (i, j) can be calculated in accordance with Formulas (21) and (22). Further, Formulas (21) and (22) are formulas similar to Formulas (18) and (19), respectively.

$$\begin{matrix}[ Mathematical Formula 21 ] & \\ {γ}_{t} ( i ) = \frac{{α}_{t} ( i ) {β}_{t} ( i )}{{\sum }_{i} {α}_{t} ( i ) {β}_{t} ( i )} & ( 21 ) \\ [ Mathematical Formula 22 ] & \\ {ξ}_{t} ( i , j ) = \frac{{α}_{t} ( i ) {β}_{t + 1} ( j ) p ( {x}_{t} \vert i ) {a}_{ij}}{{\sum }_{i , j} {α}_{t} ( i ) {β}_{t + 1} ( j ) p ( {x}_{t} \vert i ) {a}_{ij}} & ( 22 )\end{matrix}$$

Here, the time length (the number of samples) of the learning chronological data is indicated by T, and the learning chronological data is indicated by X={x₁, x₂, . . . , x_{T}}.

In Formulas (21) and (22), αₜ (zₜ) indicates a forward probability that sample value x₁, x₂, . . . , xₜ of the learning chronological data of up to the time t will be observed, the forward probability of being in the state zₜ at the time t, and is obtained on the basis of the forward algorithm.

In other words, the forward probability αₜ(zₜ) can be obtained in accordance with a recurrence formula indicated by Formula (23).

$$[ Mathematical Formula 23 ]$$

$${α}_{t} ( {z}_{t} ) = \{ \begin{matrix}π ( {z}_{t} ) & t = 0 \\ {\sum }_{{Z}_{t} - 1} p ( {z}_{t} \vert {z}_{t - 1} ) p ( {x}_{t} \vert {z}_{t} ) {α}_{t - 1} ( {z}_{t - 1} ) & 0 < t\end{matrix}$$

In Formula (23), π(zₜ) first indicates an initial probability of being in the state zₜ.

Further, in Formulas (21) and (22), βₜ (zₜ) indicates a backward probability that, after being in the state zₜ at the time t, sample value xₜ₊₁, xₜ₊₂, . . . , x_{T} of the learning chronological data at and after the time t+1 will be observed and is obtained on the basis of the backward algorithm.

In other words, the backward probability βₜ (zₜ) can be obtained in accordance with a recurrence formula indicated by Formula (24).

$$[ Mathematical Formula 24 ]$$

$${β}_{t} ( {z}_{t} ) = \{ \begin{matrix}1 & t = T \\ {\sum }_{{Z}_{t} - 1} p ( {z}_{t} \vert {z}_{t - 1} ) p ( {x}_{t} \vert {z}_{t} ) {β}_{t - 1} ( {z}_{t - 1} ) & t < T\end{matrix}$$

The parameter θ of the incremental HMM, that is, the initial probability π, the transition probability a, and the observation model ϕ are updated as follows using the posterior probability γₜ (i) of Formula (21) and the posterior probability ξₜ (i, j) of Formula (22).

Here, hereinafter, in a case where the chronological data is a multi-stream, and has modal data of two or more (M) modals, description of a suffix (m) indicating the modal will be appropriately omitted.

The initial probability πᵢ is updated to an initial probability π′ᵢ in accordance with Formula (25).

$$[ Mathematical Formula 25 ]$$

$${π}_{i}^{′} = {π}_{i} + {γ}_{i}^{( π )} ( {γ}_{1} ( i ) - {π}_{i} {\sum }_{z = 1 … N} {γ}_{1} ( z ) ) \qquad ( 25 )$$

The transition probability aᵢⱼ is updated to a transition probability a′ᵢⱼ in accordance with Formula (26).

$$[ Mathematical Formula 26 ]$$

$${a}_{ij}^{′} = {a}_{ij} + {γ}_{ij}^{( α )} {\sum }_{t = 1 … T - 1} ( {ξ}_{t} ( i , j ) - {a}_{ij} {\sum }_{z = 1 … N} {ξ}_{t} ( i , z ) ) \qquad ( 26 )$$

The observation probability p_{i, k} which is a parameter in a case where polynomial distribution is used as the observation model ϕ is updated to an observation probability p′_{i, k} in accordance with Formula (27).

$$[ Mathematical Formula 27 ]$$

$${p}_{i , k}^{′} = {p}_{i , k} + {γ}_{i}^{( φ )} {\sum }_{t = 1 … T} {γ}_{t} ( i ) ( {δ}_{k , {x}_{t}} - {p}_{i , k} ) \qquad ( 27 )$$

The average value μᵢ defining the Gaussian distribution serving as the observation model ϕ is updated to an average value μ′ᵢ in accordance with Formula (28).

$$[ Mathematical Formula 28 ]$$

$${μ}_{i}^{′} = {μ}_{i} + {γ}_{i}^{( φ )} {\sum }_{t = 1 … T} {γ}_{t} ( i ) ( {x}_{t} - {μ}_{i} ) \qquad ( 28 )$$

A variance parameter βᵢ used for obtaining a variance σᵢ² defining the Gaussian distribution serving as the observation model ϕ is updated to a variance parameter β′ᵢ in accordance with Formula (29).

$$[ Mathematical Formula 29 ]$$

$${β}_{i}^{′} = {β}_{i} + {γ}_{i}^{( φ )} {\sum }_{t = 1 … T} {γ}_{t} ( i ) ( {x}_{t}^{2} - {β}_{i} ) \qquad ( 29 )$$

The variance σᵢ² can be obtained in accordance with Formula σᵢ²=βᵢ−μᵢ² using the variance parameter βᵢ.

Here, γᵢ^{(π)} of Formula (25), γᵢⱼ^{(a)} of Formula (26), and γᵢ^{(ϕ)} of Formulas (27) to (29) are coefficients used for updating the initial probability π, the transition probability a, and the observation model ϕ.

The coefficients γᵢ^{(π)}, γᵢⱼ^{(a)}, and γᵢ^{(ϕ)} are obtained in accordance with Formulas (30), (31), and (32), respectively.

$$[ Mathematical Formula 30 ]$$

$$\begin{matrix}{γ}_{i}^{( π )} = max ( {γ}_{{min}^{′}}^{( π )} \frac{1}{{N}_{i}^{( π )} + {γ}_{1} ( i )} ) \\ [ Mathematical Formula 31 ] & ( 30 ) \\ {γ}_{ij}^{( a )} = max ( {γ}_{{min}^{′}}^{( a )} \frac{1}{{N}_{ij}^{( a )} + {\sum }_{t = 1 … T - 1} {ξ}_{t} ( i , j )} ) \\ [ Mathematical Formula 32 ] & ( 31 ) \\ {γ}_{i}^{( φ )} = max ( {γ}_{{min}^{′}}^{( φ )} \frac{1}{{N}_{i}^{( φ )} + {\sum }_{t = 1 … T} {γ}_{t} ( i )} ) & ( 32 )\end{matrix}$$

In Formulas (30) to (32), max (X1, X2) indicates a function that outputs a larger one of X1 and X2.

Further, γ^{(π)}ₘᵢₙ, γ^{(a)}ₘᵢₙ, and γ^{(ϕ)}ₘᵢₙ are predetermined constants, and for example, 0 or the like can be employed.

In Formula (30), Nᵢ^{(π)} is a variable in which a posterior probability γ₁(i) is cumulatively added. In Formula (31), Nᵢⱼ^{(a)} is a variable in which the posterior probability ξₜ(i, j) of the time t=1, 2, . . . , T−1 is cumulatively added. In Formula (32), Nᵢ^{(ϕ)} is a variable in which the posterior probability γₜ(i) of the time t=1, 2, . . . , T is cumulatively added.

In the incremental HMM, in order to update the parameter θ after the new state is added (the initial probability π, the transition probability a, and the observation model ϕ), it is necessary to store the variables Nᵢ^{(π)}, Nᵢⱼ^{(a)} And Nᵢ^{(ϕ)} in addition to the parameter θ.

The variables Nᵢ^{(π)}, Nᵢⱼ^{(a)} and Nᵢ^{(ϕ)} correspond to the information of the frequency described with reference to FIG. 6 and the like, the transition probability a corresponds to the information of the transition described with reference to FIG. 6 and the like, and the observation model ϕ corresponds to the information of the distribution of the observation values described with reference to FIG. 6 and the like.

Further, the posterior probabilities γₜ (i) and ξₜ (i, j) may be calculated in accordance with Formulas (21) and (22) respectively and may also be set to 0 or 1 in accordance with a maximum likelihood state sequence for the learning chronological data which is obtained in accordance with the Viterbi algorithm.

In other words, for the posterior probability γₜ (i) at the time t, only the posterior probability γₜ (i) of the maximum likelihood state i at the time t may be set to 1, and posterior probabilities γₜ(i′) of other the states i′ may be set to 0.

Further, for the posterior probability ξₜ (i, j) at the time t, only the posterior probability ξₜ(i, j) of the state transition from the maximum likelihood state i at the time t to the maximum likelihood state j at the time t+1 may be set to 1, posterior probabilities ξₜ (i′, j′) of other state transitions (a posterior probability ξₜ (i, J) of a state transition from the maximum likelihood state i at the time t to the state J other than the maximum likelihood state j at the time t+l and a posterior probability ξₜ(I, J′) of a state transition from a state I other than the maximum likelihood state i at the time t to an arbitrary state J′ at the time t+l) may be set to 0.

In the batch learning HMM of FIG. 7, an arrow A1 indicates a path which the learning chronological data applied to the batch learning HMM passes through. In the batch learning HMM, the learning chronological data is bundled into one of the existing states, and no new state is added.

Further, in the incremental HMM of FIG. 7, an arrow A2 indicates a path which the learning chronological data applied to the incremental HMM passes through.

In the incremental HMM in FIG. 7, a certain section of the learning chronological data is suitable for an existing state 1 and is bundled into the state 1. Similarly, predetermined sections of the learning chronological data are bundled into existing states 2, 11, 19, and 20, respectively.

Further, the other sections of the learning chronological data are not suitable for the existing state of the incremental HMM (not similar to the observation value observed in the existing state), and thus new states 26, 27, and 28 (new states having state numbers 26, 27, and 28) are added to the incremental HMM as states into which the other sections of the learning chronological data are bundled.

Further, the other sections of the learning chronological data are bundled in the new states 26, 27, and 28.

As described above, in the incremental HMM, it is possible to sequentially bundle the learning chronological data while adding the new state as necessary and update the parameter θ (the initial probability π, the transition probability a, and the observation model ϕ).

Meanwhile, according to the network model such as the HMM, it is possible to hold a large number of pieces of chronological data in a minimized form, but in a case where there are a huge number of pieces of learning chronological data, loads for the update of the HMM or the prediction (search) of the chronological data may be large.

In other words, for example, in a case where there are a huge number of pieces of learning chronological data, the scale of the network model is large, and in the large-scale network model, the processing cost for the update of the parameter or the prediction (search) of the chronological data is increased.

Further, a large number of users are expected to access the large-scale network model, but if a large number of users access the network model, access conflicts occur, and the processing time for the process of updating the parameter and predicting the chronological data is increased.

In this regard, in the present technology, it is possible to clip a subset model which is a part of the network model from the network model and update the parameter and predict the chronological data using the subset model.

Further, in the present technology, it is possible to merge (return) the subset model in which the parameter is updated with (to) an original network model.

Here, a scheme of processing the network model in units of subset models, that is, a scheme of clipping the subset model from the network model, performing the update the parameter or the prediction of the chronological data using the subset model, and merging the subset model with the original network model is also referred to as a “subset scheme.”

### <Subset Scheme>

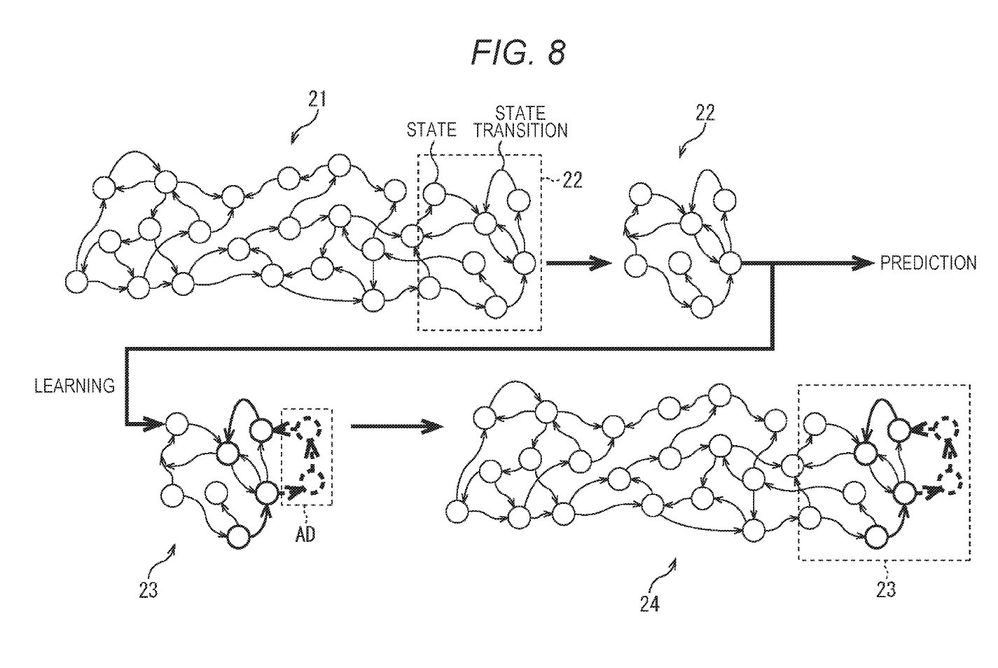

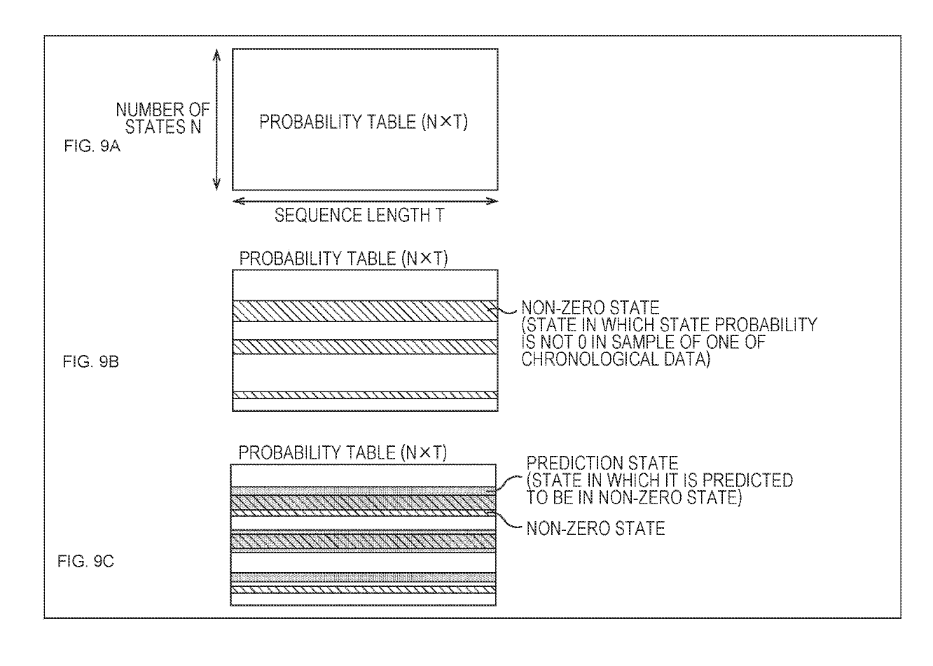

FIG. 8 is a diagram for describing an overview of the subset scheme.

Referring to FIG. 8, a network model 21 is, for example, the entire the incremental HMM and hereinafter also referred to as an “entire HMM 21.” In FIG. 8, the entire HMM 21 has, for example, an Ergodic structure.

In the subset scheme, a subset HMM 22 serving as a subset model which is a part of the HMM 21 is clipped from the entire HMM 21. The subset HMM 22 is an incremental HMM, similarly to the entire HMM 21.

As a clipping method of clipping a state (group) serving as the subset HMM 22 from the entire HMM 21, for example, there are a first clipping method and a second clipping method.

In the first clipping method, a state suitable for the distribution of observation values which are designated in advance is clipped as the state serving as the subset HMM 22.

In other words, in the first clipping method, for example, in a case where chronological data including modal data of a certain modal and chronological data including modal data of another modal are applied as the learning chronological data, when the modal data of each modal is identified by a unique stream Id (Identification), and a predetermined stream Id is designated, it is possible to clip a state in which the modal data of the modal identified by the stream Id can be observed as the observation value as the state serving as the subset HMM 22.

Further, in the first clipping method, for example, when a value or a range of values is designated for an observation value, it is possible to clip a state in which the observation value of the value or the observation value of the range of the values can be observed as the state serving as the subset HMM 22.

Further, in the first clipping method, when a threshold value of the observation probability is designated, it is possible to clip a state in which the observation value can be observed at the observation probability of the threshold value or more or the threshold value or less as the state serving as the subset HMM 22.

In addition, in the first clipping method, when the states of the entire HMM 21 are clustered into a plurality of clusters, using a hash function or the like, and a cluster is designated directly or indirectly, it is possible to clip a state belonging to the cluster as the state serving as the subset HMM 22 at a high speed.

In the second clipping method, a state designated in advance and a state connected to the state are clipped.

In other words, in the second clipping method, for example, one or more states are designated, and a state transitionable from the state is searched for. Then, the state obtained by the search is clipped as the state serving as the subset HMM 22.

Here, in a case where a certain state is set as an initial state, and in a case where a state connected to the initial state directly or indirectly (a state transitionable from the initial state) is searched for, the initial state is also referred to as a “root state.”

One or more states designated in the second clipping method become the root state.

In the second clipping method, a threshold value of a step number (the number of times) for performing the search may be set, and the search for the state may be performed, for example, by the step number equal to the threshold value.

Further, for example, a threshold value of a depth from the root state (the number of state transitions necessary to reach from the root state) may be set, and the search for the state may be performed up to the depth equal to the threshold value.

Furthermore, in the search for the state, for example, a threshold value of a probability that a state sequence whose root state is the initial state will occur as a result of search for the state (for example, a product of transition probabilities of the state transition in which the state sequence occurs) may be set, and the search may be performed for the states of the state sequences occurring at the probability of the threshold value or more.

In addition, the search for the state may be performed, for example, in accordance with a tree search algorithm disclosed in Document C (Japanese Patent Application Laid-Open No. 2011-59924).

Further, in the clipping of the subset HMM 22 serving as the subset model which is a part of the HMM 21 from the entire HMM 21, a copy of the state serving as the subset HMM 22 (and the state transition) in the entire HMM 21 is generated. Therefore, in the clipping of the subset HMM 22 from the entire HMM 21, the state clipped as the subset HMM 22 (and the state transition) is not deleted from the entire HMM 21.

In the subset scheme, the chronological data may be predicted using the subset HMM 22 clipped from the entire HMM 21 as described above.

Therefore, according to the subset scheme, for example, in a server client system including a server and a client, it is possible to store the entire HMM 21 in the server and distribute the subset HMM 22 clipped from the entire HMM 21 to the client. Further, the client is able to predict the chronological data using the subset HMM 22 distributed from the server.

In other words, the client is able to predict the chronological data using the subset HMM 22 distributed from the server without requesting the server to predict the chronological data. In this case, since there is no (little) request for requesting the prediction of the chronological data from the client to the server, it is possible to suppress the increase in the processing time of the server caused by access from a large number of clients to the entire HMM 21 stored in the server in order to request the prediction of the chronological data.

In the subset scheme, learning of the subset HMM 22 (updating of the parameter) can be performed. The learning of subset HMM 22 can be performed by dealing the subset HMM 22 as the incremental HMM.

In FIG. 8, the learning chronological data is applied to the subset HMM 22, and the learning of the subset HMM 22 is performed, and thus the subset HMM 22 is updated to a subset HMM 23.

In the subset HMM 23, two new states indicated by dotted lines in FIG. 8 are added to the subset HMM 22.

In FIG. 8, the learning chronological data passes through a state (and state transition) indicated by a heavy line and the new state (and the state transition) indicated by a dotted line in the subset HMM 23 and is bundled into the passed state.

Further, the state indicated by the heavy line in the subset HMM 23 is a state which a section determined to be the known section in the known unknown determination using the likelihood p(xₜ|X, θ) of Formula (20) among the sections of the learning chronological data passes through. Further, the new state indicated by the dotted lines in the subset HMM 23 is a state which a section determined to be the unknown section in the known unknown determination using the likelihood p(xₜ|X, θ) of Formula (20) among the sections of the learning chronological data passes through.

In the learning of the subset HMM 22, a structure of the subset HMM 23 is configured such that the new state indicated by the dotted line is added to the subset HMM 22 in accordance with the unknown section.

Then, the parameters of the subset HMM 23 (the initial probability π, the transition probability a, and the observation model ϕ) and the variables Nᵢ^{(π)}, Nᵢⱼ^{(a)}, and Nᵢ^{(ϕ)} corresponding to the information of the frequency are updated in accordance with Formulas (25) to (32) using the learning chronological data. In other words, for example, the observation model θ or the like of the state corresponding to (suitable for) the known section in the subset HMM 23 is updated using the sample value of the known section of the learning chronological data. Further, for example, the observation model θ or the like of the state corresponding to (suitable for) the unknown section in the subset HMM 23 is updated using the sample value of the unknown section of the learning chronological data.

In the subset scheme, the updated subset HMM 23 is merged into the entire HMM 21, and thus the entire HMM 21 is updated to an entire HMM 24.

For example, the merge of the updated subset HMM 23 into the entire HMM 21 can be performed by replacing a part of the entire HMM 21 corresponding to the subset HMM 23, that is, a part of the subset HMM 22 which is not updated to the subset HMM 23 with the updated subset HMM 23.

Further, in a case where the state number of the part of the entire HMM 21 corresponding to the subset HMM 23 is different from the state number of the subset HMM 23, when the updated subset HMM 23 is merged into the entire HMM 21, for example, the state number of the subset HMM 23 is changed to coincide with the state number of the part of the entire HMM 21 corresponding to the subset HMM 23.

Further, in a case where a new state is added to the subset HMM 23, the new state added to the subset HMM 23 and a state to be replaced are added to the part of the entire HMM 21 corresponding to the subset HMM 23, and the part corresponding to the subset HMM 23 after the state is added is replaced with the updated subset HMM 23.

According to the subset scheme, for example, in a client CA, it is possible to update the entire HMM by clipping a subset HMM #A from the entire HMM, performing learning of updating the subset HMM #A, and merging the updated subset HMM #A into the entire HMM.

Further, according to the subset scheme, in another client CB, it is possible to update the entire HMM by clipping a subset HMM #B from the entire HMM, performing learning of updating the subset HMM #B, and merging the updated subset HMM #B into the entire HMM.

In a case where the subset HMM #A or #B is merged (into the entire HMM) by replacing the part of the entire HMM corresponding to the subset HMM #A or #B (hereinafter also referred to as a “corresponding part”) with the subset HMM #A or #B, for example, the merge of the subset HMM #A (into the entire HMM) and the merge of the subset HMM #B are sequentially performed, and thus the entire HMM becomes an HMM in which the learning in the client CA and the learning in the client CB are reflected.

On the other hand, in a case where the merge of the subset HMM #A and the merge of the subset HMM #B are performed at the same time, instead of performing the merge of the subset HMM #A or #B by replacing a corresponding part of the entire HMM with the subset HMM #A or #B, it is necessary to perform the merge of the subset HMM #A or #B by updating the parameter of the corresponding part of the entire HMM, for example, using difference information of pieces of the information of the frequency used for the calculation of the parameter between the updated subset HMM #A or #B updated by the learning of the subset HMM #A or #B and the non-updated subset HMM #A or #B.

Hereinafter, a process in a case where the merge of the subset HMM #A and the merge of the subset HMM #B are performed at the same time will be described.

Here, the parameters of the incremental HMM are referred to collectively as a “parameter p,” and the variables Nᵢ^{(π)}, Nᵢⱼ^{(a)} and Nᵢ^{(ϕ)} of Formulas (30) to (32) are referred to collectively as “frequency information F.”

Here, the parameter p and the frequency information F are provided for each state or each state transition of the incremental HMM and are originally indicated by adding a suffix indicating the state or the state transition, but the suffix indicating the state or the state transition is omitted herein.

In the learning of the incremental HMM, the parameter p is roughly calculated in accordance with Formula (33).

$$[ Mathematical Formula 33 ]$$

$$p = \frac{Q}{F} \qquad ( 33 )$$

In Formula (33), Q indicates a temporary variable obtained from the learning chronological data (also referred to as a “temporary variable”). Similarly to the parameter p and the frequency information F, the variable Q is originally indicated by adding a suffix indicating the state or the state transition, but the suffix indicating the state or the state transition is omitted herein.

Here, the parameter p of the entire HMM is indicated by Formula (33), and if the subset HMMs #A and #B are simultaneously merged into the entire HMM to update the entire HMM, a parameter p′ of the updated entire HMM is indicated by Formula (34).

$$[ Mathematical Formula 34 ]$$

$${p}^{′} = \frac{Δ {Q}_{A} + Δ {Q}_{B} + Q}{Δ {F}_{AS} + Δ {F}_{B} + F} \qquad ( 34 )$$

In Formula (34), the frequency information F is information which is stored together with the parameter p for updating the entire HMM. If the frequency information F (before updating) is stored together with the parameter p (before updating), the variable Q can be obtained in accordance with Formula Q=pF using the parameter p and the frequency information F.

ΔF_{A} is difference information between the frequency information F′_{A} after the subset HMM #A is updated and the frequency information F_{A} before updating and is indicated by Formula (35).

[Mathematical Formula 35]

ΔF_{A}=F′_{A}−F_{A} (35)

ΔF_{B} is difference information between the frequency information F′_{B} after the subset HMM #B is updated and the frequency information F_{B} before updating and is indicated by Formula (36).

[Mathematical Formula 36]

ΔF_{B}=F′_{B}−F_{B} (36)

ΔQ_{A} is difference information of the temporary variable obtained from the learning chronological data used to obtain the parameter of the subset HMM #A and is indicated by Formula (37).

[Mathematical Formula 37]

ΔQ_{A}=Q′_{A}−Q_{A}=p′_{A}F′_{A}−p_{A}F_{A} (37)

In Formula (37), Q_{A} and Q′_{A} indicate temporary variables before and after the subset HMM #A is updated, respectively, and p_{A} and p′_{A} indicate parameters before and after the subset HMM #A is updated, respectively.

ΔQ_{B} is difference information of the temporary variable obtained from the learning chronological data used to obtain the parameter of the subset HMM #B and is indicated by Formula (38).

[Mathematical Formula 38]

ΔQ_{B}Q′_{B}−Q_{B}=p′_{B}F′_{B}−p_{B}F_{B} (38)

In Formula (38), Q_{B} and Q′_{B} indicate temporary variables before and after the subset HMM #B is updated, respectively, and p_{B} and p′_{B} indicate parameters before and after the subset HMM #B is updated, respectively.

In a case where the entire HMM is updated by simultaneously merging the subset HMMs #A and #B into the entire HMM, the parameter p′ of the updated entire HMM is calculated in accordance with Formula (34) using the difference information ΔF_{A} of the frequency information F_{A} and the difference information ΔF_{B} of the frequency information F_{B} or the like.

Formula (34) indicating the parameter p′ of the updated entire HMM can be indicated by Formula (39) from Formulas (35) to (38).

$$[ Mathematical Formula 39 ]$$

$${p}^{′} = \frac{{p}_{A}^{′} {F}_{A}^{′} - {p}_{A} {F}_{A} + {p}_{B}^{′} {F}_{B}^{′} - {p}_{B} {F}_{B} + pF}{{F}_{A}^{′} - {F}_{A} + {F}_{B}^{′} - {F}_{B} + F} \qquad ( 39 )$$

p_{A}, p′_{A}, p_{B}, p′_{B}, p, F_{A}, F′_{A}, F_{B}, F′_{B}, and F necessary for a calculation of Formula (39) are the parameters (p_{A}, p_{B}, p) before updating, the parameter (p′_{A}, p′_{B}) after updating, the frequency information (F_{A}, F_{B}, F) before updating, and the frequency information (F′_{A}, F′_{B}) after updating, and thus, when all the parameters are stored, it is possible to update the entire HMM by simultaneously merging the subset HMMs #A and #B into the entire HMM in accordance with Formula (39), that is, obtain the parameter p′ of the updated entire HMM.

Further, when the entire HMM is updated, the frequency information F of the entire HMM is updated to the frequency information F′ in accordance with Formula (40) for next updating of the entire HMM.

[Mathematical Formula 40]

F′=F′_{A}−F_{A}+F′_{B}−F_{B}+F (40)

F_{A}, F′_{A}, F_{B}, F′_{B}, and, F necessary for a calculation of Formula (40) are all information to be stored for the calculation of Formula (39), and therefore, the entire HMM of the frequency information F can be updated to the frequency information F′ in accordance with Formula (40).

In a case where the subset HMMs #A and #B are simultaneously merged into the entire HMM, for example, it is possible to update the parameter p and the frequency information F of the entire HMM in accordance with Formulas (39) and (40) by applying, to the entire HMM, the parameters p_{A} and p′_{A} and the frequency information F_{A} and F′_{A} of the subset HMM #A and the parameters p_{B} and p′_{B} and the frequency information F_{B} and F′_{B} of the subset HMM #B.

Further, the updated entire HMM in a case where the merge of the subset HMM #A and the merge of the subset HMM #B are sequentially performed, does not coincide with the updated entire HMM in a case where the merge of the subset HMM #A and the merge of the subset HMM #B are simultaneously performed.

<Clipping of Subset HMM from Entire HMM>

FIG. 9 is a diagram for describing a calculation performed using the HMM.

Various probabilities such as the posterior probability and the observation probability are calculated for the HMM.

A of FIG. 9 schematically illustrates a memory space in which the probabilities calculated for the HMM are stored.

For example, the probabilities calculated for the HMM are stored in a memory space corresponding to a product of the number of states N of the HMM and the length (the number of samples) (sequence length) T of the chronological data used for the calculation of the probability (hereinafter also referred to as a “probability table”) as illustrated in A of FIG. 9.

Here, in the probability table serving as the memory space of FIG. 9, the horizontal (column) direction indicates the length T of the chronological data, and the vertical (row) direction indicates the number of states N of the HMM.

For most of algorithms of processing the HMM, the calculation of probabilities serving as elements of the probability table causes a bottleneck.

In a case where the number of states N of the HMM is increased, and the size of the HMM is increased, the probability table is increased, and probabilities to be calculated are increased. In other words, a calculation time taken for calculating the probabilities of the probability table is increased in proportion to the number of states N of the HMM.

As described above, it is difficult to increase the scale of the HMM since the calculation time for calculating the probabilities of the probability table is increased in proportion to the number of states N of the HMM.

Meanwhile, in a case where the chronological data used for calculating the probabilities of the probability table (the input chronological data, the learning chronological data, or the like) is not long, the chronological data thereof occupies only a small part of an observation space (a space of the observation value) covered by the HMM.

Therefore, in a case where the chronological data used for calculating the probabilities of the probability table is not long, the number of states in which the probability is to be calculated is not so large.

In other words, the probability table becomes a sparse table in which the probabilities serving as the elements of many rows are all 0.

B of FIG. 9 is a diagram illustrating an example of the probability table which is a sparse table.

For the sake of simplifying the description, if attention is paid only to, for example, the state probability as the probability to be stored in the probability table, non-zero state probabilities are stored only in hatched rows in the probability table of B of FIG. 9, and state probabilities of the other rows become all 0.

Here, for example, in a case where the observation model is the Gaussian distribution, when the average value μ of the Gaussian distribution is far away from each sample value of the chronological data, when the variance of the Gaussian distribution is small, or the like, the state probability of the state with the observation model becomes (almost) 0.

Further, for example, in a case where the observation model is the polynomial distribution, when there is no discrete symbol which can be observed in accordance with the polynomial distribution in the sample value of the chronological data, the state probability of the state having the observation model becomes 0.

If it is possible to exclude the state in which the state probability becomes 0 from the calculation of the state probability in advance, it is possible to reduce the calculation time for the state probability stored in the probability table.

However, it is possible to know whether or not the state probability becomes 0 after the state probability is calculated.

In this regard, in the present technology, non-zero state prediction of predicting the state having a non-zero state probability (or a state in which the state probability is a predetermined minute value (<<1) or more) without calculating the state probability is performed, and it is possible to calculate the state probability stored in the probability table only for the state in which the state probability is predicted to be non-zero (hereinafter also referred to as a “non-zero state”) through the non-zero state prediction.

C of FIG. 9 is a diagram for describing the non-zero state prediction.

A hatched portion in the probability table of C of FIG. 9 indicates a row in which the non-zero state probability is stored.

Further, a shaded portion in the probability table of C of FIG. 9 indicates a row in which it is predicted as the non-zero state through the non-zero state prediction.

As the accuracy of the non-zero state prediction increases, that is, as a coincidence between the shaded part in FIG. 9 and the hatched part in FIG. 9 increases, the efficiency of the calculation of the state probability increases.

The clipping of the subset HMM from the entire HMM can be performed, for example, by predicting the non-zero state through the non-zero state prediction and clipping (extracting) the non-zero state as the state constituting the subset HMM.

In the non-zero state prediction, for example, it is possible to cluster the states of the entire HMM into a plurality of clusters and predict a state belonging to an associated cluster obtained by searching for a cluster to which each sample value of the chronological data belongs as the associated cluster to which the chronological data belongs for the chronological data used for calculating the probabilities of the probability table as the non-zero state.

Then, in the clipping of the subset HMM, it is possible to clip the non-zero state obtained by the non-zero state prediction (the state belonging to the associated cluster) from the entire HMM and constitute the subset HMM in the non-zero state.

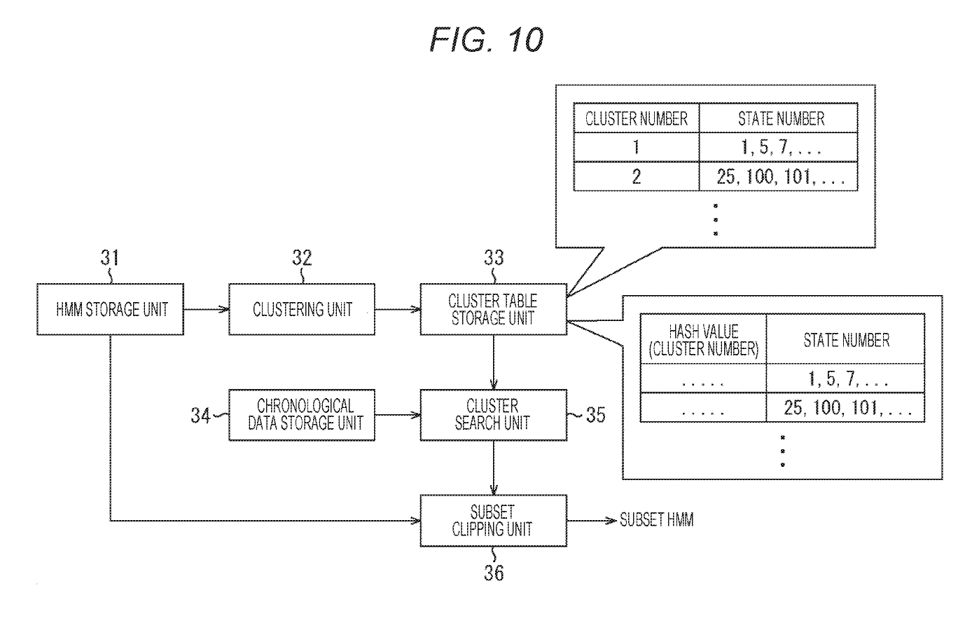

FIG. 10 is a block diagram illustrating a configuration example of a subset HMM generating device that generates the subset HMM by clipping the subset HMM by the non-zero state prediction as described above.

Referring to FIG. 10, the subset HMM generating device includes an HMM storage unit 31, a clustering unit 32, a cluster table storage unit 33, a chronological data storage unit 34, a cluster search unit 35, and a subset clipping unit 36.

The HMM storage unit 31 stores the entire HMM.

The clustering unit 32 clusters the states of the entire HMM stored in the HMM storage unit 31 into a plurality of clusters.

The clustering of the states of the entire HMM in the clustering unit 32 can be performed in accordance with an inter-state distance.

As the inter-state distance, that is, a distance between one state and another state, for example, a distance between the probability distribution of the observation value observed in the one state and the probability distribution of the observation value observed in another state can be employed.

As the distance between the two probability distributions, for example, there is a Kullback-Leibler distance.

In addition, in a case where the observation value observed in the state is the continuous value, for example, a Manhattan distance, a Euclid distance, a Maharabinos distance, or the like which can be calculated using a representative observation value which is a representative value of the observation value of the state (for example, the average value μ in a case where the observation model is the Gaussian distribution) can be employed as the inter-state distance.

Further, an overlapping degree between the probability distribution of the observation values observed in the one state and the probability distribution of the observation values observed in another state is obtained as a similarity between the one state and another state, and a value corresponding to the similarity, that is, for example, a value which is inversely proportional to the similarity can be employed as the distance between the one state and another state.

For example, in a case where the observation model is the Gaussian distribution, a similarity f(i, j) between the state i and the state j can be calculated, for example, in accordance with Formula (41) using (the average value μ and the variance Σ which are) the parameters of the Gaussian distribution.

[Mathematical Formula 41]

f(i,j)≡∫dx\sqrt{N(x;μᵢ,Σᵢ)N(x;μⱼ,Σⱼ)} (41)

In Formula (41), μᵢ and Σᵢ indicate the average value (average vector) and the variance (variance-covariance matrix) of the Gaussian distribution serving as the observation model of the state i, respectively, and x indicates the observation value.

N(x; μ, Σ) indicates the Gaussian distribution in which the average value is μ, and the variance is Σ.

The similarity f(i, j) of Formula (41) becomes 1 when the Gaussian distribution N (x; μᵢ, Σᵢ) of the state i coincides with the Gaussian distribution N (x; μⱼ, Σⱼ) of the state j and becomes 0 or more and less than 1 when the Gaussian distribution N (x; μᵢ, Σᵢ) of the state i does not coincide with the Gaussian distribution N (x; μⱼ, Σⱼ) of the state j.

Further, in a case where a probability distribution other than the Gaussian distribution is employed as the observation model, a function indicating the probability distribution serving as the observation model is used in Formula (41) instead of the Gaussian distribution N(x; μ, Σ).

In a case where the observation model is the polynomial distribution, the similarity f(i, j) between the state i and the state j is calculated, for example, in accordance with Formula (42) using the observation probability that the discrete symbol indicated by the polynomial distribution will be observed.

$$[ Mathematical Formula 42 ]$$

$$f ( i , j ) = {\sum }_{k = 1}^{K} \sqrt{{p}_{i , k} {p}_{j , k}} \qquad ( 42 )$$

In Formula (42), k indicates a discrete symbol, and K indicates the number of discrete symbols. p_{i, k} indicates the observation probability that the discrete symbol k will be observed in the state i.

The similarity f(i, j) of Formula (42) becomes 1 when the polynomial distribution of the state i (the distribution of observation probabilities p_{i,1} to p_{i,K} that the discrete symbols 1 to K will be observed in the state i) coincides with the polynomial distribution of the state j and becomes 0 or more and less than 1 when the polynomial distribution of the state i (the distribution of observation probabilities p_{i,1} to p_{i,K} that the discrete symbols 1 to K will be observed in the state i) does not coincide with the polynomial distribution of the state j.

A distance d(i, j) between the state i and the state j can be calculated from the similarity f(i, j) between the state i and the state j as indicated by Formula (41) or (42), for example, in accordance with Formula (43).

[Mathematical Formula 43]

d(i,j)=−log(f(i,j)) (43)

The distance d(i, j) of Formula (43) has a value closer to 0 as the probability distributions of the observation values observed in the states i and j are closer (as the overlapping increases) and has a larger value as the probability distributions of the observation values observed in the states i and j are far from each other (as the overlapping decreases). Therefore, the distance d(i, j) of Formula (43) can be used as a distance measure between the state i and the state j.

Further, calculations of an integral of Formula (41), a power of a Napier's constant (e) included in a formula indicating the Gaussian distribution N(x; μ, Σ) of Formula (41), roots (≈) of Formulas (41) and (42), and a logarithm (log) of Formula (43) are relatively large in a computational cost.

On the other hand, a calculation of the distance d(i, j) used for clustering is not problematic even if it is not so strict.

The calculations of the integral, the power of the Napier's constant, the root, and the logarithm of Formulas (41) to (43) may be performed by performing an approximate calculation appropriately within a range in which a magnitude relation can be maintained as compared with a case where a strict calculation is performed or may be omitted. For example, the calculations of the roots of Formulas (41) and (42) can be omitted. Further, for example, the calculation of the integral of Formula (41) can be approximated through a calculation for obtaining an area of a trapezoid.

Further, in a case where the observation value observed in the state is a multi-stream, that is, modal data of a plurality of modals, it is possible to obtain the similarly for each piece of modal data and obtain a distance in a form in which the similarities are added.

In other words, if a similarity between the distributions of modal data of a modal m observed in each of the states i and j is indicated by f^{m}(i, j), and (a total of) the number of modals is indicated by M, the distance d(i, j) between the state i and the state j can be calculated in accordance with Formula (44).

$$[ Mathematical Formula 44 ]$$

$$d ( i , j ) = {\sum }_{m = 1}^{M} - log ( {f}^{m} ( i , j ) ) \qquad ( 44 )$$

Further, the addition of (the logarithm log(f^{m}(i, j) of)) the similarities f^{m}(i, j) may be performed by weighted addition using a weight wₘ of each modal m as indicated in Formula (45).

$$[ Mathematical Formula 45 ]$$

$$d ( i , j ) = {\sum }_{m = 1}^{M} - {w}_{m} log ( {f}^{m} ( i , j ) ) \qquad ( 45 )$$

The distance d (i, j) in which the modal m is ignored can be obtained by setting the weight wₘ to 0 in Formula (45). In other words, it is possible to select a modal having influence on clustering and a modal having no influence on clustering.

The clustering of the states of the entire HMM in the clustering unit 32 can be performed in accordance with the inter-state distance d(i, j).

In other words, the clustering of the states can be performed through a technique such as a k-means technique or hierarchical clustering using the inter-state distance d(i, j).

The clustering unit 32 creates a cluster table on the basis of a result of clustering the state of the entire HMM and supplies the cluster table to the cluster table storage unit 33.

At least a cluster number indicating a cluster and a state number of a state belonging to (clustered into) the cluster are registered in the cluster table in association with each other.

The cluster table storage unit 33 stores the cluster table supplied from the clustering unit 32.

The chronological data storage unit 34 stores the chronological data used for the calculation of the probabilities of the probability table, that is, clipping chronological data used for clipping the subset HMM.

For example, in a case where the subset HMM #A for a certain user is clipped, for example, chronological data related to a life event of the user is stored in the chronological data storage unit 34 as the clipping chronological data.

The cluster search unit 35 searches for a cluster to which each sample value of the clipping chronological data belongs as an associated cluster to which the clipping chronological data belongs for the clipping chronological data stored in the chronological data storage unit 34 with reference to the cluster table stored in the cluster table storage unit 33.

In other words, the cluster search unit 35 obtains a distance between each cluster whose cluster number is registered in the cluster table and each sample value of the clipping chronological data, and detects a cluster whose distance is smallest or a cluster whose distance is a threshold value or less as an associated cluster.

A distance between a centroid of the cluster and the sample value of the clipping chronological data can be employed as the distance between the cluster and the sample value of the clipping chronological data.

For example, in a case where the observation model is the Gaussian distribution, the average value of the average value and the variance of the Gaussian distribution serving as the observation model of the state belonging to the cluster can be employed as the average value and the variance of the centroid of the cluster.

Further, in a case where the sample value of the clipping chronological data is associated with distribution information indicating the distribution of the sample values thereof, for the distance between the cluster and the sample value of the clipping chronological data, a similarity between the cluster and the sample value of the clipping chronological data similar to the similarity f(i, j) described in Formula (41) can be obtained from the Gaussian distribution specified by the average value and the variance of the centroid of cluster and the distribution information of the sample value of the clipping chronological data.

Then, the distance between the cluster and the sample value of the clipping chronological data similar to distance d(i, j) described in Formula (43) can be obtained using the similarity between the cluster and the sample value of the clipping chronological data.

On the other hand, in a case where the sample value of the clipping chronological data is not associated with the distribution information indicating the distribution of the sample values thereof, the distance between the cluster and the sample value of the clipping chronological data is obtained using the sample value.

In other words, in a case where the sample value of the clipping chronological data (and the observation value of the observation model) is a continuous value, a similarity f(c, x) between a cluster c and a continuous value x serving as the sample value of the clipping chronological data is obtained in accordance with Formula (46).

[Mathematical Formula 46]

f(c,x)=∫dx′\sqrt{N(x′;μ_{c},Σ_{c})δ(x′−x)} (46)

In Formula (46), N (x′, μ_{c}, Σ_{c}) indicates the Gaussian distribution specified by an average value μ_{c} and a variance Σ_{c} of the centroid of the cluster c. δ(x) is a function that becomes 1 when x=0 and 0 when x is not 0.

In a case where the sample value of the clipping chronological data is a discrete value, a similarity f(c, x) between the cluster c and the discrete value (discrete symbol) x serving as the sample value of the clipping chronological data is calculated in accordance with Formula (47).

$$[ Mathematical Formula 47 ]$$

$$f ( c , x ) = {\sum }_{k = 1}^{K} \sqrt{{p}_{c , k} {δ}_{k , x}} \qquad ( 47 )$$

In Formula (47), p_{c, k} indicates the observation probability that the discrete symbol k will be observed at the centroid of the cluster c. δ_{i, j} indicates a Kronecker delta which is 1 when i=j and 0 when i≠j.

For example, the average of the observation probability that the discrete symbol k will be observed in each state belonging to the cluster c can be employed as the observation probability that the discrete symbol k will be observed at the centroid of the cluster c.

After the similarity f(c, x) is calculated as described above, the distance between the cluster and the sample value of the clipping chronological data can be obtained using the similarity f(c, x), for example, similarly to Formula (43).

Further, in Formula (46), a function with a spread in a value (function value) can be employed instead of the function δ(x). The same applies to δ_{i, j} of Formula (47).

Further, in calculations of Formulas (46) and (47), similarly to the calculations of Formulas (41) to (43), calculations of an integral, a root, and the like may be performed by performing an approximate calculation or may be omitted.

Here, in a case where the observation value observed in the state and the sample value of the clipping chronological data are multi-streams, that is, modal data of a plurality of modals, the distance between the cluster and the sample value of the clipping chronological data can be obtained in a form in which the similarities for respective pieces of modal data are added, similarly to Formula (44) for obtaining the inter-state distance.

Further, the addition may be performed by a weighted addition described in Formula (45).

If the distance between each cluster whose cluster number is registered in the cluster table and each sample value of the clipping chronological data is obtained as described above, the cluster search unit 35 detects a cluster whose distance is smallest or a cluster whose distance is a threshold value or less as an associated cluster to which the clipping chronological data belongs.

Then, the cluster search unit 35 supplies the state number of the state belonging to the associated cluster to the subset clipping unit 36.

The subset clipping unit 36 extracts (clips) the state specified by the state number supplied from the cluster search unit 35 from the entire HMM stored in the HMM storage unit 31, generates the subset HMM constituted by the state, and outputs the subset HMM.

Further, in a case where the associated cluster to which the clipping chronological data belongs is detected using one cluster table, it may be difficult to generate the subset HMM robustly when the clipping chronological data is distributed near the boundary of the cluster.

In this regard, in the generation of the subset HMM, it is possible to generate a plurality of cluster tables by clustering the state through a plurality of clustering methods. Further, in the generation of the subset HMM, it is possible to detect the associated cluster to which the clipping chronological data belongs from each of a plurality of cluster tables and generate the subset HMM in the state belonging to the associated cluster detected from each of the plurality of cluster tables. In this case, in clustering of a certain clustering method, the clipping chronological data is distributed near the boundary of the cluster, but in clustering of other clustering methods, the clipping chronological data can be expected not to be distributed near the boundary of the cluster, and as a result, it is possible to generate the subset HMM robustly. Here, as a plurality of clustering methods, for example, a plurality of clustering methods of different algorithms or a plurality of clustering methods in which the same algorithm is used, but parameters (initial parameters or the like) are different can be employed.

Further, the clustering of the states in the clustering unit 32 and the detection of the associated cluster in the cluster search unit 35 may be performed using a hash function.

It is because, in a case where the clustering of the states is performed in accordance with the inter-state distance, and the cluster in which the distance between the cluster and the sample value of the clipping chronological data is smallest is detected as the associated cluster as described above, it is necessary to calculate the inter-state distance or the distance between the cluster and the sample value of the clipping chronological data, the computational cost of these distances may be relatively large, but it is possible to suppress the computational cost using the hash function.

Next, an example in which the clustering of the states in the clustering unit 32 and the detection of the associated cluster in the cluster search unit 35 are performed using the hash function will be described.

In the clustering of the states, since the states in which the observation values observed in the state are near have to be clustered into the same cluster, it is possible to use a hash function of a type that outputs the same value when close values are input in the clustering of the states.

Here, as a hash function of a type that outputs the same value when close values are input, there is a locality sensitive hashing (LSH) or the like. In the locality sensitive hashing, an algorithm differs depending on a distance function of defining a distance of an input value.

In a case where the observation model of the state of the entire HMM is, for example, the Gaussian distribution, the Euclid distance can be used as the distance of the observation value. For the Euclid distance, for example, a pStable algorithm can be employed as a locality sensitive hashing algorithm. According to the pStable algorithm, it is possible to efficiently search for adjacent samples in response to a query and lists the adjacent samples.

The pStable algorithm is described in detail, for example, Datar, M.; Immorlica, N., Indyk, P., Mirrokni, V. S. (2004), “Locality-Sensitive Hashing Scheme Based on p-Stable Distributions,” Proceedings of the Symposium on Computational Geometry.

In the clustering of the states using the hash function, for example, the clustering unit 32 inputs the average value of the Gaussian distribution which is the observation value with the highest probability of observation in the state to the hash function and obtains a hash value (an output of the hash function).

The clustering unit 32 obtains the hash value for all the states of the entire HMM and detects the state having the same hash value.

Then, the clustering unit 32 generates the cluster table in which the state number of the state having the same hash value is associated with the hash value, and stores the cluster table in the cluster table storage unit 33.

In this case, it is possible to deal the hash value of the cluster table as the cluster number indicating the cluster.

In the detection of the associated cluster using the hash function, the cluster search unit 35 inputs each sample value of the clipping chronological data into the hash function and obtains the hash value.

Further, for each sample value of the clipping chronological data, the cluster search unit 35 detects a cluster in which the hash value of that sample value is used as the cluster number as the associated cluster to which the clipping chronological data belongs.

If the associated cluster is detected, the cluster search unit 35 supplies the state number of the state belonging to the associated cluster to the subset clipping unit 36.

As described above, in a case where the clustering of the states and the detection of the associated cluster are performed using the hash function, it is possible to perform the clustering of the states and the detection of the associated cluster without calculating, for example, the distances between the states.

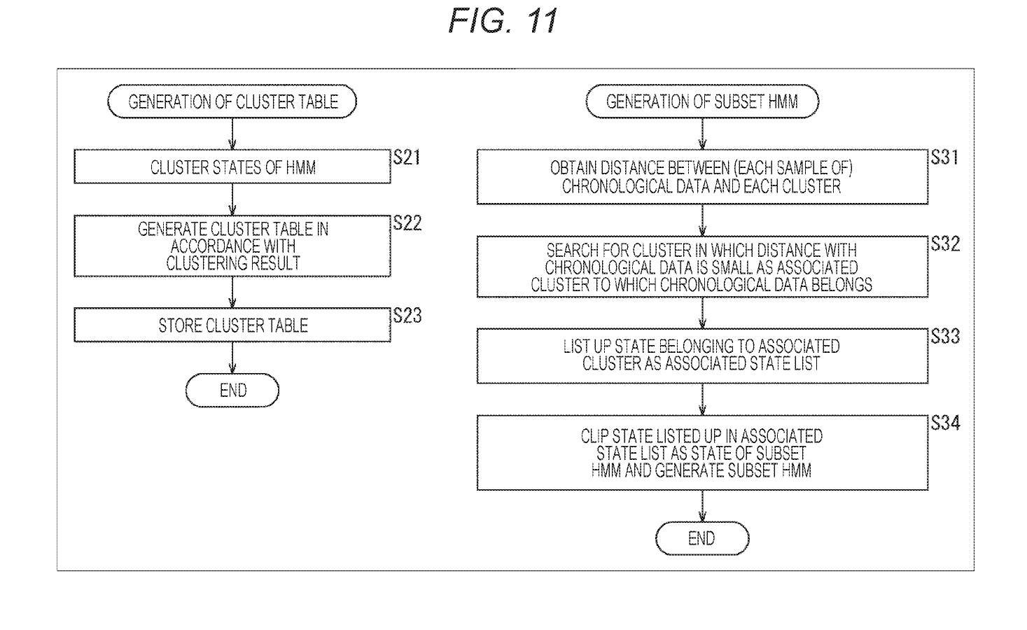

FIG. 11 is a flowchart for describing an example of a cluster table generation process and an example of a subset HMM generation process performed by the subset HMM generating device of FIG. 10.

Further, in the following description, for example, the clustering of the states is assumed to be performed in accordance with the inter-state distance, and the associated cluster is assumed to be detected in accordance with the distance between the cluster and the sample value of the clipping chronological data.

In the generation of the cluster table, in step S21, the clustering unit 32 clusters the states of the entire HMM stored in the HMM storage unit 31 into a plurality of clusters in accordance with the inter-state distance, and the process proceeds to step S22.

In step S22, the clustering unit 32 generates the cluster table in which the cluster number and the state number are registered in association with each other in accordance with a result of the clustering in step S21, and supplies the cluster table to the cluster table storage unit 33, and the process proceeds to step S23.

In step S23, the cluster table storage unit 33 stores the cluster table supplied from the clustering unit 32, and the cluster table generation process ends.

In the generation of the subset HMM, in step S31, the cluster search unit 35 obtains the distance between each cluster whose cluster number is registered in the cluster table stored in the cluster table storage unit 33 and each sample value of the clipping chronological data stored in the chronological data storage unit 34, and the process proceeds to step S32.

In step S32, the cluster search unit 35 detects (searches for) a cluster in which the distance between the cluster and the sample value of the clipping chronological data is small (the cluster in which the distance is a threshold value or less) as the associated cluster for the clipping chronological data, and the process proceeds to step S33.

In step S33, the cluster search unit 35 lists up (registers) (the state number of) the state belonging to the associated cluster with reference to the cluster table stored in the cluster table storage unit 33, and supplies the state to the subset clipping unit 36, and the process proceeds to step S34.

Here, the list in which the state belonging to the associated cluster is registered is also referred to an “associated state list.”

In step S34, the subset clipping unit 36 extracts the state listed in the associated state list supplied from the cluster search unit 35 from the entire HMM stored in the HMM storage unit 31, and generates and outputs the subset HMM constituted by the state, and the subset HMM generation process ends.

The subset HMM generation process of FIG. 11 corresponds to the process using the first clipping method described with reference to FIG. 8.

Meanwhile, in the generation of the subset HMM of FIG. 11, the subset HMM is generated using only the state belonging to the associated cluster for the clipping chronological data, but only the state belonging to the associated cluster may be insufficient as the state of the subset HMM.

In other words, for example, in a case where the subset HMM #A for a certain user A is clipped, when chronological data related to a life event of the user A is used as the clipping chronological data, and the subset HMM is generated using only the state belonging to the associated cluster for the clipping chronological data, the state in which the observation value which can be observed as the life event of the user A is observed is not covered in the subset HMM.

In this regard, the subset HMM can be constituted using a state transitionable from the state belonging to the associated cluster in addition to the state belonging to the associated cluster for the clipping chronological data.

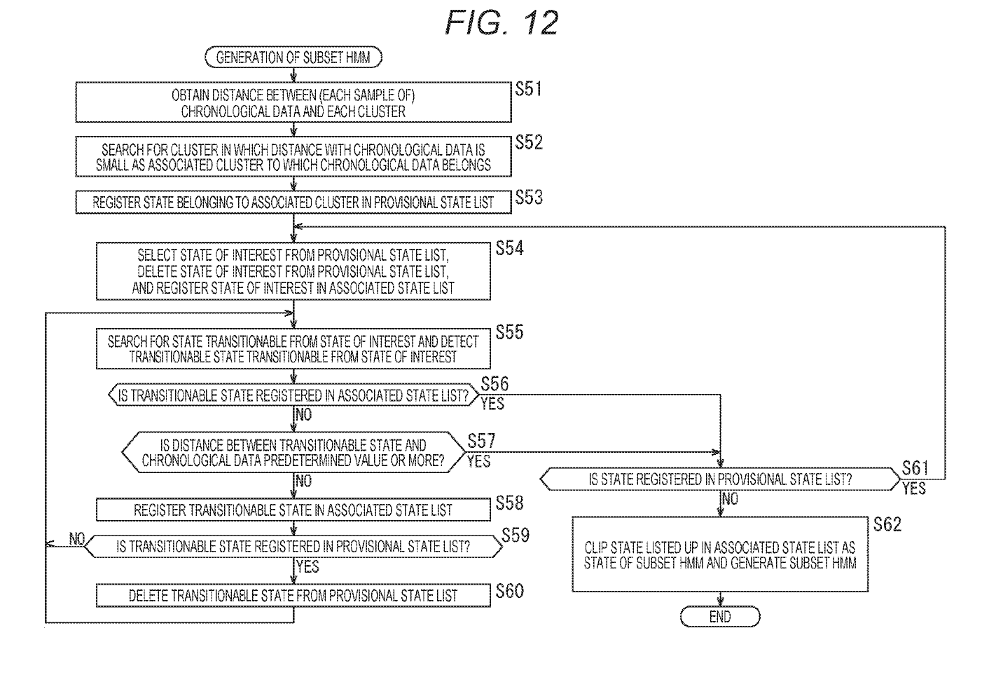

FIG. 12 is a flowchart illustrating a subset HMM generation process for generating the subset HMM constituted by the state belonging to the associated cluster for the clipping chronological data and the state transitionable from the state belonging to the associated cluster.

In step S51, similarly to step S31 of FIG. 11, the cluster search unit 35 obtains the distance between each cluster whose cluster number is registered in the cluster table and each sample value of the clipping chronological data, and the process proceeds step S52.

In step S52, similarly to S32 in FIG. 11, the cluster search unit 35 detects the cluster in which the distance between the cluster and the sample value of the clipping chronological data is small as the associated cluster for the clipping chronological data, and the process proceeds to step S53.

In step S33, the cluster search unit 35 registers (lists up) (the state number of) the state belonging to the associated cluster in a provisional state list with reference to the cluster table stored in the cluster table storage unit 33, and the process proceeds to step S54.

In step S54, the cluster search unit 35 selects one of the states registered in the provisional state list as a state of interest. Further, the cluster search unit 35 deletes the state of interest from the provisional state list and registers (the state number of) the state of interest in the associated state list, and the process proceeds from step S54 to step S55.

In step S55, the cluster search unit 35 detects one of states transitionable from the state of interest (hereinafter also referred to as “transitionable states”) by sequentially perform a search (tree search) for a state transitionable from the state of interest in the entire HMM stored in the HMM storage unit 31, for example, starting from a state close to the state of interest, and the process proceeds to step S56.

Here, the search for the transitionable state in step S55 can be performed by, for example, the method described in Document C mentioned above.

In step S56, the cluster search unit 35 determines whether or not the transitionable state detected in step S55 has been registered in the associated state list.

In a case where the transitionable state is determined not to have been registered in the associated state list in step S56, the process proceeds to step S57.

In step S57, the cluster search unit 35 determines whether or not the distance between the transitionable state detected in step S55 and each sample value of the clipping chronological data is a predetermined value or more.

In a case where the distance between the transitionable state and each sample value of the clipping chronological data is determined not to be a predetermined value or more in step S57, the process proceeds to step S58.

In step S58, the cluster search unit 35 registers (the state number of) the transitionable state detected in step S55 in the associated state list, and the process proceeds to step S59.

Therefore, the transitionable state is registered in the associated state list only in a case where the transitionable state detected in step S55 is not registered in the associated state list, and the distance between the transitionable state and each sample value of the clipping chronological data is not a predetermined value or more.

In step S59, the cluster search unit 35 determines whether or not the transitionable state registered in the associated state list in step S58 is registered in the provisional state list.

In a case where the transitionable state registered in the associated state list is determined to be registered in the provisional state list in step S59, the process proceeds to step S60.

In step 560, the cluster search unit 35 deletes the transitionable state registered in the provisional state list from the provisional state list. Then, the process returns from step S60 to step S55, the search for the transitionable state is continued, and a next transitionable state is detected.

On the other hand, in a case where the transitionable state is determined to be registered in the associated state list in step S56 or in a case where the distance between the transitionable state and each sample value of the clipping chronological data is determined to be a predetermined value or more in step S57, the search for the transitionable state transitionable from the state of interest is stopped, and the process proceeds to step S61.

In step S61, the cluster search unit 35 determines whether or not the state is still registered in the provisional state list.

In a case where the state is determined to be still registered in the provisional state list in step S61, the process returns to step S54, one of the states registered in the provisional state list is newly selected as the state of interest, and then the similar process is repeated.

Further, in a case where the state is determined not to be registered in the provisional state list in step S61, that is, in a case where the search for the transitionable state transitionable from the corresponding state is stopped for all the states belonging to the associated cluster registered in the provisional state list, the cluster search unit 35 supplies the associated state list to the subset clipping unit 36, and the process proceeds to step S62.

In step S62, the subset clipping unit 36 extracts the state listed up in the associated state list supplied from the cluster search unit 35 from the entire HMM stored in the HMM storage unit 31, similarly to step S34 of FIG. 11, and generates and outputs the subset HMM constituted by the state, and the subset HMM generation process ends.

The subset HMM generation process of FIG. 12 corresponds to a process using both the first clipping method and the second clipping method described with reference to FIG. 8.

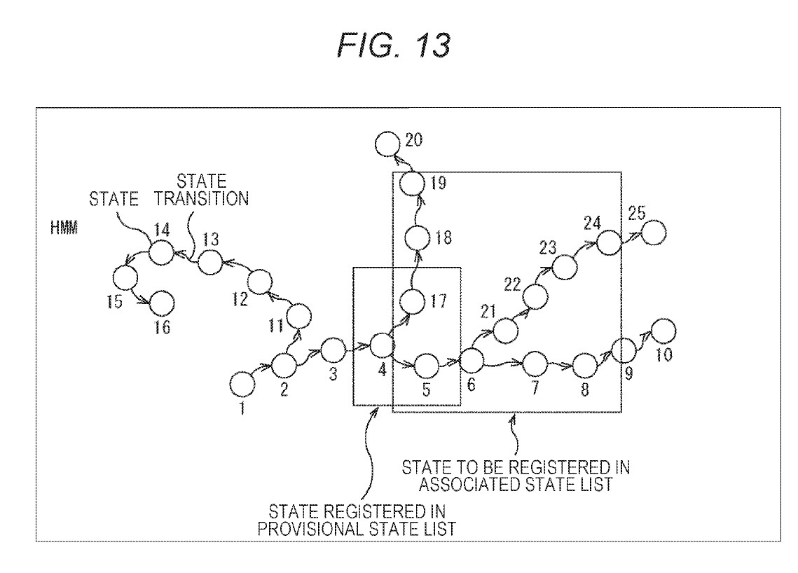

FIG. 13 is a diagram for further describing the subset HMM generation process for generating the subset HMM constituted by the state belonging to associated clusters for the clipping chronological data and the state transitionable from the state belonging to the associated cluster.

Referring to FIG. 13, states 4, 5, and 17 are detected as the state belonging to the associated cluster for the clipping chronological data, and are registered in the provisional state list.

Further, in FIG. 13, for each of the states 4, 5, and 17, the transitionable states transitionable from the state are searched for, and states 6 to 9, 18, 19, and 21 to 24 are detected as the transitionable states.

Thus, in FIG. 13, the states 4, 5, and 17 serving as the state belonging to the associated cluster and the states 6 to 9, 18, 19, and 21 to 24 serving as the transitionable states are registered in the associated state list.

According to the incremental HMM and the subset scheme as described above, it is possible to reduce the storage capacity as compared with the case where the chronological data is stored without change.

Further, according to the incremental HMM and the subset scheme, it is possible to reduce the occurrence of the combination explosion.

Further, according to the incremental HMM and the subset scheme, it is possible to reduce the computational cost.

Further, according to the incremental HMM and the subset scheme, it is possible to perform additional learning.

Further, according to the incremental HMM and the subset scheme, it is possible to increase a degree of freedom in the structure of the HMM, that is, the number of states or the state transition.

Further, according to the incremental HMM and the subset scheme, since it is possible to perform the learning (update) and the prediction in units of subset HMMs although the scale of the entire HMM is large, it is possible to perform the learning and the prediction at a small computational cost.

Further, according to the incremental HMM and the subset scheme, the subset HMM clipped from the entire HMM can be transmitted from the server to the client, and the client is able to apply the chronological data related to the life event of the user to the subset HMM and perform the learning of the subset HMM or the prediction of the chronological data.

Therefore, since it is possible to perform the learning and the prediction without transmitting the chronological data related to the life event of the user to the server, in a case where the chronological data related to the life event of the user is transmitted from the client to the server, it is possible to avoid a privacy problem occurring when the chronological data is wiretapped.

<Configuration Example of Predicting Device that Predicts Predictive Chronological Data Using Network Model>

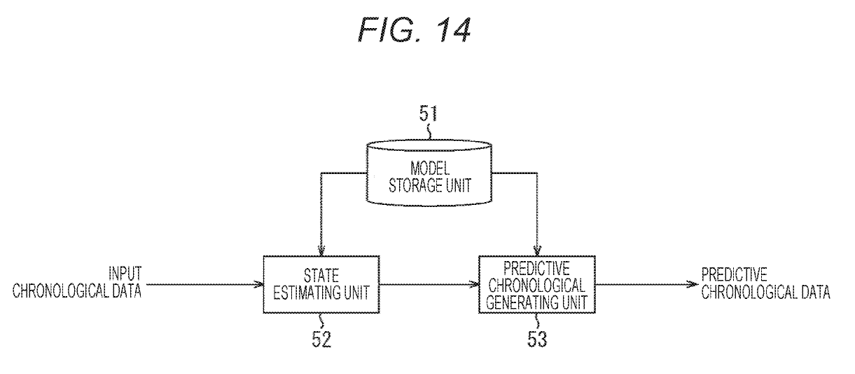

FIG. 14 is a block diagram illustrating a configuration example of a predicting device that predicts (generates) predictive chronological data using a network model.

Referring to FIG. 14, the predicting device includes a model storage unit 51, a state estimating unit 52, and a predictive chronological generating unit 53.

The model storage unit 51 stores, for example, (a parameter of) a network model such as the incremental HMM.

Chronological data to be used for predicting the future is supplied to the state estimating unit 52 as the input chronological data serving as a query.

The state estimating unit 52 calculates the state probability of stays in each state of the incremental HMM stored in the model storage unit 51 using the input chronological data. Further, the state estimating unit 52 estimates a current state which is a state in which it currently stays in the incremental HMM on the basis of the state probability, and supplies the estimated current state to the predictive chronological generating unit 53.

Here, examples of a method for estimating the current state include the Viterbi algorithm and forward algorithm. For example, according to the Viterbi algorithm, it is possible to estimate a current state (a node constituting a network model) having the highest likelihood from the input chronological data. Further, according to the forward algorithm, it is possible to obtain the probability distribution of the current state from the input chronological data.

Further, the state estimating unit 52 is able to efficiently perform the process on the input chronological data by utilizing the incremental HMM stored in the model storage unit 51 sufficiently as compared with the search unit 11 of the predicting device of FIG. 4.

On the basis of the incremental HMM stored in the model storage unit 51, the predictive chronological generating unit 53 predicts one or more pieces of chronological data of a future farther than the input chronological data for the current state supplied from the state estimating unit 52 and outputs the predicted chronological data as the predictive chronological data.

In other words, the predictive chronological generating unit 53 reconstructs the chronological data of a future farther than the input chronological data using the state transition of the incremental HMM stored in the model storage unit 51.

The reconstruction (prediction) of the chronological data using the state transition of the HMM may be performed by employing, for example, a method described in Patent Document 2, Document A, or Document D (Japanese Patent Application Laid-Open No. 2011-252844). For example, according to the method described in Document A, it is possible to repeatedly search for a state of a transition destination to which the state transition can be performed starting from the current state, list the state sequence, arrange a representative value of the observation value observed in each state of the state sequence (for example, the average value of the Gaussian distribution or the discrete symbol having the highest observation probability) for each modal, and obtain the chronological data of the multi-stream as the future chronological data.

Further, in the predicting device of FIG. 14, there is no loop of feeding back the predictive chronological data from the predictive chronological generating unit 12 to the search unit 11 as new input chronological data as in the predicting device of FIG. 4.

Therefore, in the predicting device of FIG. 14, a high-load process such as the search for the chronological data from the chronological database 10 is not repeated as in the predicting device illustrated in FIG. 4.

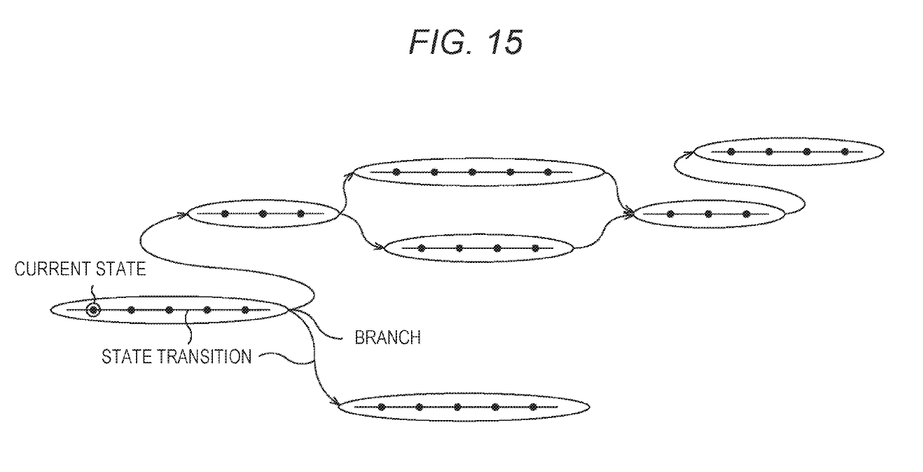

FIG. 15 is a diagram for describing an example of generating (predicting) the predictive chronological data in the predictive chronological generating unit 53 of FIG. 14.

The predictive chronological generating unit 53 performs the tree search of generating the state sequence while sequentially tracking the state transition starting from the current state of the incremental HMM stored in the model storage unit 51. In the tree search, the state transition may be branched, but in the branch of the state transition, for example, the state transition that is preferentially traced is decided in accordance with the transition probability or the like.

The tree search can be performed in accordance with either of a depth priority or a width priority. It is possible to decide which of the depth priority and the width priority is employed in accordance with designation or the like from the user or an application, for example.

The tree search ends when a predetermined end condition is satisfied.

As the end condition, for example, a condition that it reaches a state set as an end state in advance, a condition that it reaches an end point state in which there are only state transition returning to a transition source and self transition, a condition that it reaches any one state of a state group connected by state transition configuring a loop, or the like can be employed.

Further, in a case where the condition that it reaches a state set as an end state in advance is employed as the end condition, for example, a state in which the parameter of the observation model satisfies a predetermined condition can be employed as the end state.

Further, the state sequence obtained as a result of tree search varies depending on the end condition of the tree search.

The predictive chronological generating unit 53 ends the tree search if the end condition is satisfied. As a result of tree search, a state sequence in which the states of the transition destination of the state transition traced through the tree search are sequentially arranged starting from the current state is obtained.

The number of state sequences obtained through the tree search corresponds to the number of branches occurring in the tree search.

The predictive chronological generating unit 53 generates chronological data having a representative value of the observation value observed in each state constituting the state sequence (for example, the average value of the Gaussian distribution) as sample value as the predictive chronological data for each of one or more state sequences obtained as a result of the tree search.

Further, in a case where the tree search is performed by the method described in Document A or Document D, it is possible to obtain a probability that it will reach a specific state designated in advance. Furthermore, it is possible to obtain a probability that (a sequence of) a predetermined observation value will be observed (for example, a probability that a predetermined life event will be observed (occur)) using the probability that it will reach a specific state. A similar process can also be performed by the method described in Patent Document 2.

### <Presentation of Future Life Event>

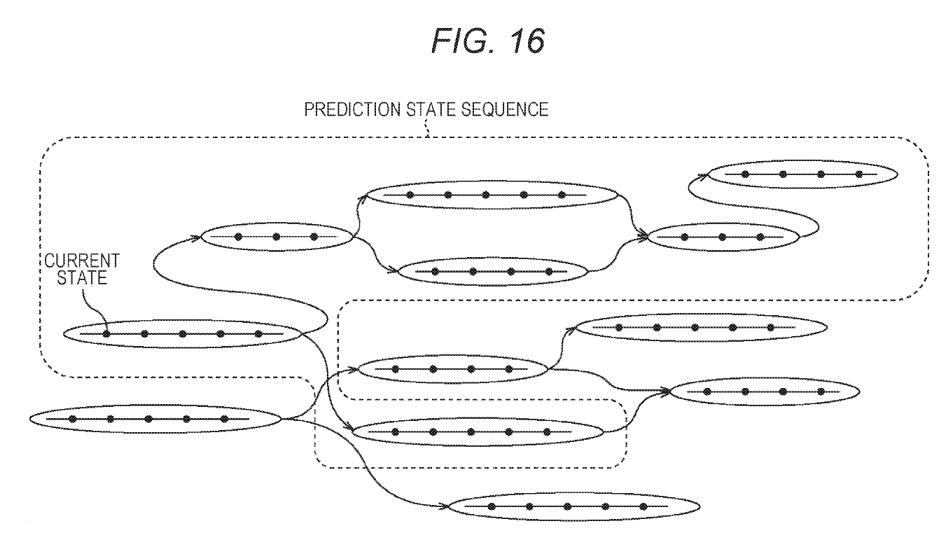

FIG. 16 is a diagram for describing an example of presentation of a future life event.

In the predicting device of FIG. 14, when the learning of the incremental HMM stored in the model storage unit 51 is performed using, for example, the chronological data related to the life event, it is possible to obtain the predictive chronological data obtained by predicting the chronological data related to the life event, the state sequence in which the predictive chronological data is observed (hereinafter also referred to as a “prediction state sequence”), or the like. Further, it is possible to obtain the future life event which is a prediction result for the life event from the predictive chronological data or the prediction state sequence.

Here, the state sequence (including the prediction state sequence) in the present specification means a sequence of states which are arranged in a straight line form without branching (hereinafter also referred to as a “straight line sequence”) or a sequence of states constituting a network structure with branching or merging (hereinafter also referred to as a “network sequence”). The network sequence is a sequence obtained by collecting a plurality of straight line sequences and expressed such that a common (identical) state between a certain straight line sequence and another straight line sequence is collected as one state.

For the future life event obtained from the predictive chronological data or the prediction state sequence, it is requested to present the future life event to the user in an easy-to-understand manner.

FIG. 16 schematically illustrates, for example, an example of display of the future life event as the presentation of the future life event.

As the display of the future life event, for example, the network structure of the prediction state sequence (network sequence) can be displayed without change.

However, in a case where the prediction state sequence is displayed without change, it is difficult for the user to understand what the prediction state sequence means by viewing the display of the prediction state sequence.

In this regard, for the prediction state sequence, it is possible to assign a life event corresponding to a representative value of the observation value observed in each of the states constituting the prediction state sequence to each state and display the life event.

In this case, the user is able to recognize the prediction state sequence, a concept on an observation space, that is, a connection with a life event, and branching or merging of a life event to occur in the future.

Further, in the prediction state sequence, for a branch at which state transition from one state to a plurality of states may occur, it is possible to easily calculate a score for state transition to each of a plurality of states using the transition probability or the like.

In the branching of the prediction state sequence, the score for the state transition to each of a plurality of states is displayed, and thus the user is able to recognize the likelihood that that the life event corresponding to each of a plurality of states at the branch destination will occur, for example.

Further, for each of the states of the prediction state sequence, a score reaching the state (from the current state) can be easily calculated using the transition probability or the like.

In each state of the prediction state sequence, the score reaching the state is displayed, and thus the user is able to recognize the likelihood that the life event corresponding to each state of the prediction state sequence will occur.

In FIG. 16, the prediction state sequence is displayed in a form included in the structure of the incremental HMM together with the incremental HMM stored in the model storage unit 51 (or the subset HMM clipped from the incremental HMM).

As described above, the prediction state sequence is displayed along with the incremental HMM, and thus the user is able to recognize the current state as its own position in the entire incremental HMM.

Further, the user is able to recognize the life event corresponding to the state which is unable to be reached from the current state (when the state transition is traced) among the states of the incremental HMM as a life event which is unable to occur in the future.

Meanwhile, in a case where the scale of the incremental HMM stored in the model storage unit 51 of the predicting device of FIG. 14 or the prediction state sequence is large, it is difficult to display the entire prediction state sequence or the entire incremental HMM including the prediction state sequence.

In this regard, in the display of the future life event, it is possible to simplify and display the prediction state sequence without display the prediction state sequence without change.

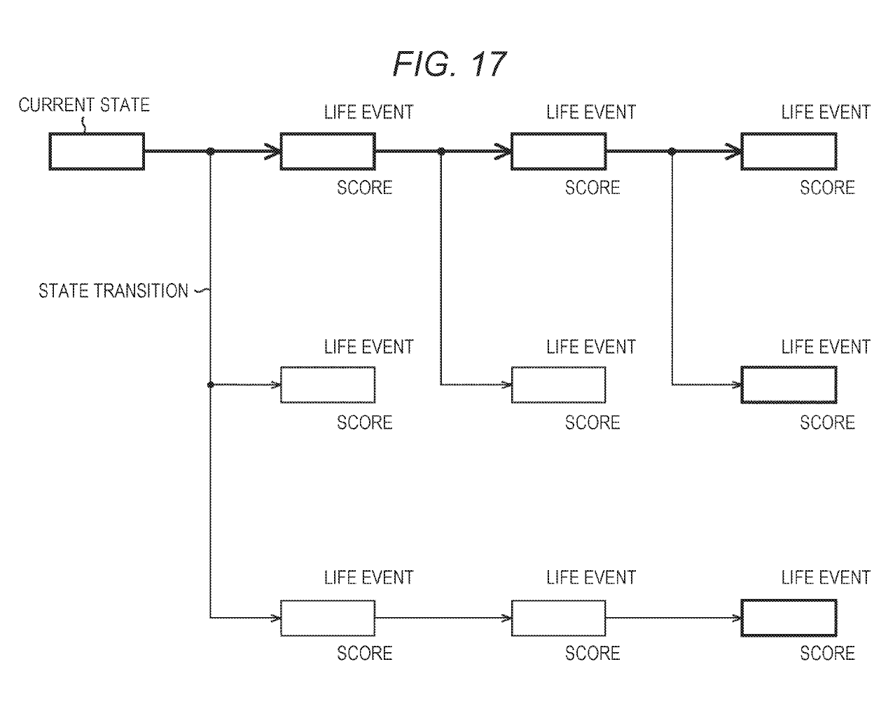

FIG. 17 is a diagram illustrating a display example of simplifying and displaying the prediction state sequence.

Referring to FIG. 17, (a symbol indicating) a life event corresponding to a current state among the states of the prediction state sequence and a life event corresponding to a state corresponding to a predetermined characteristic life event are displayed in a network structure along with the score reaching the state corresponding to each life event.

In other words, in FIG. 17, for example, one or more states are selected as the state corresponding to the characteristic life event from the state group in units of state groups located from a certain branch or merge of the prediction state sequence to a next branch or merge, and (a symbol indicating) a life event corresponding to the state is displayed.

As described above, not (the life event corresponding to) all the states of the prediction state sequence but the state corresponding to the characteristic life event is selected from the states of the prediction state sequence, the state is narrowed down, and the prediction state sequence is displayed, and thus the user is able to look down upon the overall image of the prediction state sequence easily.

Further, even in a case where the prediction state sequence is displayed together with the incremental HMM, it is possible to similarly select and display the state corresponding to the characteristic life event.

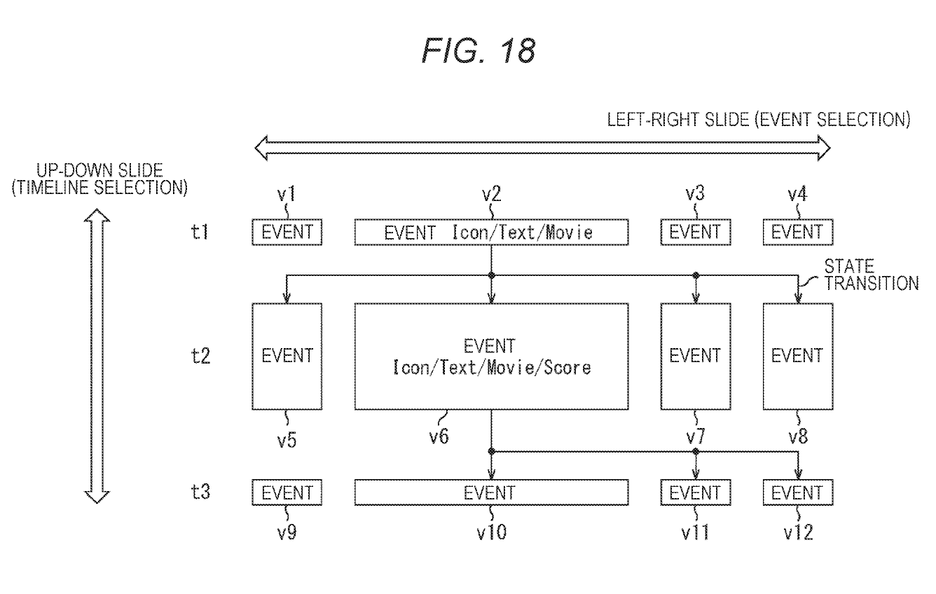

FIG. 18 is a diagram illustrating a display example of displaying the prediction state sequence.

In other words, FIG. 18 illustrates a display example of the future life event obtained from the prediction state sequence or the like.

Referring to FIG. 18, the network structure of(the symbol indicating) the life event corresponding to the state of the prediction state sequence (or the state corresponding to the characteristic life event among the states of the prediction state sequence) is chronologically displayed on the basis of the score in which the life event will occur.

In other words, in FIG. 18, the life event corresponding to the state of the prediction state sequence is displayed with two orthogonal directions indicating a score and a time at which the life event occurs, respectively. Specifically, a horizontal axis indicates the score at which the life event will occur, a vertical axis indicates a time (order) at which the life event will occur, and the life events corresponding to the states of the prediction state sequence are displayed in the order of scores and the time order.

For example, in FIG. 18, a rightward direction is a direction in which the score decreases, and therefore, the life events arranged in a certain row are arranged rightwards in order of likelihood.

Further, for example, in FIG. 18, a downward direction is a direction in which a time elapses, and thus, the life event at the lowest position is the farthest future life event.

Further, in this case, the rightward direction is the direction in which the score decreases, the downward direction is the direction in which the time elapses, but the direction in which the score decreases or the direction in which the time elapses are not limited thereto.

In other words, for example, a leftward direction may be the direction in which the score decreases, and an upward direction may be the direction in which the time elapses. Further, for example, the rightward direction may be the direction in which the time elapses, and the downward direction may be the direction in which the score decreases. Further, for example, the score may be assumed to be highest at a central portion of the screen in the horizontal direction, and the score may be assumed to decrease as a distance from the central portion in each of the leftward direction and the rightward direction increases.

Here, a display in which the network structure of the life event corresponding to the state of the prediction state sequence is arranged in the score order and the time order as in the display example of FIG. 18 is also referred to as a “score/time order display.”

According to the score/time order display, it is possible to display the future life events for the user in an easy-to-understand manner.

In other words, according to the score/time order display, since the future life events are displayed in the score order, the user is able to easily recognize a life event which is likely to occur.

Further, according to the score/time order display, since the future life events are displayed side by side in the time order, it is easy to recognize an order in which the life events occur.

Further, in the score/time order display, in a case where the network structure of the life event corresponding to the state of the prediction state sequence is unable to be displayed within one screen, the network structure is displayed to be scrolled (slid) in a left-right direction or an up-down direction.

In this case, by scrolling the screen in the leftward direction, it is possible to display a life event having a low score which is positioned in a more rightward direction. Further, by scrolling the screen in the upward direction, it is possible to display a life event that may occur at a previous time which is positioned in a more downward direction.

For scrolling of the screen of the score/time order display, a scroll bar (a slide bar) is displayed in an upper, lower, left, or right portion of the screen, and the screen can be scrolled in accordance with an operation of the scroll bar performed by the user.

Further, for example, it is possible to detect a slide operation (or a flick operation) on the screen performed by the user through a touch panel and slide (scroll) the screen of the score/time order display in accordance with the slide operation.

Further, in the score/time order display, as the display of the life event corresponding to the state of the prediction state sequence (the symbol indicating life event), an image such as an icon, a mark indicating a link with a text, a movie, or the like, or the like can be employed. In FIG. 18, for example, a rectangular icon is employed as the display of the life event.

Further, in the score/time order display, similarly to the example of FIG. 17, it is possible to display the score at which the left event will occur (the probability that it will reach the state corresponding to the life event) together with the life event.

The score/time order display described above is useful, for example, in a case where the network structure of the life event corresponding to the state of the prediction state sequence is displayed on a display screen (the user interface) having a limited size such as a mobile terminal such as a smartphone.

In FIG. 18, life events v1, v2, v3, and v4 are arranged in a row of a time zone (time) t1 in the described order in the rightward direction. Therefore, in the time zone t1, the life event v1, v2, v3, and v4 are likely to occur in the described order.

Further, In FIG. 18, life events v5, v6, v7, and v8 connected with the life event v2 by (an arrow indicating) the state transition are arranged in a row of a time zone t2 (>t1) in the rightward direction in the described order. Since the life events v5, v6, v7, and v8 are connected with the life event v2 by the state transition, the life events v5, v6, v7, and v8 may occur in the time zone t2 in a case where the life event v2 occurs in the time zone t1.

Further, the life events v5, v6, v7, and v8 in the time zone t2 are likely to occur in the described order.

Further, in FIG. 18, life events v9, v10, v11, and v12 are arranged in a row of a time zone t3 (>t2) in the rightward direction in the described order.

Further, the life events v10 to v12 among the life events v9 to v12 are connected with the life event v6 in the time zone t2 by the state transition.

Therefore, the life events v10 to v12 may occur in the time zone t3 later in a case where the life event v6 occurs in the time zone t2.

In FIG. 18, the life event v6 indicated by the largest rectangle is an event of interest to which attention is paid.

Further, in FIG. 18, rectangles indicating the other life events v5, v7, and v8 in the time zone t2 of the life event v6 which is an event of interest are larger than rectangles indicating the life events v1 to v4 and v9 to v12 in the other time zones t1 and t3.

Therefore, the user can easily recognize the event of interest (the life event v6 in FIG. 18). Further, the user can easily recognize other life events (the life event v5, v7, and v8 in FIG. 18) that may occur at a time (the time zone t2 in FIG. 18) in which the event of interest may occur. Further, for example, as the time gets farther from the event of interest, a size of a rectangular icon indicating the life event can decrease. Further, for example, a rectangular icon indicating a life event can have a size corresponding to the score of the life event.

The life event serving as the event of interest can be selected, for example, in accordance with an operation of the user. By default, for example, a life event corresponding to a current state may be selected as the event of interest.

Further, for example, a life event located at a central portion of the screen of the score/time order display may be selected as the event of interest. In this case, it is possible to change the life event to be selected as the event of interest by sliding the screen and changing the life event located at the central portion of the screen of score/time order display.

In addition, in the score/time order display, for example, the network structure of the life event may be displayed so that the life event selected as the event of interest is located at the central portion of the screen.

In the score/time order display, it is possible to display a condition that another life event will occur from an arbitrary life even among future life events (hereinafter also referred to as an “occurrence condition”) together with the future life event obtained from the prediction state sequence or the like.

Hereafter, the score/time order display of displaying the occurrence condition together with the future life event is also referred to as a “score/time order display with an occurrence condition.”

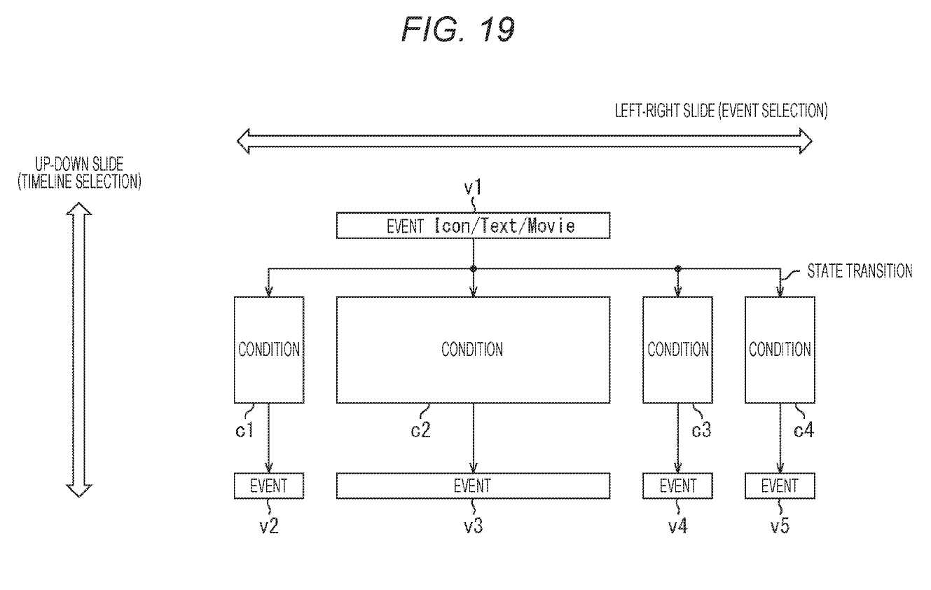

FIG. 19 is a diagram illustrating a display example of the score/time order display with the occurrence condition.

Referring to FIG. 19, life events v2, v3, v4, and v5 that may occur after a life event v1 are connected with the life event v1 by the state transition.

Further, the occurrence conditions c1, c2, c3, and c4 that the life events v2, v3, v4, and v5 occur are displayed in the middle of the state transition connecting the life event v1 with the life events v2, v3, v4, and v5.

According to the score/time order display with the occurrence condition described above, the user is able to easily recognize a condition which is satisfied (not satisfied) when the life events v2, v3, v4, and v5 occur after the life event v1 occurs.

Here, in the HMM, in order to accurately calculate the probability serving as the score for reaching (a life event corresponding to) a certain state, chronological data actually observed until it arrives at the state (an actual observation value) is necessary.

However, for the state corresponding to the future life event, the actual observation value is unable to be observed until the corresponding future comes.

Therefore, in a case where the score/time order display is performed, for example, the product of the transition probability of the state transition in the state sequence until it reaches the state corresponding to the future life event from the current state can be used as the probability serving as the score for reaching the state corresponding to the future life event (the score at which the future life event occurs).

Each of the occurrence conditions c1 to c4 displayed through the score/time order display with the occurrence condition is a condition of chronological data indicating chronological data which is observed when the life events v2 to v5 occur when (after) the life event v1 occurs.

Therefore, as the occurrence conditions c1 to c4, a value of a concrete discrete symbol to be taken by a discrete value serving as chronological data, a section in which a continuous value serving as chronological data is distributed, or the like may be employed.

In other words, for example, in a case where the observation value observed in the state is the continuous value, and the Gaussian distribution is employed as the observation model, the average value of the Gaussian distribution of the state corresponding to the life event v2 is indicated by av2, and the average value of the Gaussian distribution of the state corresponding to the life event v3 is indicated by av3. Further, a section of a predetermined width centered on the average value av2 is indicated by sec2, and a section of a predetermined width centered on the average value av3 is indicated by sec3.

In this case, a condition that chronological data of the section sec2 is observed as chronological data may be employed as the occurrence condition c1 that the life event v2 occurs, and a condition that chronological data of the section sec3 is observed as chronological data may be employed as the occurrence condition c2 that the life event v3 occurs. Further, here, in order to simplify the description, the sections sec2 and sec3 are assumed not to overlap.

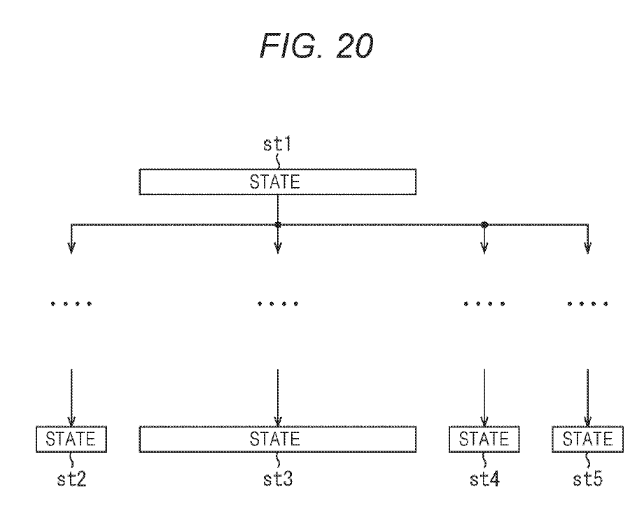

FIG. 20 is a diagram illustrating an example of a correspondence relation between the state constituting the prediction state sequence and the life event.

In other words, FIG. 20 illustrates an example of the prediction state sequence.

In the prediction state sequence of FIG. 20, state transitions from a state st1 to any one of states st2, st3, st4, and sty can be performed.

FIG. 19 illustrates a display example in a case where the score/time order display with the occurrence condition is performed on the prediction state sequence of FIG. 20.

The life events v1 to v5 of the score/time order display with the occurrence condition of FIG. 19 correspond to the states st1 to st5 of the prediction state sequence of FIG. 20, respectively.

In this case, for example, conditions that a predetermined value included in the observation value that can be observed in the states st2 to st5 are observed are the occurrence condition c1 to c4, respectively.

As the predetermined value included in the observation value that can be observed in the state, for example, in a case where the observation model is the Gaussian distribution, a value within a section of a predetermined width centered on the average value of the Gaussian distribution may be employed. Further, for example, in a case where the observation model is the polynomial distribution, a discrete symbol in which the observation probability is greater than 0 in the polynomial distribution may be employed as the predetermined value included in the observation value which can be observed in the state.

Here, for example, the life events v2, v3, v4, and v5 corresponding to the states st2, st3, st4, and sty are assumed to be attending colleges UA, UB, UC, and UD, respectively. Further, the observation values observed in the states st2 to st5 are assumed to be academy achievement deviation values of a trial test TR received before attending the colleges.

In this case, occurrence conditions C1, C2, C3, and C4 are assumed to be conditions related to the academy achievement deviation values of the trial test TR.

The learning of the (incremental) HMM is performed using the academy achievement deviation values of the trial test TR taken by the users attending the colleges UA, UB, UC, UD before attending.

In a case where the observation model of the state is, for example, the Gaussian distribution, through the learning of the HMM, in the state st2, the distribution of the academy achievement deviation value of the trial test TR taken by the user attending the college UA is modeled by the Gaussian distribution. Similarly, through the learning of the HMM, in the states st3, st4, and sty, the distribution of the academy achievement deviation values of the trial test TR taken by the users attending the colleges UB, UC, and UD are modeled by the Gaussian distribution.

For the state st2, for example, a condition that a range (section) of the academy achievement deviation value of the trial test TR which is high in a possibility (frequency) of acquisition in the trial test TR by the user enrolling in the college UA on the basis of the average value and the variance specifying the Gaussian distribution of the state st2 is acquired in the trial test TR can be decided as an occurrence condition c1 that the attendance to the college UA corresponding to the state st2 occurs. The occurrence conditions c2 to c4 can be decided similarly to the occurrence condition c1.

Further, in the score/time order display with the occurrence condition, the user can select the occurrence condition. In a case where a certain occurrence condition is selected, it is possible to re-calculate a score for reaching a state corresponding to a life event occurring when the occurrence condition selected by the user is satisfied by applying the observation value satisfying the occurrence condition to the subset HMM as the input chronological data after a certain life event, and it is possible to re-calculate a score for reaching a state corresponding to a life event which may occur thereafter as well.

Further, for other life events that may occur after a certain life event, it is possible to re-calculate scores for reaching states corresponding to the life events.

In the score/time order display with the occurrence condition, it is possible to change an arrangement of life events in accordance with the recalculated score after re-calculating the score. Further, in the score/time order display with the occurrence condition, in a case where the score at which the life event occurs is displayed together with the life event, it is possible to change the display of the score to the recalculated score.

Therefore, the user can interactively check the future life event. In other words, in the score/time order display with the occurrence condition, the user can check how (the score of) the future life event changes by selecting the occurrence condition.

### <One Embodiment of Life Event Service System>

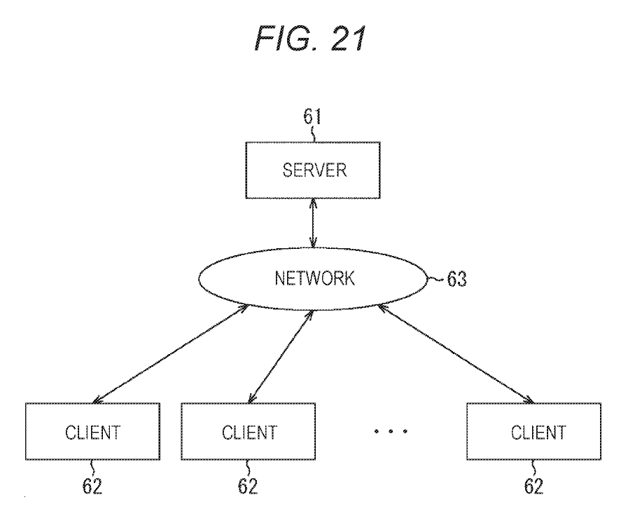

FIG. 21 is a block diagram illustrating a configuration example of one embodiment of a life event service system to which the present technology is applied.

Referring to FIG. 21, the life event service system is a server client system in which one server 61 and one or more clients 62 are connected via a network 63.

The life event service system of FIG. 21 can predict the future life event by appropriately using the above-described technology and cause the prediction result for the future life event to be displayed for the user in an easy-to-understand manner through the score/time order display described with reference to FIGS. 18 and 19 or the like.

Further, in the life event service system of FIG. 21, a role of one server 61 can be distributed to a plurality of servers.

In FIG. 21, the server 61 stores, for example, a main body HMM serving as a network model in which learning is performed using chronological data related to a life event or the like.

The client 62 provides chronological data related to a life event of the user or the like of the client 62 to the server 61 via the network 63 such as the Internet as necessary.

Further, the client 62 predicts the future life event using (the subset HMM clipped from) the main body HMM stored in the server 61, and presents the future life event which is the prediction result to the user.

In other words, for example, the client 62 performs the score/time order display of the future life event or the like.

Here, hereinafter, the score/time order display is assumed to include the score/time order display of FIG. 18 and the score/time order display with the occurrence condition of FIG. 19 unless otherwise specified.

Further, as the client 62, in addition to a client that performs both a chronological data provision process of providing chronological data related to a life event to the server 61 and a life event presentation process of presenting a future life event to the user as described above, there may be a client that performs only one of the chronological data provision process and the life event presentation process.

The life event service system configured with the server 61 and the client 62 collects chronological data of a limited section for the life event, predicts (a life event of) a far future using the chronological data, and presents the predicted far future to the user.

The presentation of the prediction of the far future is performed so that an overall image can be easily understood in accordance with an operation of the user or the like.

Since the prediction of the far future is presented, the user can decide current guidelines or a future goal with reference to the prediction.

Examples of a target of the prediction of the far future include a person, an assembly (group) of persons, and things (constructions (houses or buildings), vehicles, pets, plants).

As a life event which is the target of the prediction of the far future, for example, there is a life stage which the target can take. As the life stage of the target, there are various life stages from the beginning (appearance) to the end (disappearance) of the target.

For example, as a life stage related to a background of a person, there is birth-student-society-retirement-death or the like. Further, for example, as a life stage related to a person's health, there is health-morbidity-recovery-death or the like. Further, for example, as a life stage related to a background of an organization, there is establishment-expansion-division-dissolution or the like. Further, for example, as a life stage of an object, there is purchase-use-resale-disposal or the like. Further, for example, as a life stage of a plant or a pet, there is birth-growth-old-death.

### <Configuration Examples of Server 61 and Client 62>

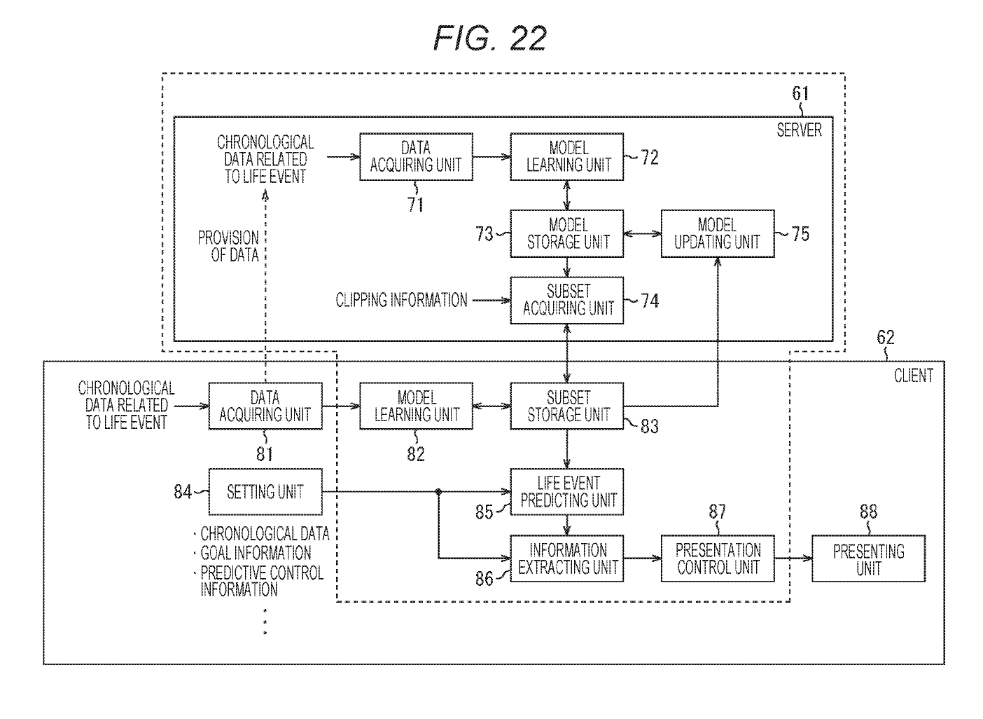

FIG. 22 is a block diagram illustrating functional configurations of the server 61 and the client 62 of FIG. 21.

Referring to FIG. 22, the server 61 includes a data acquiring unit 71, a model learning unit 72, a model storage unit 73, a subset acquiring unit 74, and a model updating unit 75. The client 62 includes a data acquiring unit 81, a model learning unit 82, a subset storage unit 83, a setting unit 84, a life event predicting unit 85, an information extracting unit 86, a presentation control unit 87, and a presenting unit 88.

Further, in FIG. 22, one or more of the model learning unit 82, the subset storage unit 83, the life event predicting unit 85, the information extracting unit 86, and the presentation control unit 87 constituting the client 62 may be installed in the server 61 instead of the client 62.

The data acquiring unit 71 acquires the chronological data related to the life event and supplies the acquired chronological data to the model learning unit 72. The data acquiring unit 71 is able to acquire the chronological data related to the life event from, for example, the data acquiring unit 81 to be described later of the client 62. In addition, for example, the data acquiring unit 71 is able to acquire the chronological data related to the life event, for example, from a database (not illustrated), a wearable device worn by the user, sensors for sensing various physical quantities, or the like.

Here, the chronological data related to the life event is chronological data of the life event or an element deciding the life event (an element having influence on the life event).

As the element deciding the life event, for example, there are a behavior, a judgment, an evaluation history, relevant external information, and the like of a person. Further, for a certain life event, another life event may be an element deciding the certain life event.

A specific example of the chronological data related to the life event differs depending on an application of predicting a life event.

For example, as a life event of a person, there is getting a job. Until a life event such as getting a job occurs, for example, life events such as enrollment in an elementary school, enrollment in a middle school, enrollment in a high school, and enrollment in a college occur.

The background such as enrollment in an elementary school, enrollment in a middle school, enrollment in a high school, admission to a college, and getting a job corresponds to the chronological data related to the life event.

Further, as an element deciding enrollment in a school such as a college, there are academic achievements, achievements related to special skills (for example, a tournament winner, a prize winner, or the like), and these elements also correspond to the chronological data related to the life event.

Further, as elements deciding admission to a school such as a college, there are time allocation of daily behaviors, for example, a time spent on study per unit period, a time spent on learning of sports, or the like, and these elements also corresponds to the chronological data related to the life event. Further, an arbitrary period may be employed as a unit period mentioned here and may be, for example, one day, one month, or one year.

Further, for example, as the life event of the person, there are morbidity of various diseases and death. Until the life event such as morbidity of diseases or death occurs, various life events occur, and a sequence of these life events corresponds to the chronological data related to the life event.

Further, as an element deciding the morbidity of diseases or death, there are a daily life style, for example, a meal, sleeping, a way of working, how to spend a spare time, preference, and the like, and these elements also correspond to the chronological data related to the life event.

For example, the chronological data related to the life event may be a single stream including a stream of only one modal such as a chronology of morbidity of diseases or may be a multi-stream including streams (modal data) of a plurality of modals such as a chronology of morbidity of diseases and a chronology of a career background before getting a job.

The data acquiring unit 71 acquires the chronological data related to the life event and supplies the chronological data related to the life event to the model learning unit 72.

Here, hereinafter, the chronological data related to the life event is also referred to as “chronological event data.”

The model learning unit 72 performs, for example, learning of the incremental HMM serving as the network model stored in the model storage unit 73 using the chronological event data supplied from the data acquiring unit 71.

The model storage unit 73 stores, for example, (the parameter of) the incremental HMM serving as the network model.

Here, the incremental HMM stored in the model storage unit 73 is, for example, the entire HMM processed by the subset scheme described with reference to FIG. 8 and the like.

The subset acquiring unit 74 acquires the subset HMM by clipping the subset HMM from the entire HMM stored in the model storage unit 73, and supplies (transmits) the subset HMM to the subset storage unit 83 of the client 62.

Here, clipping information is supplied to the subset acquiring unit 74. The clipping information is information used for clipping the subset HMM.

For example, information of a population to which a prediction target whose life event is predicted using the subset HMM clipped from the entire HMM (a person, an assembly of persons, a thing formed by an assembly of persons, or an object) belongs, chronological data related to the life event of the prediction target, or the like is employed as the clipping information.

Specifically, for example, in a case where the life event prediction target is the user of the client 62, the information of the population to which the user of the client 62 belongs and the chronological data related to the life event of the user are employed as the clipping information.

As the information of the population to which the user of the client 62 belongs, there is information of various categories to which the user belongs such as a sex or an age group of the user. The subset acquiring unit 74 clips a state obtained by learning the chronological event data of the user coinciding with the sex or the age group of the user of the client 62 (a state obtained by bundling the chronological event data of the user) using the population information from the entire HMM stored in the model storage unit 73 as the subset HMM.

Further, the subset acquiring unit 74 is able to clip the subset HMM through the non-zero state prediction described with reference to FIG. 10 using the chronological data related to the life event of the user of the client 62 as the clipping chronological data described with reference to FIG. 10.

The model updating unit 75 acquires the subset HMM supplied (transmitted) from the subset storage unit 83 to be described later and updates the entire HMM by merging the subset HMM into the entire HMM stored in the model storage unit 73 as described with reference to FIG. 8.

The data acquiring unit 81 acquires the chronological data related to the life event of the user of the client 62 and supplies the acquired chronological data to the model learning unit 82 as the learning chronological data. The data acquiring unit 81 is able to acquire the chronological data related to the life event of the user of the client 62, for example, from an input from the user, a wearable device worn by the user, sensors of sensing various physical quantities, or the like. In addition, it is possible to acquire, for example, a chart of the user registered in a database of a hospital which the user goes to, a grade report of the user registered in a database of a school which the user attends, and the like as the chronological data related to the life event of the user of the client 62.

Further, the data acquiring unit 81 is able to supply (transmit) the chronological data related to the life event of the user of the client 62 to the data acquiring unit 71 of the server 61 as necessary.

The model learning unit 82 updates (learns) the subset HMM stored in the subset storage unit 83 using the learning chronological data supplied from the data acquiring unit 81.

The subset storage unit 83 stores the subset HMM supplied from the subset acquiring unit 74. Further, the subset storage unit 83 supplies (transmits) the subset HMM updated by the model learning unit 82 to the model updating unit 75 of the server 61 as necessary.

The setting unit 84 sets various kinds of information in accordance with an operation of the user of the client 62 or the like.

In other words, for example, the setting unit 84 sets the chronological data related to the life event of the user inputted by the operation of the user as the input chronological data used for the prediction of the life event, and supplies the set chronological data to the life event predicting unit 85. Further, the user is able to input chronological data obtained by changing part of the chronological data, chronological data including a virtual future life event, and the like in addition to chronological data related to a life event which has occurred actually.

Further, for example, the setting unit 84 sets goal information indicating a goal of the life event in accordance with the operation of the user, and supplies the goal information to the life event predicting unit 85 and the information extracting unit 86.

Further, for example, the setting unit 84 sets predictive control information in accordance with the operation of the user, and supplies the predictive control information to the life event predicting unit 85.

The predictive control information is information for controlling the prediction of the chronological event data in the life event predicting unit 85 (the chronological data related to the life event) and includes, for example, the length (depth) of the state sequence obtained by the tree search using the subset HMM, and an upper limit value of the number thereof.

Similarly to the state estimating unit 52 and the predictive chronological generating unit 53 of FIG. 14, the life event predicting unit 85 generates predictive chronological data of a future farther than the input chronological data (predictive chronological data of a future later than the input chronological data) for the input chronological data supplied from the setting unit 84 using the subset HMM stored in the subset storage unit 83, and supplies the generated predictive chronological data to the information extracting unit 86.

In other words, the life event predicting unit 85 calculates the state probability of stay in each state of the subset HMM stored in the subset storage unit 83 using the input chronological data supplied from the setting unit 84.

Further, the life event predicting unit 85 estimates the current state (a state corresponding to the last sample value of the input chronological data) on the basis of the state probability.

Thereafter, the life event predicting unit 85 performs the tree search of generating the state sequence serving as the prediction state sequence while sequentially tracing the state transition starting from the current state of the subset HMM stored in the subset storage unit 83.

The length of the prediction state sequence generated by the tree search and the number thereof are decided in accordance with the predictive control information supplied from the setting unit 84 to the life event predicting unit 85.

Further, in a case where the goal information is supplied from the setting unit 84 to the life event predicting unit 85, the tree search is performed until the state corresponding to the goal information is reached. Accordingly, the life event predicting unit 85 generates the state sequence until it reaches from the current state to a state corresponding to a goal state as the prediction state sequence.

For each of one or more prediction state sequences obtained as a result of tree search, the life event predicting unit 85 generates chronological data having a representative value of the observation value observed in each state constituting the prediction state sequence (for example, the average value of the Gaussian distribution) as the sample value as the predictive chronological data.

Then, the life event predicting unit 85 supplies the predictive chronological data to the information extracting unit 86 together with the prediction state sequence, the score for reaching the state of the prediction state sequence, and the like.

The information extracting unit 86 extracts information necessary for presenting the future life event to the user as presentation information from the predictive chronological data or the prediction state sequence supplied from the life event predicting unit 85 and supplies the presentation information to the presentation control unit 87.

For example, in a case where there are a plurality of prediction state sequences reaching the state corresponding to the goal information supplied from the setting unit 84 as the prediction state sequence supplied from the life event predicting unit 85, the information extracting unit 86 obtains an addition value obtained by adding the scores for reaching the state corresponding to the goal information for the plurality of prediction state sequences as a value indicating goal reachability.

Further, for example, the information extracting unit 86 selects a prediction state sequence having the highest score from among a plurality of prediction state sequences reaching the state corresponding to the goal information as the most likely prediction state sequence.

Further, for example, the information extracting unit 86 selects a prediction state sequence satisfying a predetermined condition (for example, a prediction state sequence including a state corresponding to a predetermined characteristic life event or the like) among a plurality of prediction state sequences reaching the state corresponding to the goal information as a characteristic prediction state sequence.

Further, for example, the information extracting unit 86 generates a condition that state transition to a state of a branch destination state occurs for branching of the prediction state sequence supplied from the life event predicting unit 85, that is, the occurrence condition described with reference to FIG. 19 with reference to the subset storage unit 83.

Further, for example, the information extracting unit 86 recognizes a life event corresponding to a state in which the prediction state sequence is necessary from the predictive chronological data supplied from the life event predicting unit 85, and generates a symbol indicating the life event (for example, an icon or the like).

Further, for example, in a case where it is possible to predict a time necessary until the state corresponding to the goal information is reached for the prediction state sequence reaching the state corresponding to the goal information, the information extracting unit 86 predicts the necessary time.

The information extracting unit 86 extracts a value indicating the goal reachability described above, symbols indicating life events corresponding to the states of the most likely prediction state sequence, the characteristic prediction state sequence, and the prediction state sequence, a time necessary until the state corresponding to the goal information is reached, and the like as the presentation information as necessary, and supplies the extracted information to the presentation control unit 87.

The presentation control unit 87 controls the presenting unit 88 in accordance with the presentation information supplied from the information extracting unit 86 so that the future life event or the like is presented to the user of the client 62.

The presenting unit 88 presents the future life event or the like in accordance with the control of the presentation control unit 87.

The presentation of the life event in the presenting unit 88 may be performed through an image (including text) or a sound. Further, the presentation of the life event may be performed, for example, as an operation of a predetermined function of a device (not illustrated) installed in the client 62 or an external device different from the client 62.

Hereinafter, a display device that displays images is assumed to be employed as the presenting unit 88, and the display illustrated in FIG. 17 or the score/time order display described with reference to FIGS. 18 and 19 is assumed to be performed as the presentation of the life event in presenting unit 88.

### <Display Example of Presenting Unit 88>

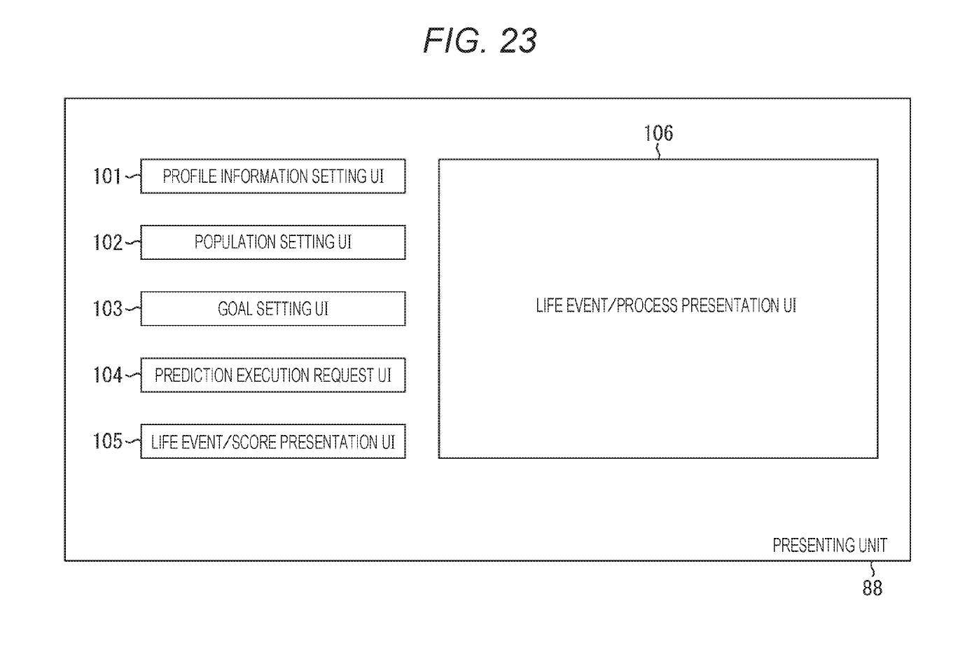

FIG. 23 is a diagram illustrating a display example of a user interface displayed on the presenting unit 88.

Referring to FIG. 23, the user interface displayed on the presenting unit 88 includes a profile information setting UI (user interface) 101, a population setting UI 102, a target setting UI 103, a prediction execution request UI 104, a life event/score presentation UI 105, a life event/process presentation UI 106.

Further, the presenting unit 88 may be configured with a touch panel. The profile information setting UI 101 to the life event/process presentation UI 106 may be operated by a touch performed by the user or a pointing device such as a mouse by the user.

The profile information setting UI 101 is operated by the user when the profile of the prediction target (a person, an assembly of persons, a thing formed by an assembly of persons, or an object) whose life event is predicted.

For example, in a case where the prediction target is the user of the client 62 whose is a person or the like, it is possible to set individual information such as the sex of the user, a date of birth, a hometown, an address, an associated group, a hobby, or a preference as the profile of the prediction target.

Further, for example, in a case where the prediction target is a group (assembly) of persons, for example, information such as an establishment date, a purpose, and constituent members of group, or the like may be set as the profile of the prediction target.

Further, for example, in a case where the prediction target is an object, it is possible to seta creation (production) date, a creation method, or the like of the object as the profile of the prediction target.

Here, after the profile of the prediction target is set, the profile information setting UI 101 need not be constantly displayed on the presenting unit 88. In other words, after the profile of the prediction target is set, the profile information setting UI 101 may be set not to be displayed on the presenting unit 88. However, in the case where the presenting unit 88 is set not to perform the display, the user causes the profile information setting UI 101 to be displayed on the presenting unit 88 in accordance with a predetermined event such as a predetermined operation performed by the user in preparation for a case where it is desired to update the profile of prediction target, a case where it is desired to modify (change) the profile of the prediction target, or the like.

Further, a part or all of the profile of the prediction target set through the profile information setting unit UI 101 can be displayed through the life event/process presentation UI 106 as necessary.

The population setting UI 102 is operated by the user when the information of the population applied to the subset acquiring unit 74 of the server 61 as the clipping information is set (FIG. 22).

Further, for the information of the population applied to the subset acquiring unit 74 of the server 61 (FIG. 22) as the clipping information, the server 61 can set default information.

In other words, in the server 61, it is possible to set the default information serving as the information of the population for the user from information such as a category (an age group, a sex, or the like) in which the profile set by the user operating the profile information setting UI 101 is necessary.

The population setting UI 102 is operated when the user desires to set the information of the population which is not default information.

The information of the population includes information delimited by a time such as a life stage and statically delimited information other than such information.

For example, in a case where the prediction target is a person, the information of the population includes an age group of a person, an associated state (an occupation, an educational background, or the like), a preference (spicy, like), a hobby (sports or music), or the like. For example, the age group and the associated state correspond to the information delimited by a time, and the preference and the hobby correspond to the information of the population which is delimited statically.

Further, although a termination naturally appears in the chronology of the information of the population delimited by a time, but the termination may not appear in the chronology of the information of the population which is delimited statically. Further, in the subset acquiring unit 74 of the server 61 (FIG. 22), in a case where the process of clipping the subset HMM is performed using the information of the population as the clipping information, when the information of the population serving as the clipping information is the information of the population which is delimited by a time, the subset HMM clipping process may differ from that when the information of the population serving as the clipping information is the information of the population which is delimited statically.

The goal setting UI 103 is operated by the user when the goal information is set. In a default state, the goal information is not set.

In a case where the goal information is not set, the life event predicting unit 85 of the client 62 (FIG. 22) performs the tree search for the prediction state sequence without restricting the final state of the prediction state sequence to a specific state.

On the other hand, in a case where the goal state is set, the life event predicting unit 85 of the client 62 (FIG. 22) restricts the last state of the prediction state sequence to the state corresponding to the goal information, and performs the tree search for the prediction state sequence.

The prediction execution request UI 104 is operated by the user when an instruction to predict a future life event is given.

The life event/score presentation UI 105 is operated by the user when a score display is turned on or off in the score/time order display (FIGS. 18 and 19) or the like, for example. Further, the life event/score presentation UI 105 is operated by the user, for example, when a score recalculation is requested.

In the life event/process presentation UI 106, the prediction result for the prediction of the future life event is displayed in the form of the score/time order display (FIGS. 18 and 19) or the display illustrated in FIG. 17.

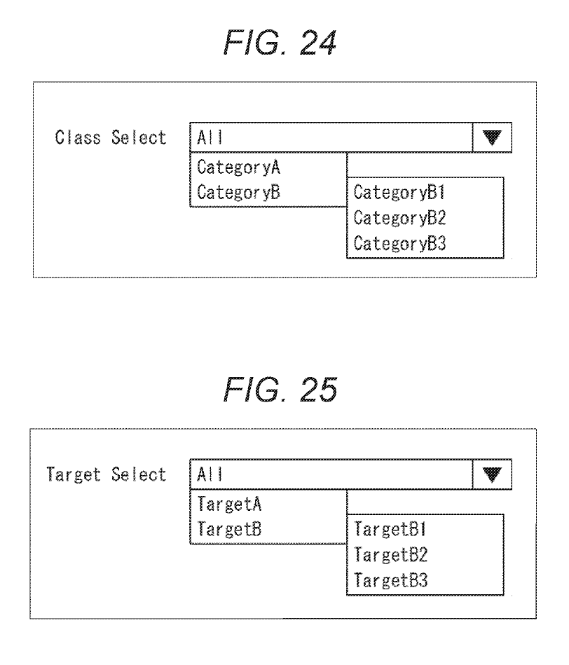

FIG. 24 is a diagram illustrating a detailed example of the population setting UI 102 of FIG. 23.

The population setting UI 102 may be configured with a pull-down menu as illustrated in FIG. 24. In the pull-down menu serving as the population setting UI 102, it is possible to display choices of a category serving as the population.

In this case, when the user selects a choice from the pull-down menu serving as the population setting UI 102, the choice is set as the information of the population.

Further, as the population setting UI 102, instead of the UI that allows the user to select the information of the population from the choices of the pull-down menu, a UI that allows the user to input arbitrary information (category) may be employed.

FIG. 25 is a diagram illustrating a detailed example of the goal setting UI 103 of FIG. 23.

As illustrated in FIG. 25, the goal setting UI 103 may be configured with a pull-down menu. In the pull-down menu serving as the goal setting UI 103, a choice of a life event which is a goal may be displayed.

In this case, when the user selects the choice from the pull-down menu serving as the goal setting UI 103, the choice is set as the goal information.

Further, as the goal setting UI 103, instead of the UI that allows the user to select the select the goal information from the choices of the pull-down menu, a UI that allows the user to input arbitrary information (life event) may be employed.

### <Learning of Network Model>

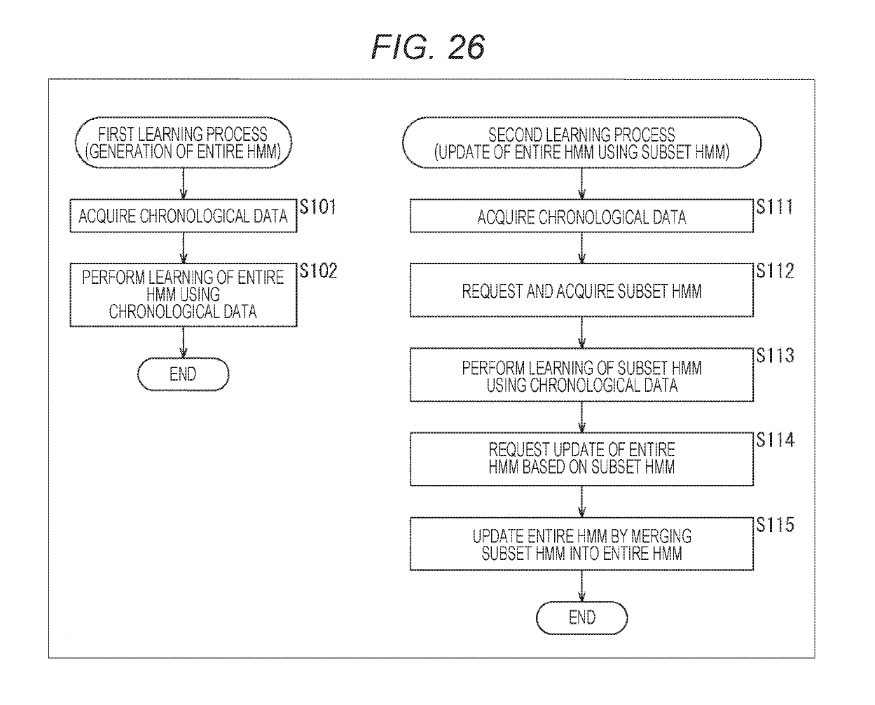

FIG. 26 is a flowchart for describing an example of a network model learning process performed by the life event service system of FIG. 21.

Here, as the network model learning process performed by the life event service system of FIG. 21, there are a first learning process of performing the learning of the entire HMM stored in the model storage unit 73 (FIG. 22) without using the subset HMM and a second learning process of updating the entire HMM by merging the subset HMM.

The first learning process may be started, for example, in accordance with an operation of an operator of the server 61.

In the first learning process, in step S101, the data acquiring unit 71 of the server 61 (FIG. 22) acquires the chronological data related to the life event and supplies the chronological data related to the life event to the model learning unit 72, and the process proceeds to step S102.

In step S102, the model learning unit 72 performs the learning of the entire HMM stored in the model storage unit 73 using the chronological data supplied from the data acquiring unit 71, and the first learning process ends.

The second learning process may be started at a predetermined timing or may be started in accordance with an operation of the user.

In the second learning process, in step S111, the data acquiring unit 81 of the client 62 (FIG. 22) acquires, for example, the chronological data related to the life event of the user of the client 62 as the learning chronological data. Then, the data acquiring unit 81 supplies the learning chronological data to the model learning unit 82, and the process proceeds from step S111 to step S112.

In step S112, the client 62 transmits a request to the server 61 and acquires the subset HMM.

In other words, for example, the client 62 transmits the learning chronological data acquired by the data acquiring unit 81 in step S111 to the server 61 as the clipping information and requests the server 61 to transmit the subset HMM.

For example, the subset acquiring unit 74 of the server 61 (FIG. 22) clips the subset HMM on the basis of the non-zero state prediction described with reference to FIG. 10 using the learning chronological data serving as the clipping information supplied from the client 62 as the clipping chronological data described with reference to FIG. 10, and transmits the subset HMM to the client 62.

In the client 62, the subset storage unit 83 receives the subset HMM from the subset acquiring unit 74 of the server 61 and stores the subset HMM.

Further, here, the client 62 transmits the learning chronological data to the server 61 as the clipping information, but a predetermined range within the observation space of the chronological data used for the learning of the entire HMM stored in the model storage unit 73 or range information indicating a predetermined range within the state space of the entire HMM stored in the model storage unit 73 may be employed as the clipping information as well.

In a case where the range information is employed as the clipping information, the subset HMM constituted by the state in which the observation value in the range of the observation space designated by the range information is likely to be observed and the state in the range of the state space designated by the range information is clipped.

Further, the subset acquiring unit 74 is able to further clip the subset HMM including the state transitionable from the state obtained from the clipping information in addition to the state obtained from the clipping information as described with reference to FIG. 12.

If the subset storage unit 83 stores the subset HMM, the process proceeds from step S112 to step S113, and the model learning unit 82 performs the updating (learning) of the subset HMM stored in the subset storage unit 83 using the learning chronological data supplied from the data acquiring unit 81.

The updating of the subset HMM is performed as described with reference to FIG. 7.

In other words, in the updating of the subset HMM, the likelihood p(xₜ|X, θ) of Formula (20) is obtained for the learning chronological data X. Further, the threshold value processing of the likelihood p(xₜ|X, θ) is performed, and the known unknown determination is performed on the section of the learning chronological data.

For the known section of the learning chronological data obtained as a result of the known unknown determination, the maximum likelihood state sequence is obtained, for example, in accordance with the Viterbi algorithm, and the state constituting the maximum likelihood state sequence is detected as the state suitable for the known section.

The parameter of the state suitable for the known section (the initial probability π, the transition probability a, and the observation model ϕ) are updated in accordance with Formulas (25) to (29) using the sample value of the known section of the learning chronological data.

Further, the variables Nᵢ^{(π)}, Nᵢⱼ^{(a)}, and Nᵢ^{(ϕ)} of Formulas (30) to (32) serving as the information of the frequency are also updated and held.

For the unknown section of the learning chronological data obtained as a result of the known unknown determination, another HMM different from the subset HMM is prepared, and the learning of another HMM is performed in accordance with the Baum-Welch algorithm using the sample value of the unknown section of the learning chronological data.

Then, for another HMM after the learning, for example, the state constituting the maximum likelihood state sequence for the unknown section is selected as the new state to be added to the subset HMM and added to the subset HMM. The parameter of the new state added to the subset HMM (the initial probability π, the transition probability a, and the observation model ϕ) is updated in accordance with Formulas (25) to (29) using the sample value of the unknown section of the learning chronological data.

Further, the updating of the subset HMM can be performed using the entire learning chronological data after the new state is added to the subset HMM.

For the new state added to the subset HMM, the variables variable Nᵢ^{(π)}, Nᵢⱼ^{(a)} and Nᵢ^{(ϕ)} of Formulas (30) to (32) serving as the information of the frequency are held for subsequent updating of the subset HMM.

Further, for the new state, the variable Nᵢ^{(π)} is equal to the posterior probability γ₀ (i) obtained from the learning chronological data, the variable Nᵢⱼ^{(a)} is equal to the sum Σξₜ(i, j) of the posterior probability τₜ(i, j) obtained from the learning chronological data for t=1, 2, . . . , T−1, and the variable Nᵢ^{(ϕ)} is equal to the sum Σγₜ (i) of the posterior probability γₜ (i) obtained from the learning chronological data for t=1, 2, . . . , T.

In a case where the updating of the subset HMM ends, the process proceeds from step S113 to step S114, and the subset storage unit 83 transmits (the parameter of) the subset HMM updated in step S113 to the model updating unit 75 of the server 61 together with the information of the frequency.

Further, in step S114, the subset storage unit 83 requests the model updating unit 75 to update the entire HMM, and the process proceeds to step S115.

In step S115, the model updating unit 75 updates the entire HMM as described with reference to FIG. 8 by merging the subset HMM supplied from the subset storage unit 83 into the entire HMM stored in the model storage unit 73 using the information of the frequency supplied from the subset storage unit 83 in accordance with the request for updating the entire HMM, and the second learning process ends. Thereafter, the server 61 and the client 62 enter the state in which other processes can be performed.

In the second learning process, instead of the chronological data related to the life event of the user of the client 62 serving as the learning chronological data, statistical information of the learning chronological data in which the learning chronological data is anonymized, that is, the subset HMM or the information of the frequency is transmitted from the client 62 to the server 61, and the entire HMM is updated using the subset HMM or the information of the frequency.

Therefore, since the chronological data related to the life event of the user is not transmitted from the client 62 to the server 61, the leak of the chronological data related to the life event of the user, that is, individual information of the user is prevented, and thus the privacy can be protected.

### <Prediction of Life Event>

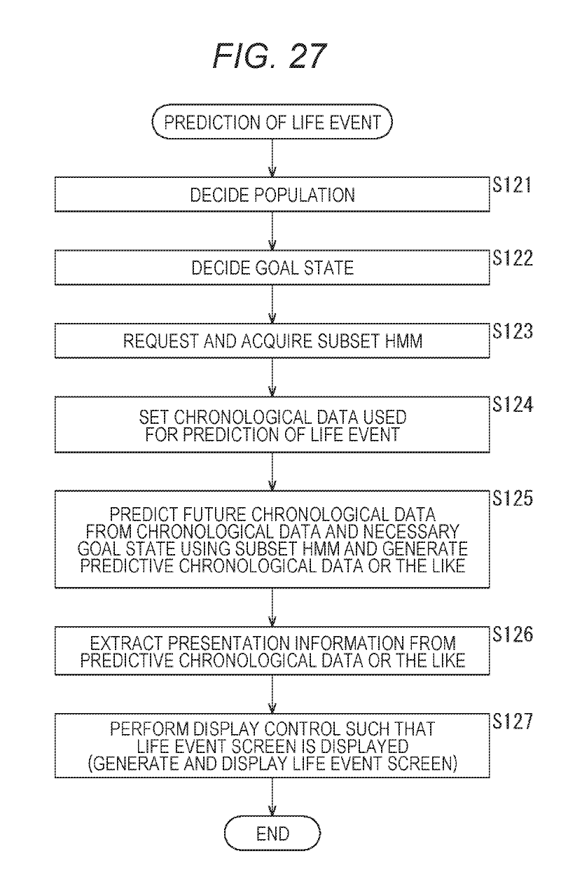

FIG. 27 is a flowchart illustrating an example of the life event prediction process performed by the life event service system of FIG. 21.

For example, in a case where the prediction execution request UI 104 (FIG. 23) is operated, the server 61 and the client 62 of the life event service system (FIG. 21) start the life event prediction process.

Further, the life event prediction process may be started, for example, in a case where an icon linked to a predetermined application is operated, in a case where a predetermined command is input from the user, or the like.

Further, the life event prediction process may be started in a case where a predetermined event occurs. As the predetermined event, for example, the occurrence of a predetermined change in the chronological data acquired by the data acquiring unit 81 or a profile set by operating the profile information setting UI 101.

In the life event prediction process, in step S121, the subset acquiring unit 74 of the server 61 (FIG. 22) decides the population indicating the range of the state to be clipped as the state constituting the subset HMM from the entire HMM, and the process proceeds to step S122.

In other words, in the client 62, in a case where the population setting UI 102 (FIG. 23) is not operated, and the information of the population is not set, the subset acquiring unit 74 decides the population in accordance with the default information of the population.

Further, in the client 62, in a case where the population setting UI 102 is operated, and the information of the population is set, the subset acquiring unit 74 decides the population in accordance with the information of the population which is set in accordance with the operation of the population setting UI 102.

In step S122, the life event predicting unit 85 and the information extracting unit 86 decide the state corresponding to the goal state as the goal state according to the goal information supplied from the setting unit 84, and the process proceeds to step S123. Further, in a case where the goal information is not set in the setting unit 84, the goal state is not decided in step S122.

In step S123, the subset storage unit 83 supplies a subset HMM request to the subset acquiring unit 74. The subset acquiring unit 74 acquires the subset HMM in response to the subset HMM request supplied from the subset storage unit 83 and supplies the subset HMM to the subset storage unit 83. The subset storage unit 83 acquires and stores the subset HMM from the subset acquiring unit 74, and the process proceeds from step S123 to step S124.

Here, the subset acquiring unit 74 clips the state belonging to the population decided in the step S121 among the states of the incremental HMM serving as the entire HMM stored in the model storage unit 73 as the state serving as the state of the subset HMM or clips the state serving as the state of the subset HMM among the state belonging to the population, and generates the subset HMM constituted by the state.

The clipping of the state serving as the subset HMM from the state belonging to the population among the states of the entire HMM may be performed, for example, through the non-zero state prediction in which the chronological data related to the life event of the user of the client 62 is used as the clipping chronological data as described with reference to FIG. 10.

Further, in the server 61, the subset HMM is prepared for each user in advance, and when the subset HMM request is transmitted from the client 62 to the server 61, the subset HMM for the user of the client 62 which has transmitted the request may be transmitted from server 61 to client 62.

The subset HMM of each user, for example, may be generated at a predetermined timing within one day. Further, for example, a timing at which the subset HMM request is transmitted from the client 62 of the user may be predicted, and the generation of the subset HMM for each user may be performed immediately before the timing comes. The prediction of the timing at which the subset HMM request is transmitted from the client 62 of the user may be performed, for example, on the basis of a history of the subset HMM request performed in the past. For example, for the timing of the subset HMM request, a histogram may be generated for each day of week or each time zone in which there is the request, and the subset HMM may be generated, for example, immediately before the day of week or the time zone in which the frequency of the request exceeds a threshold value.

In step S124, the setting unit 84 sets the input chronological data used for predicting the life event, supplies the input chronological data to the life event predicting unit 85, and the process proceeds to step S125.

For example, the setting unit 84 may set the chronological data related to the life event of the user input by the operation of the user as the input chronological data used for predicting the life event.

Further, for example, the setting unit 84 may set one piece of chronological data selected from the chronological data related to the life event of the user of the client 62 acquired by the data acquiring unit 81 as the input chronological data. The selection of one piece of chronological data to be set as the input chronological data may be performed, for example, in accordance with the operation of the user.

In step S125, the life event predicting unit 85 generates predictive chronological data of a future farther than the input chronological data for the input chronological data supplied from the setting unit 84 using the subset HMM stored in the subset storage unit 83.

In other words, the life event predicting unit 85 estimates the current state (the state corresponding to the last sample of the input chronological data) from the states of the subset HMM stored in the subset storage unit 83 using the input chronological data supplied from the setting unit 84.

Further, the life event predicting unit 85 searches for the state by tracing the state transition in the descending order of the transition probabilities starting from the current state of the subset HMM stored in the subset storage unit 83, and performs the tree search of generating the state sequence serving as the prediction state sequence through, for example, a depth-first search.

The length of the prediction state sequence generated by the tree search or the number thereof is decided in accordance with the predictive control information supplied from the setting unit 84 to the life event predicting unit 85.

Further, for one prediction state sequence, even in a case where the length (depth) decided in accordance with the predictive control information is not reached, the search for the state ends in a case where any one state in a state group in which a loop is constituted by the state transition is reached.

Further, in a case where the goal state is decided in step S122, the tree search is performed until the goal state is reached. Accordingly, the life event predicting unit 85 generates the state sequence until the goal state corresponding to the goal state is reached from the current state as the prediction state sequence.

The life event predicting unit 85 generates chronological data having a representative value of the observation value observed in each state constituting the prediction state sequence (for example, the average value of the Gaussian distribution) as sample value as the predictive chronological data for each of one or more prediction state sequences obtained as a result of the tree search.

Then, the life event predicting unit 85 supplies the predictive chronological data to the information extracting unit 86 together with the prediction state sequence or the score for reaching the state of the prediction state sequence, and the process proceeds from step S125 to step S126.

In step S126, the information extracting unit 86 extracts information necessary for presenting the future life event to the user as the presentation information from the predictive chronological data, the prediction state sequence, or the like supplied from the life event predicting unit 85, and supplies the extracted information to the presentation control unit 87, and the process proceeds to step S127.

For example, in a case where there are a plurality of prediction state sequences reaching the goal state as the prediction state sequence supplied from the life event predicting unit 85, the information extracting unit 86 obtains an addition value obtained by adding the scores for reaching the goal state for the plurality of prediction state sequences as a value indicating goal reachability.

Further, for example, the information extracting unit 86 selects the prediction state sequence having the highest score from among a plurality of prediction state sequences reaching the goal state as the most likely prediction state sequence.

Further, for example, the information extracting unit 86 generates a condition that state transition to a state of a branch destination state occurs for branching of the prediction state sequence supplied from the life event predicting unit 85, that is, the occurrence condition described with reference to FIG. 19 with reference to the subset storage unit 83.

Further, for example, the information extracting unit 86 recognizes a life event corresponding to a state in which the prediction state sequence is necessary from the predictive chronological data supplied from the life event predicting unit 85, and generates a symbol indicating the life event (for example, an icon or the like).

The information extracting unit 86 extracts a value indicating the goal reachability described above, symbols indicating life events corresponding to the states of the most likely prediction state sequence and the prediction state sequence, and the like as the presentation information, and supplies the extracted information to the presentation control unit 87 as necessary.

In step S127, for example, the presentation control unit 87 generates a screen for performing the display of FIG. 17 or the score/time order display of FIGS. 18 and 19 (hereinafter also referred to as a “life event screen”) in accordance with the presentation information supplied from the information extracting unit 86, and causes the generated screen to be displayed on the presenting unit 88, and the life event prediction process ends.

Further, the generation of the predictive chronological data and the prediction state sequence in step S125, the extraction of the presentation information from the predictive chronological data or the like in step S126 and step S127, the generation of the life event screen from the presentation information, and the display of the life event screen may be performed only once or may be performed repeatedly.

For example, in a case where a life event screen in which the overall image of the future life event can be understood or a life event screen on which a value indicating the goal reachability is displayed, in step S125, all of the necessary predictive chronological data and the prediction state sequence are generated, and in steps S126 and S127, the presentation information is extracted from the predictive chronological data and the prediction state sequence, and the life event screen is generated from the presentation information and displayed.

On the other hand, for example, in a case where a life event screen on which a process before it reaches an event of interest which is a certain life event to which attention is paid (a life event occurring before it reaches the event of interest and a process after it reaches the event of interest (a life event occurring after it reaches the event of interest) are displayed is generated, in step S125, all of the predictive chronological data and the prediction state sequence necessary for obtaining the process before it reaches the event of interest and the process after it reaches the event of interest are generated, and in steps S126 and S127, the presentation information is extracted from the predictive chronological data and the prediction state sequence, and the life event screen is generated from the presentation information and displayed.

Further, in a case where the event of interest is changed, for example, in accordance with the operation of the user, the process returns to step S125 again, all of the predictive chronological data and the prediction state sequence necessary for obtaining the process before it reaches the changed event of interest and the process after it reaches the changed event of interest are generated, and in steps S126 and S127, the presentation information is extracted from the predictive chronological data and the prediction state sequence, and the life event screen is generated from the presentation information and displayed.

<Specific Example of Application that Predicts Life Event of Person>

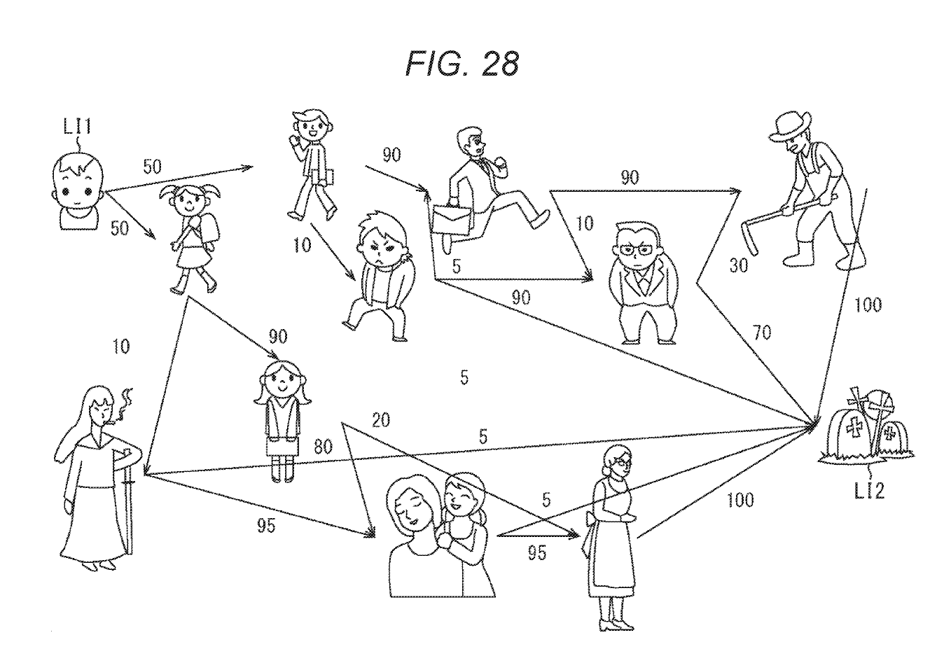

FIG. 28 is a diagram schematically illustrating an example of a network structure of a life event of a person.

In other words, FIG. 28 schematically illustrates an example of the entire HMM serving as the network model in which learning is performed using chronological data related to a life event of a person.

Here, the life event service system of FIG. 21 can be applied to an application that predicts life events of various targets.

As the prediction target whose life event is predicted, there are a person, an assembly of persons, a thing formed by an assembly of persons, or an object as described above.

Specific examples of the assembly of persons or the thing formed by the assembly of persons include a group, a company, a nation, culture, a religion, a boom, and the like.

Specific examples of the object include a vehicle, a musical instrument, a construction, a house, a building, a road, a bridge, a plant, a pet, and the like.

Examples of the life event of the person include a birth, enrollment in a school, graduation, getting a job, an encounter, separation, marriage, divorce, childbirth, purchase, disease morbidity, successful career, award, loss of position, job change, retirement, and death. Examples of the element deciding the life event of the person include lifestyles (for example, working, studying, exercise, movement, entertainment, a family service allocation time and degree (including heavy, light, or middle thereof), or the like), meal styles (for example, a meal time, the number of meals (the number of meals per day or the number of eating-out meals per week), an amount of intake (a total calorie, salt, or sugar), or the like), results of activities (for example, records, income, expenditure, position, social trust, a quantity and evaluation of deliverables, or the like), and external factors (for example, communication with others, evaluation from others, or the like).

Examples of the life event of the assembly of persons or the thing formed by the assembly of persons include establishment, scale expansion, scale reduction, personnel expansion, personnel reduction, merger, division, and dissolution. Examples of the element deciding the life event of the assembly of persons or the thing formed by the assembly of persons include activity statuses (for example, an activity time, a degree of activity or the like), results of activities (for example, records, income, expenditure, social trust, a quantity and evaluation of deliverables, or the like), and external factors (for example, usage from the outside, a degree of use, or the like).

Examples of the life event of the object include purchase, consumption, resale, damage, maintenance, destruction, and disposal. Examples of the element deciding the life event of the object include, use, a maintenance time and degree, a demand, and a supply price.

In FIG. 28, a life event LI1 indicates a birth of person, and a life event LI2 indicates death of a person. The life of a person starts from the life event LI1 indicating the birth, goes through various state transitions, and finally reaches the life event LI2 indicating the death.

In FIG. 28, a score indicating a possibility that a next life event will occur from a certain life event on the basis of the transition probability is added to an arrow indicating the state transition.

According to the life event service system of FIG. 21, it is possible to model a large number of pieces of chronological data such as various life events of the person or a behavior, evaluation, judgment history, and the like serving as the element deciding the life event, for example, in accordance with the HMM serving as the network model.

Further, according to the life event service system of FIG. 21, it is possible to display the life event of the person with the network structure in accordance with the HMM in which a large number of pieces of chronological data are modeled as illustrated in FIG. 28.

Further, according to the life event service system of FIG. 21, it is possible to display the score at which a next life event occurs from a certain life event on the basis of the transition probability as illustrated in FIG. 28.

In addition, in the life event service system of FIG. 21, although not illustrated, it is possible to display the form of the distribution of the chronological data which is modeled in accordance with the HMM.

Here, the modeling of a large number of pieces of chronological data related to the life event may be performed by connecting similar sections one after another in the large number of pieces of chronological data. When the modeling of a large number of pieces of chronological data is performed, the information of the frequency of the bundled chronological data, the information of the distribution of the observation values of the bundled section (the sample values of the chronological data), and the information of the transition from the bundled section to another bundled section are stored.

The modeling of a large number of pieces of chronological data may be performed, for example, using the Ergodic HMM. In the modeling of a large number of pieces of chronological data, particularly, the incremental HMM capable of expanding the network structure (the structure of the state transition) of the HMM is useful.

In the incremental HMM in which a large number of pieces of chronological data are modeled, the observation model becomes a model of generating the observation values of the life event indicated by a large number of pieces of chronological data or a behavior, evaluation, judgment or the like of deciding the life event.

For example, when a unique ID (Identification) is allocated to the life event, the observation probability that a life event indicated by each ID is observed is modeled using the polynomial distribution as the observation model for the life event. In this case, the ID indicating the life event is the observation value of the discrete symbol observed in the observation model.

Similarly, a history a behavior, evaluation, judgment, or the like of deciding the life event is modeled using another observation model. An element observed in the continuous value among the elements such as a behavior, evaluation, judgment, or the like of deciding the life event is modeled, for example, using the Gaussian distribution as the observation model, and an element observed in the discrete value is modeled, for example, using the polynomial distribution as the observation model.

It is possible to constitute the network structure illustrated in FIG. 28 in which the overall image of the life event indicated by a large number of pieces of chronological data is looked down by modeling a large number of pieces of chronological data in accordance with the incremental HMM, that is, performing the learning of the incremental HMM using a large number of pieces of chronological data and extracting the states in which the observation probability that the characteristic life event is observed in the observation model is high in the incremental HMM and the state transition of connecting the states.

Further, the network structure in FIG. 28 is a network structure in which a large number of life events or state transitions are omitted in order to look down the overall image of the life event of the person, and practically, according to the incremental HMM in which the learning using a large number of pieces of chronological data related to the life event of the person is performed, a huge network structure is constituted.

In this regard, in the life event service system of FIG. 21, it is possible to clip and display only a necessary portion in the huge network structure.

In other words, it is possible to clip some subset HMM from the entire HMM and predict the future life event using the subset HMM.

In the clipping of the subset HMM, for example, when a value of the observation value or a range of the value is designated, it is possible to clip the state in which the observation value of the value or the state in which the observation value of the range of the value can be observed as the state serving as the subset HMM. Further, in the clipping of the subset HMM, for example, when the state itself is designated, it is possible to clip the state as the state serving as the subset HMM.

For example, in a case where the state of the entire HMM has the Gaussian distribution serving as the observation model in which the age of a person is observed as the observation value, when 30 or less or the like is designated as the age of the person, it is possible to clip a state in which the average value of the Gaussian distribution is 30 or less as the state serving as the subset HMM.

Further, as the state serving as the subset HMM, for example, it is possible to clip the state in which the profile matches that of the user (person) whose life event is predicted, that is, the state obtained by learning the chronological data related to the life event of the user of the profile similar to the profile of the user whose life event is predicted.

For example, it is possible to clip a state in which a sex coincides with that of the user, a state in which a family configuration, a residential area, a labor form, a residential feature, and the like are similar to those of the user, or the like as the state serving as the subset HMM.

In a case where the profile of the user is given by the chronological data, for example, it is possible to detect the state in which (the sample value of) the chronological data can be observed and narrow down the state in which the profile matches that of the user.

Further, for example, if the learning of the HMM is performed, for example, in accordance with a profile such as a sex, it is possible to select the HMM in which the profile matches that of the user and narrow down the state in which the profile matches that of the user.

### <Configuration Example of Academic Background Occupation Selection Prediction System>

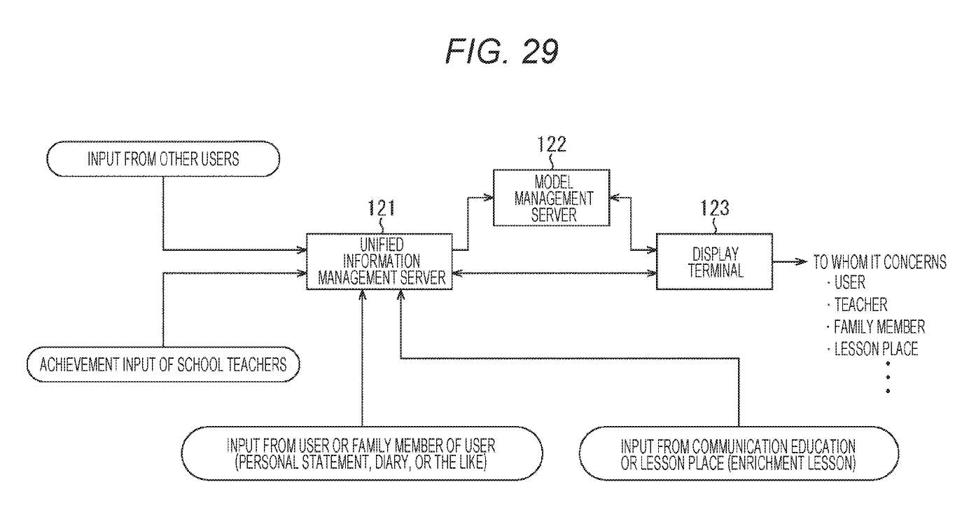

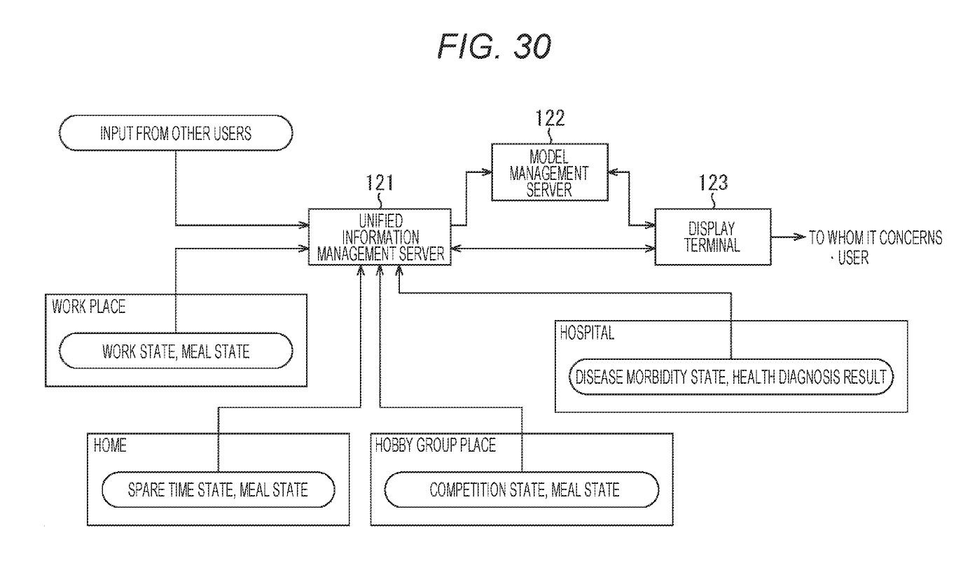

FIG. 29 is a block diagram illustrating a configuration example of an academic background occupation selection prediction system to which the life event service system of FIG. 21 is applied.

The academic background occupation selection prediction system illustrated in FIG. 29 is one example of an application that predicts and presents a far future of a person, for example, an age is narrowed down to 30 or less, and occupation selection (getting a job) is predicted.

For example, in the academic background occupation selection prediction system illustrated in FIG. 29, in a case where future occupation selection of an elementary school student is predicted in response to an input of chronological data related to a life event of the elementary school life event, it is necessary to collect chronological data having influence on decision of the future occupation selection in a period from the elementary school student to the occupation selection.

Examples of the chronological data having influence on the decision of the future occupation selection in the period from the elementary school student to the occupation selection includes academic achievement (which is obtainable from, for example, educational institutions, personal statement, or statement from parents), extracurricular academic achievement of a cram school or the like (which is obtainable from a period such as a cram school, personal statement, or statement from parents), club activities (which is obtainable from educational institutions or the like), enrichment lessons, sports (which is available form coaches or the like), parents' degree of involvement (which is obtainable from information such as a diary uploaded to an SNS or the like), a lifestyle (a wake-up time, a meal time, a sleeping time, and the like are obtained from sensors), a relationship between children (it is better to know information such as a good relationship or a romance), a living place, and an range of activities.

Further, all the above-mentioned chronological data are not necessarily essential as the chronological data having influence on the decision of the future occupation selection in the period from the elementary school student to the occupation selection. Further, the chronological data having influence on the decision of the future occupation selection in the period from the elementary school student to the occupation selection is not limited to the above-mentioned chronological data.

In a case where prediction for the future occupation selection is performed, it is necessary to collect chronological data including data of enrolled (graduated) schools, occupations, and the like as the modal data.

Examples of the data of the schools include school names or a department of an enrolled elementary school, a middle school, and a college. Examples of the data of the occupations include a company name of an employment place, a business type, and a job type.

In FIG. 29, the academic background occupation selection prediction system includes a unified information management server 121, a model management server 122, and a display terminal 123.

The unified information management server 121 and the model management server 122 correspond to the server 61 of the life event service system in FIG. 21, and share the function of the server 61.

The display terminal 123 corresponds to the client 62 of the life event service system in FIG. 21.

The unified information management server 121 collects the chronological data having influence on the decision of the future occupation selection and the chronological data including the data of the schools, the occupation, and the like described above as the chronological data necessary for the prediction of the future occupation selection.

The unified information management server 121 is able to collect the chronological data necessary for the prediction of the future occupation selection from various places such as schools, home, communication education, cram schools, and lesson places. Further, the chronological data necessary for the prediction of the future occupation selection may be input from the user, a family member of the user, or the like.

Further, for example, the user or the family member of the user accesses the unified information management server 121 from the display terminal 123 and view the chronological data of the user among the chronological data collected by the unified information management server 121.

Further, for the chronological data collected by the unified information management server 121, the schools, the communication education, the cram schools, the lesson places, and the like are able to view only the chronological data which they provide.

The model management server 122 generates the entire HMM by performing the learning using the chronological data collected by the unified information management server 121 as necessary. Further, the model management server 122 clips the subset HMM suitable for the user of the display terminal 123 from the entire HMM, and transmits the subset HMM to the display terminal 123. Further, the model management server 122 is able to employ the entire HMM of the state in which the learning is not performed as the entire HMM from which the subset HMM is clipped.

In the display terminal 123, the subset HMM supplied from the model management server 122 is periodically updated, for example, using the chronological data related to the life event of the user of the display terminal 123, and the updated subset HMM (and the information of the frequency (for example, the variables Nᵢ^{(π)}, Nᵢⱼ^{(a)}, and Nᵢ^{(ϕ)}) of Formulas (30) to (32))) are transmitted to the model management server 122.

Therefore, the chronological data serving as the personal information of the user of the display terminal 123 is transmitted from the display terminal 123 to the model management server 122 in an anonymized form such as the updated subset HMM.

The model management server 122 updates the entire HMM by merging the updated subset HMM supplied from the display terminal 123 into the entire HMM. In the model management server 122, the subset HMM updated using the chronological data related to the life event before various users perform the occupation selection is merged into the entire HMM, and thus information related to the life event before various users perform the occupation selection is acquired in the entire HMM.

In a case where the prediction of the future occupation selection of the user of the display terminal 123 is performed, the model management server 122 clips the subset HMM constituted by the state suitable for the profile of the user of the display terminal 123 from the entire HMM and supplies the subset HMM to the display terminal 123.

For example, as described above, in a case where an age is narrowed down to 30 or less, and the occupation selection is predicted, a subset HMM constituted by a state suitable for an age of 30 or less (a state in which the observation value of the age observed in the observation model is 30 or less) is clipped from the entire HMM.

The display terminal 123 acquires the chronological data related to the life event of the user of the display terminal 123 until now from the unified information management server 121 or the like, applies the chronological data to the subset HMM supplied from the model management server 122 as the input chronological data, and generates the predictive chronological data in which the future of the input chronological data is predicted and the prediction state sequence in which the predictive chronological data is observed.

Further, in the display terminal 123, a network structure of an occupation which the user of the display terminal 123 is predicted to get as the future life event is displayed through the display illustrated in FIG. 17 or the score/time order display illustrated in FIGS. 18 and 19 on the basis of the predictive chronological data and the prediction state sequence.

Further, in the display terminal 123, in a case where the user inputs a goal occupation such as a pianist, for example, it is possible to obtain and display a score at which the user is able to get the goal occupation in the future in accordance with the predictive chronological data and the prediction state sequence.

Further, in the display terminal 123, it is possible to obtain an occurrence condition in which a life event in which the user gets the goal occupation in the future occurs, and display the occurrence condition through the score/time order display with the occurrence condition (FIG. 19).

For example, in the display terminal 123, in a case where the future life event is predicted using the chronological data such as academic achievement, extracurricular achievement, group activities, and the like of an elementary school student who is the user of the display terminal 123 until now as the input chronological data for the elementary school students, a future life event indicating that it is general to first go to a private middle school, go to a high school as it is, go to a national public college, and get a job at a famous company and whether or not a probability to follow such footsteps is high may be displayed.

Further, for example, in the display terminal 123, in a case where the future life event is predicted using the chronological data such as parents' degree of involvement for enrichment lessons, sports, and individual lessons and a lifestyle of an elementary school student who is the user of the display terminal 123 as the input chronological data for the elementary school student, a future life event indicating that if the user follows footsteps of going to a municipal middle school, then waking up to music, going to a music school, going to a college of music, wining a piano competition, and becoming a pianist, the user can be a pianist which is a goal occupation and whether or not a probability of becoming a pianist is high may be displayed.

Further, here, the footsteps from the elementary school student from the final occupation selection serving as the prediction result of the future life event have been described using only the representative life event as an example, but there are a large number of life events and branches until it reaches the final occupation selection from the elementary school student.

In a case where a large number of life events and branches are displayed as illustrated in FIG. 16, that is, in a case where the network structure of the prediction state sequence (network sequence) as the prediction result for the future life event is displayed such that the corresponding life event is allocated to each of the state constituting the prediction state sequence, it may be difficult for the user to understand it.

On the other hand, when the score/time order display (FIGS. 18 and 19) is performed on a large number of life events and branches serving as the prediction result for the future life event, it is easy for the user to understand the possibility of the occurrence of each life event and the passage of time. Therefore, the prediction result for life event can be displayed for the user in an easy-to-understand manner.

Further, in the score/time order display, in a case where the network structure of the life event (and the occurrence condition) serving as the prediction result for the future life event is unable to be displayed within one screen, the network structure is displayed to be scrolled in accordance with the operation of the user as described with reference to FIG. 18.

In this case, the user is able to follow a route for reaching the life event of the final occupation selection interactively while performing the operation of scrolling the network structure of the life event as necessary. In a case where the network structure of the life event is large, and the screen for displaying the large-scale network structure is a space-saving display screen, the user is able to understand the entire large-scale network structure by performing the scrolling operation as necessary.

Further, according to the score/time order display with the occurrence condition in FIG. 19, since the occurrence condition that a life event of a certain branch destination occurs from a certain life event is displayed, for example, the user is able to understand a subsequent achievement required for causing a life event of a desired branch destination to occur, a test score required for causing a life event of a desired branch destination to occur, and behaviors and hours allocated to the behavior required for causing a life event of a desired branch destination to occur, and the like.

Therefore, by seeing the score/time order display with the occurrence condition, the user is able to search for a behavior of increasing the probability of reaching the goal while undergoing trial-and-error as to where and what kind of effort should be taken.

### <Configuration Example of Health Prediction System>

FIG. 30 is a block diagram illustrating a configuration example of a health prediction system to which the life event service system of FIG. 21 is applied.

The health prediction system of FIG. 30 is one example of an application that predicts and presents a far future of a person, for example, and an age is narrowed down to 30 or more, and a health state is predicted.

In a case where a future health state is predicted, it is necessary to collect chronological data related to a life event having influence on the health state.

Examples of the chronological data related to the life event having influence on the health state includes a lifestyle (for example, overtime hours, holiday works, overseas business trips, day trips (company data)), worth living (for example, job satisfaction), an entertainment ratio (for example, the presence or absence of hobbies such as pachinko), stress (for example, stress body, stress tolerance, stress coping work, existence value, and personality (pessimistic)), an income, a debt, a relationship with others, the presence or absence of conversation, marriage, friends, close friends, dietary habits (for example, a meal type (high calorie frequency, salt content, sugar content, fat content, eating-out, and midnight snacks), meal frequency (whether to eat each meal or whether to eat useless night snacks), and an obesity rate).

Further, there are health state classes (a health, a disease type, and death) as chronological data useful for prediction of the future health state.

In FIG. 30, the health prediction system includes a unified information management server 121, a model management server 122, and a display terminal 123 and has a similar configuration to that of the academic background occupation selection prediction system of FIG. 29.

However, in FIG. 30, the unified information management server 121 collects the chronological data related to the life event having influence on the health state and the chronological data indicating the class of the health state as the chronological data necessary for the prediction of the future health state.

In the unified information management server 121, the chronological data necessary for the prediction of the future health state may be collected from various places such as a work place, a family, a hobby group, and a hospital. Further, the chronological data necessary for the prediction of the future health state may be input from the user, the family member of the user, or the like.

Further, for example, the user or the family member of the user is able to access the unified information management server 121 from the display terminal 123 and view the chronological data related to the life event of the user among the chronological data collected by the unified information management server 121.

Further, for the chronological data collected by the unified information management server 121, a work place, a family, a hobby group, a hospital, and the like are able to view only the chronological data which they provide.

The model management server 122 performs the learning using the chronological data collected by the unified information management server 121 as necessary and generates the entire HMM. Further, the model management server 122 clips the subset HMM suitable for the user of the display terminal 123 from the entire HMM, and transmits the subset HMM to the display terminal 123. Further, in the model management server 122, the entire HMM of the state in which the learning is not performed may be employed as the entire HMM from which the subset HMM is clipped.

In the display terminal 123, the subset HMM supplied from the model management server 122 is periodically updated, for example, using the chronological data related to the life event of the user of the display terminal 123, and the updated subset HMM (and the information of the frequency (for example, the variables Nᵢ^{(π)}, Nᵢⱼ^{(a)}, and Nᵢ^{(ϕ)}) of Formulas (30) to (32))) are transmitted to the model management server 122.

Therefore, the chronological data serving as the personal information of the user of the display terminal 123 is transmitted from the display terminal 123 to the model management server 122 in an anonymized form such as the updated subset HMM.

The model management server 122 updates the entire HMM by merging the updated subset HMM supplied from the display terminal 123 into the entire HMM. In the model management server 122, the subset HMM updated using the chronological data related to the life event associated with various health states of the user is merged into the entire HMM, and thus information related to the life event associated with the various health states of the user is acquired in the entire HMM.

In a case where the prediction of the future health state of the user of the display terminal 123 is performed, the model management server 122 clips the subset HMM constituted by the state suitable for the profile of the user of the display terminal 123 from the entire HMM and supplies the subset HMM to the display terminal 123.

For example, as described above, in a case where an age is narrowed down to 30 or more, and the health state is predicted, a subset HMM constituted by a state suitable for an age of 30 or more (a state in which the observation value of the age observed in the observation model is 30 or more) is clipped from the entire HMM.

The display terminal 123 acquires the chronological data related to the life event of the user of the display terminal 123 until now from the unified information management server 121 or the like, applies the chronological data to the subset HMM supplied from the model management server 122 as the input chronological data, and generates the predictive chronological data in which the future of the input chronological data is predicted and the prediction state sequence in which the predictive chronological data is observed.

Further, in the display terminal 123, a network structure of a future health state which the user of the display terminal 123 is predicted to have as the future life event is displayed through the display illustrated in FIG. 17 or the score/time order display illustrated in FIGS. 18 and 19 on the basis of the predictive chronological data and the prediction state sequence.

In other words, in the display terminal 123, for example, it is possible to display what kind of diseases will be suffered in the future, the probability of the disease, footsteps until now, and the like if the user of the display terminal 123 continues current life.

Further, in the display terminal 123, for example, it is possible to display choices of a behavior serving as the occurrence condition and a probability of having the disease occurring from the choice of each behavior (the score for reaching the disease) in each branch of the network structure of the future health state.

If the user selects the choice of the behavior in the branch of the network structure of the future health state, the display terminal 123 is able to apply the observation value satisfying the occurrence condition serving as the choice of the behavior selected by the user to the subset HMM as the input chronological data and re-generate the predictive chronological data and the prediction state sequence.

Further, the display terminal 123 is able to re-display the network structure of the future health state predicted for the user of the display terminal 123 serving as the future life event on the basis of the re-generated predictive chronological data and the prediction state sequence.

In this case, a network structure different from the network structure before the user selects the choice of the behavior may be displayed. In other words, for example, a life event occurring before a certain disease occurs, a probability of having the disease, and the like are changed from those before the user selects the choice of behavior and displayed.

For people, in addition to the prediction of the future occupation selection described with reference to FIG. 29 and the prediction of the future health state described with reference to FIG. 30, for example, it is possible to collect chronological data related to various life events associated with a successful career, loss of position, encounter, separation, or the like, perform the learning of the HMM, and perform the prediction using the HMM. Then, for various life events, it is possible to obtain information such as a probability that the life event will occur (the score for reaching the state corresponding to the life event), the life event that may occur before the life event occurs (footsteps causing the life event to occur), the occurrence condition that the life event occurs and provide the information to the user.

<Specific Example of Application that Predicts Life Event of Object>

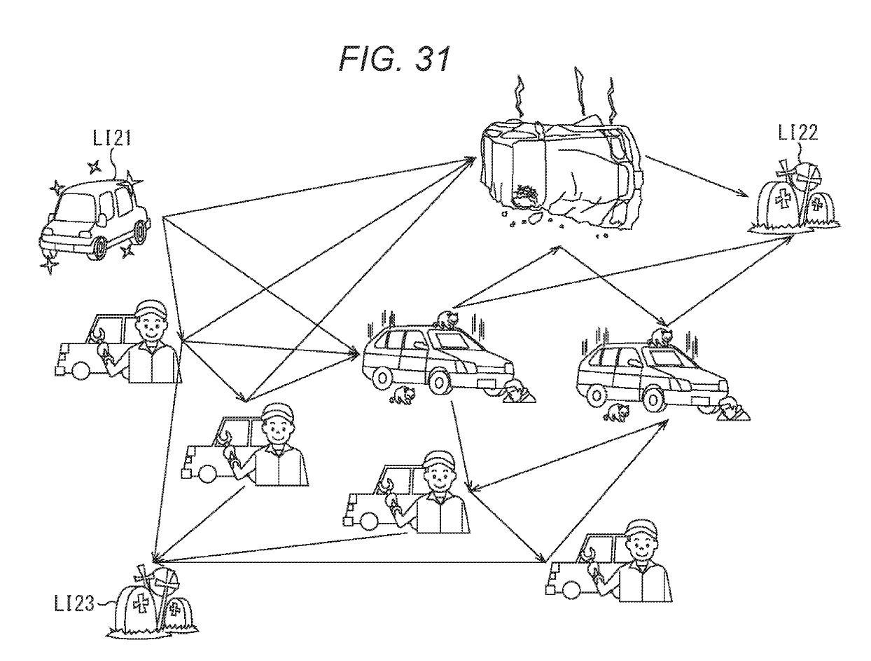

FIG. 31 is a diagram schematically illustrating an example of a network structure of a life event of an object.

In other words, FIG. 31 schematically illustrates an example of the entire HMM serving as the network model in which the learning is performed using the chronological data related to the life event of the object.

The life event service system of FIG. 21 can be applied to an application that predicts the life event of the object in addition to the application that predicts the life event of the person described with reference to FIGS. 29 and 30.

For example, the prediction of the life event is widely required, particularly, for objects such as durable consumer goods held over a long period of time among the objects. For example, for the durable consumer goods such as houses, buildings, construction such as towers, public facilities such as roads or bridges, vehicles, and musical instruments, a maintenance frequency, a storage location, an operation rate, a management method, or the like has influence on a price at the time of resale, a lifespan, and the like as a future life event.

FIG. 31 schematically illustrates an example of a network structure serving as an entire HMM of a life event of a vehicle (automobile) serving as durable consumer goods.

Examples of the life event of the vehicle include a new car sale, use, vehicle inspection, a trouble, a used vehicle (a secondhand selling price), an accident, and a vehicle disposal. Further, as an element deciding the life event of the vehicle, for example, there is chronological data such as a travel distance, a speed, a gasoline use state, equipment (a battery, an air conditioner, and the like), a use state, an operation rate (weekdays and holidays), a road type (an expressway, a general road, a road congestion degree, or the like), a road maintenance state (asphalt, a gravel road, or the like), a profile or use tendency of the user (polite or violent), a sunshine condition, a fluctuation in a gasoline unit price (related to an operation rate).

Here, in FIG. 31, a life event L121 indicates a new car sale (new car production), and life events L122 and L123 indicate vehicle disposal.

The travel distance, the speed, and the like among the chronological data serving as the element deciding the life event of the vehicle can be acquired, for example, from a global positioning system (GPS) mounted on the vehicle or meters such as a speed meter. The gasoline use state, a gasoline mileage economy, and the like can be easily obtained by, for example, performing time differentiation of chronological data of a remaining gasoline amount. A frequency in which the gasoline fueling is performed or the like can be obtained, for example, from meters. The use states of the equipment (a battery, an air conditioner, interior lights, mirrors, and the like) can be acquired, for example, from sensors installed to sense the use states or the like. The operation rate of the vehicle can be easily measured, for example, from the GPS or meters such as a remaining amount meter. The operation rate, the road type, and the road maintenance state can be measured, for example, using meters mounted on the vehicle, an acceleration sensor separately mounted on the vehicle, and the like. The profile of the user, that is, information such as a man or a woman, an age group, an occupation, and the like can be registered by the user, for example, when the application is used for the first time.

The use tendency of the user can be estimated, for example, from the profile of the user. Further, for the use tendency of the user, it is possible to estimate, for example, the use tendency such as polite, violent, many mistakes, slow reaction, or fast reaction, for example, from measured values of a speedometer and an acceleration sensor, a use frequency of an accelerator or a brake, and the like. In addition, for example, information indicating whether a vehicle is kept inside or outside a garage may be collected as the use tendency of the user. When information on a place in which the vehicle is kept is collected, it is possible to acquire a condition (situation) in which the vehicle is kept such as a sunshine state (rainfall amount), humidity, and the like. In addition, as the condition in which the vehicle is kept, it is possible to measure and acquire a degree of salt damage, for example, from a distance from a coast. Since the fluctuations in the gasoline unit price affect the operation rate of the vehicle and the like, it is desirable to acquire it as one of chronological data necessary for the prediction of the life event of the vehicle.

In the life event service system illustrated in FIG. 21, the server 61 collects the chronological data described above as the chronological data necessary for the prediction of the life event of the vehicle, performs the learning using the chronological data, and generates the entire HMM.

On the other hand, for example, the client 62 acquires the subset HMM from the server 61, applies the chronological data related to the life event of the vehicle owned by the user of the client 62 until now to the subset HMM as the input chronological data, and generates the predictive chronological data in which the future of the input chronological data is predicted and the prediction state sequence in which the predictive chronological data is observed.

Then, the client 62 displays, for example, a secondhand price of the vehicle (secondhand selling price), a useful life, and the like serving as the future life event of the vehicle through the display illustrated in FIG. 17 or the score/time order display illustrated in FIGS. 18 and 19 on the basis of the predictive chronological data and the prediction state sequence.

Further, in the life event service system of FIG. 21, for example, the chronological data related to the life event of the vehicle owned by the user of the client 62 among the chronological data collected by the server 61 may be applied to the subset HMM as the input chronological data. In this case, the user of the client 62 does not recognize the operation of applying the chronological data related to the vehicle owned by the user of the client 62 to the subset HMM.

Further, the displaying of the secondhand price of the vehicle (secondhand selling price), the useful life, and the like serving as the future life event through the display illustrated in FIG. 17 or the score/time order display illustrated in FIGS. 18 and 19 may be performed, for example, in a case where the user of the client 62 is a user who purchased the car as a new car.

Further, the displaying of the secondhand price of the vehicle (secondhand selling price), the useful life, and the like through the display illustrated in FIG. 17 or the score/time order display illustrated in FIGS. 18 and 19 may be performed, for example, in a case where the user of the client 62 is a used vehicle dealer, a used vehicle purchaser, or the like.

<Specific Example of Application that Predicts Life Event of Assembly of Persons or Thing Formed by Assembly of Persons>

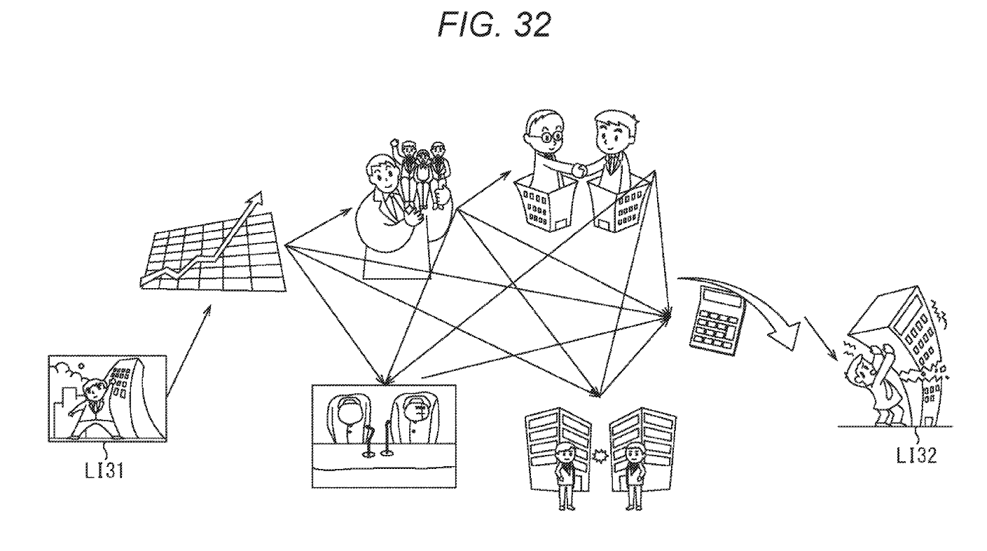

FIG. 32 is a diagram schematically illustrating an example of a network structure of a life event of an assembly of persons or a thing formed by an assembly of persons.

Here, as the assembly of persons, there are organizations such as a hobby group, a club, a company, an autonomous body, a volunteer organization, a religious organization, and a nation. As the thing formed by the assembly of persons, there are culture, fashion, and the like, for example.

The life event service system of FIG. 21 can be applied to an application that predicts the life event of the assembly of persons or the thing formed by the assembly of persons in addition to the application that predicts the life event of the person described with reference to FIG. 29 and FIG. 30 and the application that predicts the life event of the thing described with reference to FIG. 31.

FIG. 32 schematically illustrates an example of an entire HMM as a network model in which learning is performed using chronological data related to a life event of a company serving as the assembly of persons.

Examples of the life event of the company include establishment, expansion of business scale, personnel expansion, merger, scandals, battle against rivals, reduction in business scale, personnel reduction, organization division, and dissolution. Further, as an element deciding the life event of the company, for example, there is chronological data such as a cash flow, a stock price (expectation from shareholders), business sales (profit), personnel size, research development scale, market size, and competitor company information.

Here, in FIG. 32, a life event L131 indicates establishment of a company, and a life event L132 indicates dissolution of the company.

The chronological data related to the life event of the company, that is, chronological data of the life event of the company or chronological data deciding the life event of the company may be obtained, for example, from web sites on the Internet.

In the life event service system illustrated in FIG. 21, the server 61 collects the chronological data related to the life event of the company from the website or the like, performs the learning using the chronological data, and generates the entire HMM.

On the other hand, for example, the client 62 acquires the subset HMM from the server 61, applies the chronological data related to the life event of the company whose future life event is desired to be predicted until now to the subset HMM as the input chronological data, and generates the predictive chronological data in which the future of the input chronological data is predicted and the prediction state sequence in which the predictive chronological data is observed.

Further, the client 62 displays, for example, scale expansion, scale reduction, dissolution, and the like serving as the future life event of the company through the display illustrated in FIG. 17 or the score/time order display illustrated in FIGS. 18 and 19 on the basis of the predictive chronological data and the prediction state sequence. The scale expansion, the scale reduction, the dissolution, and the like serving as the future life event of the company may be displayed together with the probability that the life event will occur (the score for reaching the state corresponding to the life event).

The display of the future life event of the organization such as the company can be used as a reference when an administrator of the organization (for example, a manager of the company) reviews a management method of the organization in the future. Further, the display of the future life event of the organization can be used as a reference, for example, when a person belonging to the organization (for example, an employee of the company) decides how to behave in the organization.

Further, in the present embodiment, the HMM is employed as the network model of learning the chronological data, but a linear dynamic system such as a Kalman filter or a particle filter or other state transition models can be used as the network model.

<Description of Computer to which Present Technology is Applied>

Next, a series of processes described above can be performed by hardware or software. In a case where a series of processes is performed by software, a program constituting the software is installed in a general-purpose computer or the like.

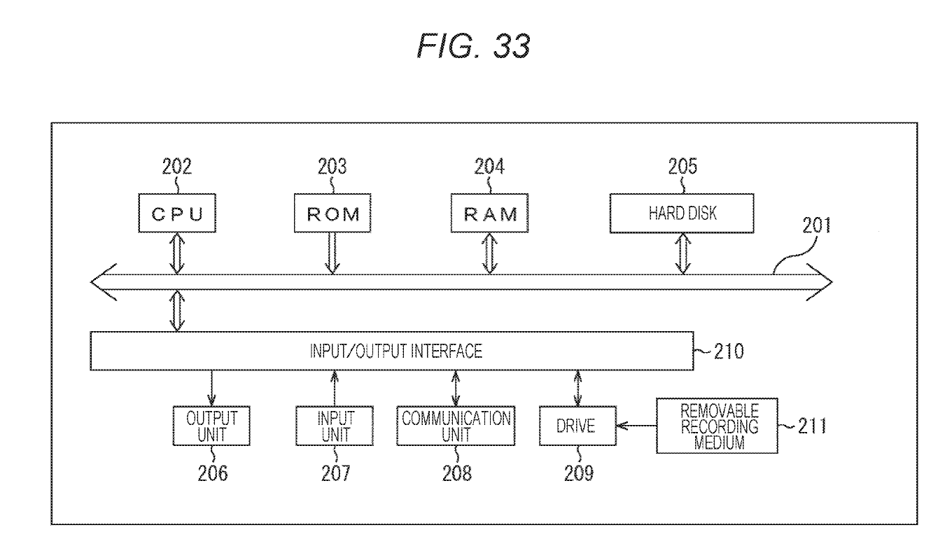

In this regard, FIG. 33 illustrates a configuration example of one embodiment of a computer in which a program executing a series of processes described above is installed.

The program may be recorded in a hard disk 205 or a read only memory (ROM) 203 serving as a recording medium installed in the computer in advance.

Alternatively, the program may be stored (recorded) in a removable recording medium 211. The removable recording medium 211 may be provided as so-called package software. Examples of the removable recording medium 211 include a flexible disk, a compact disc read only memory (CD-ROM), a magneto optical (MO) disk, a digital versatile disc (DVD), a magnetic disk, and a semiconductor memory.

Further, instead of installing the program in the computer from the removable recording medium 211 as described above, the program may be downloaded to a computer via a communication network or a broadcasting network and installed in the internal hard disk 205. In other words, the program may be wirelessly transferred from a download site to the computer via a satellite for digital satellite broadcasting or may be transferred to the computer via a network such as a local area network (LAN) or the Internet in a wired manner.

The computer includes a central processing unit (CPU) 202 therein, and an input/output interface 210 is connected to the CPU 202 via a bus 201.

If the user inputs a command by operating an input unit 207 via the input/output interface 210, the CPU 202 executes the program stored in the ROM 203 in accordance with the command. Alternatively, the CPU 202 loads the program stored in the hard disk 205 onto a random access memory (RAM) 204 and executes the program.

Accordingly, the CPU 202 performs the process according to the above-described flow charts or the process according to the configurations of the above-described block diagrams. Then, for example, the CPU 202 causes a processing result to be output from an output unit 206, transmitted from a communication unit 208, or recorded in the hard disk 205 via the input/output interface 210 as necessary.

Further, the input unit 207 includes a keyboard, a mouse, a microphone, or the like. Further, the output unit 206 includes a liquid crystal display (LCD), a speaker, or the like.

Here, in this specification, the process performed by the computer in accordance with the program need not be necessarily performed chronologically in the order described in the flowchart. In other words, the process performed by the computer in accordance with the program also includes processes which are executed in parallel or individually (for example, a parallel process or an object-based process).

Further, the program may be processed by a single computer (processor) or may be distributedly processed by a plurality of computers. Further, the program may be transferred to a computer at a remote site and executed.

Further, in this specification, a system refers to a set of a plurality of components (devices, modules (parts), or the like), and all components need not be necessary installed in the same housing. Thus, both a plurality of devices which are accommodated in separate housings and connected via a network and one device in which a plurality of modules are accommodated in one housing are systems.

Further, the embodiment of the present technology is not limited to the above-described example, and various modifications can be made within the scope departing from the gist of the present technology.

For example, the present technology may have a cloud computing configuration in which one function is shared and processed by a plurality of devices via a network.

Further, steps described in the above flowcharts may be performed through one device or may be shared and processed by a plurality of devices.

In addition, in a case where a plurality of processes are included in one step, a plurality of processes included in one step may be performed through one device or may be shared and processed by a plurality of devices.

Further, the effects described in this specification are merely examples and the present technology is not limited to these effects, and any other effect may be included.

Further, the present technology may have the following configurations.

<1>

A display control device, including:

a control unit that performs display control such that a future life event obtained by predicting the future life event using chronological data related to a life event is displayed on a display unit in a chronology on the basis of a score at which the life event occurs.

<2>

The display control device according to <1>,

in which the control unit performs the display control such that an occurrence condition that another life event occurs from a predetermined life event is further displayed.

<3>

The display control device according to <2>,

in which the score is re-calculated in accordance with selection of the occurrence condition.

<4>

The display control device according to any one of <1> to <3>,

in which the control unit performs the display control such that the score at which the life event occurs is further displayed.

<5>

The display control device according to any one of <1> to <4>,

in which the life event is a life event of a person, an assembly of persons, a thing formed by the assembly of persons, or an object.

<6>

The display control device according to any one of <1> to <5>,

in which the future life event is predicted using a model having a network structure in which learning is performed using the chronological data related to the life event.

<7>

The display control device according to <6>,

in which the future life event is predicted using a subset model which is a part of the model.

<8>

The display control device according to <7>,

in which the subset model is updated by learning using the chronological data related to the life event, and

the model is updated using the updated subset model.

<9>

The display control device according to any one of <6> to <8>,

in which the model is a hidden Markov model (HMM).

<10>

The display control device according to <9>,

in which the subset model is a subset HMM constituted by a state obtained by clustering states of the HMM, searching for a cluster to which each sample of the chronological data related to the life event belongs as an associated cluster to which the chronological data belongs using a result of clustering the states of the HMM, and clipping a state belonging to the associated cluster from the HMM.

<11>

The display control device according to <7>, further including

a predicting unit that predicts the future life event using the subset model.

<12>

A display control method, including:

performing display control such that a future life event obtained by predicting the future life event using chronological data related to a life event is displayed on a display unit in a chronology on the basis of a score at which the life event occurs.

<13>

A program causing a computer to function as:

a control unit that performs display control such that a future life event obtained by predicting the future life event using chronological data related to a life event is displayed on a display unit in a chronology on the basis of a score at which the life event occurs.

### REFERENCE SIGNS LIST

10 Chronological database
11 Search unit
12 Predictive chronological generating unit
21 Entire HMM
22, 23 Subset HMM
24 Entire HMM
31 HMM storage unit
32 Clustering unit
33 Cluster table storage unit
34 Chronological data storage unit
35 Cluster search unit
36 Subset clipping unit
51 Model storage unit
52 State estimating unit
53 Predictive chronological generating unit
61 Server
62 Client
63 Network
71 Data acquiring unit
72 Model learning unit
73 Model storage unit
74 Subset acquiring unit
75 Model updating unit
81 Data acquiring unit
82 Model learning unit
83 Subset storage unit
84 Setting unit
85 Life event predicting unit
86 Information extracting unit
87 Presentation control unit
88 Presenting unit
101 Profile information setting UI
102 Population setting UI
103 Goal setting UI
104 Prediction execution request UI
105 Life event/score presentation UI
106 Life event/process presentation UI
121 Unified information management server
122 Model management server
123 Display terminal
201 Bus
202 CPU
203 ROM
204 RAM
205 Hard disk
206 Output unit
207 Input unit
208 Communication unit
209 Drive
210 Input/output interface
211 Removable recording medium

1. A display control device, comprising:
a control unit that performs display control such that a future life event obtained by predicting the future life event using chronological data related to a life event is displayed on a display unit in a chronology on the basis of a score at which the life event occurs.

2. The display control device according to claim 1,
wherein the control unit performs the display control such that an occurrence condition that another life event occurs from a predetermined life event is further displayed.

3. The display control device according to claim 2,
wherein the score is re-calculated in accordance with selection of the occurrence condition.

4. The display control device according to claim 1,
wherein the control unit performs the display control such that the score at which the life event occurs is further displayed.

5. The display control device according to claim 1,
wherein the life event is a life event of a person, an assembly of persons, a thing formed by the assembly of persons, or an object.

6. The display control device according to claim 1,
wherein the future life event is predicted using a model having a network structure in which learning is performed using the chronological data related to the life event.

7. The display control device according to claim 6,
wherein the future life event is predicted using a subset model which is a part of the model.

8. The display control device according to claim 7,
wherein the subset model is updated by learning using the chronological data related to the life event, and
the model is updated using the updated subset model.

9. The display control device according to claim 6,
wherein the model is a hidden Markov model (HMM).

10. The display control device according to claim 9,
wherein the subset model is a subset HMM constituted by a state obtained by clustering states of the HMM, searching for a cluster to which each sample of the chronological data related to the life event belongs as an associated cluster to which the chronological data belongs using a result of clustering the states of the HMM, and clipping a state belonging to the associated cluster from the HMM.

11. The display control device according to claim 7, further comprising
a predicting unit that predicts the future life event using the subset model.

12. A display control method, comprising:
performing display control such that a future life event obtained by predicting the future life event using chronological data related to a life event is displayed on a display unit in a chronology on the basis of a score at which the life event occurs.

13. A program causing a computer to function as:
a control unit that performs display control such that a future life event obtained by predicting the future life event using chronological data related to a life event is displayed on a display unit in a chronology on the basis of a score at which the life event occurs.
